(19) United States
(12) Patent Application Publication
(10) Pub. No.: US 2026/0358590 A1
(43) Pub. Date: Nov. 12, 2026

(54) FIBER OPTIC DISTRIBUTION SYSTEM WITH CABLE MANAGEMENT AND CIRCUIT TRACING

(71) Applicant: Amphenol Network Solutions, Inc., Liberty Lake, WA (US)

(72) Inventors: Bryan Joseph Kioski, Spokane, WA (US); Craig Dwayne Ray, Raleigh, NC (US); Harley J. McAllister, Spokane Valley, WA (US); David J. Braga, Durham, NC (US); Greg Hilbert, Liberty Lake, WA (US); Steven Witkoe, Liberty Lake, WA (US)

(21) Appl. No.: 19/671,080

(22) Filed: May 7, 2026

Related U.S. Application Data
(60) Provisional application No. 63/803,324, filed on May 9, 2025.

(51) Int. Cl. G02B 6/44

(52) U.S. Cl. CPC G02B 6/4452

(57) ABSTRACT

A fiber optic distribution system includes a cabinet with an interior and a shelf disposed within the cabinet. The shelf includes a rail structure with passages formed therein, receptacles positioned adjacent to the passages, tracer cables routed through the passages, and a door that moves between an open position and a closed position. The door includes apertures, where each aperture lines up with a corresponding passage. A coupler engages with the shelf and includes a housing, a ferrule extending from the housing that defines a bore for receiving an end of a tracer cable, a first prong extending from the housing for placement within a first receptacle, and a second prong extending from the housing for placement within a second receptacle. The first prong and the second prong are positioned on opposite sides of the ferrule.

### CROSS-REFERENCE TO RELATED APPLICATIONS

This application claims priority to U.S. Provisional Application No. 63/803,324, filed May 9, 2025, and entitled “Fiber Vault,” the entirety of which is herein incorporated by reference.

### BRIEF DESCRIPTION OF FIGURES

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted.

FIG. 1 illustrates an isometric view of an example cabinet housing example shelves, according to an embodiment of the present disclosure.

FIG. 2 illustrates an isometric view of an example shelf assembly, according to an embodiment of the present disclosure.

FIG. 3 illustrates an isometric view of an example shelf coupled to an example shelf bracket, according to an embodiment of the present disclosure.

FIGS. 4A-4D illustrate views of an example shelf and associated mounting components for coupling the shelf to a shelf bracket, according to an embodiment of the present disclosure.

FIGS. 5A-5C illustrate views of an example shelf bracket, according to an embodiment of the present disclosure.

FIGS. 6A-6C illustrate views of an example engagement between a shelf and a shelf bracket, according to an embodiment of the present disclosure.

FIGS. 7A-7C illustrate views of a shelf coupled to a shelf bracket, according to an embodiment of the present disclosure.

FIG. 8 illustrates a detailed view of an example locking mechanism of a shelf, according to an embodiment of the present disclosure.

FIG. 9 illustrates a top view of a shelf in an open position relative to a cabinet, according to an embodiment of the present disclosure.

FIG. 10 illustrates a perspective view of a portion of a shelf and associated shelf bracket components showing cables routed therethrough, according to an embodiment of the present disclosure.

FIGS. 11A and 11B illustrate views of a shelf showing the arrangement of example trays, according to an embodiment of the present disclosure.

FIG. 12 illustrates an isometric view of a shelf with an example cable routing and example retention components, according to an embodiment of the present disclosure.

FIGS. 13A and 13B illustrate views of an example clamp and an example receptacle of a shelf, according to an embodiment of the present disclosure.

FIGS. 14A-14C illustrate views of a shelf showing the arrangement of receptacles, according to an embodiment of the present disclosure.

FIGS. 15A-15D illustrate views of a clamp, according to an embodiment of the present disclosure.

FIGS. 16A and 16B illustrate cross-sectional views of a clamp disposed within a receptacle of a shelf, according to an embodiment of the present disclosure.

FIGS. 17A and 17B illustrate views of a shelf showing a clamp in a depressed state with a cable secured therein, according to an embodiment of the present disclosure.

FIGS. 18A and 18B illustrate views of a clamp engaging with a receptacle to secure a cable, according to an embodiment of the present disclosure.

FIGS. 19A and 19B illustrate views of a shelf showing a routing configuration for fiber optic cables, according to an embodiment of the present disclosure.

FIG. 20 illustrates a perspective view of a portion of a shelf showing an example channel, an example guide, and an example compliant retainer, according to an embodiment of the present disclosure.

FIG. 21 illustrates a detailed view of a portion of a shelf showing details of a guide, according to an embodiment of the present disclosure.

FIG. 22 illustrates a portion of a shelf showing components associated with an example tracer fiber routing and retention system, according to an embodiment of the present disclosure.

FIG. 23 illustrates an isometric view of a portion of a shelf showing an example door, an example rail, and example passages, according to an embodiment of the present disclosure.

FIG. 24 illustrates a view of a portion of a shelf showing compliant retainers, passages, and receptacles, according to an embodiment of the present disclosure.

FIG. 25 illustrates a cross-sectional view of a portion of a shelf showing components for tracer routing and retention, according to an embodiment of the present disclosure.

FIG. 26 illustrates a cross-sectional view of a portion of a shelf showing a compliant retainer being depressed to permit tracer routing, according to an embodiment of the present disclosure.

FIG. 27 illustrates a detailed view of a portion of a shelf showing the routing of cables and tracer cables through guides, according to an embodiment of the present disclosure.

FIG. 28 illustrates a cross-sectional view of a portion of a shelf showing a tracer cable routed through a passage, according to an embodiment of the present disclosure.

FIG. 29 illustrates an isometric view of an example strip that includes compliant retainers, according to an embodiment of the present disclosure.

FIG. 30 illustrates details of a compliant retainer, according to an embodiment of the present disclosure.

FIG. 31 illustrates a perspective view of a shelf showing a door in an open state, according to an embodiment of the present disclosure.

FIG. 32 illustrates an isometric view of a shelf showing a door in a closed position, according to an embodiment of the present disclosure.

FIG. 33 illustrates a perspective view of a portion of a shelf showing tracer cables routed toward through passages, according to an embodiment of the present disclosure.

FIGS. 34A and 34B illustrate views of a shelf with an example coupler and a cable positioned adjacent to a door and passages for circuit identification purposes, according to an embodiment of the present disclosure.

FIG. 35 illustrates a cross-sectional view of a coupler engaged with a shelf, according to an embodiment of the present disclosure.

FIGS. 36A-36D illustrate various views of a coupler, according to an embodiment of the present disclosure.

FIG. 37 illustrates an exploded view of a shelf with a coupler and a connector positioned for engagement, according to an embodiment of the present disclosure.

FIG. 38 illustrates a cross-sectional view showing an example prong engaged with receptacles and slots to align the coupler with the shelf, according to an embodiment of the present disclosure.

FIG. 39 illustrates a top view of a shelf showing the arrangement of six trays and a spine, according to an embodiment of the present disclosure.

FIGS. 40A and 40B illustrate views of a shelf showing trays positioned on opposite sides of a spine, according to an embodiment of the present disclosure.

FIG. 41 illustrates an isometric view of two trays, according to an embodiment of the present disclosure.

FIGS. 42A-42C illustrate views of a tray showing an interior and various structural features for fiber optic cable management and splicing operations, according to an embodiment of the present disclosure.

FIG. 43 illustrates a top view of a tray showing the internal structure and components for fiber optic cable management and splicing, according to an embodiment of the present disclosure.

FIG. 44 illustrates a top view of a tray showing the routing of fiber optic cables, according to an embodiment of the present disclosure.

FIG. 45 illustrates a top view of a tray showing the routing of fiber optic cables and splicing, according to an embodiment of the present disclosure.

FIG. 46 illustrates a top view of a tray showing the routing of multiple fiber optic cables, according to an embodiment of the present disclosure.

### DETAILED DESCRIPTION

This application is directed, at least in part, to a fiber optic distribution system that includes a cabinet, shelves, splice trays, cable retention mechanism(s), and a tracer fiber system for circuit identification. The shelves include splice trays for managing fiber optic connections, clamps for securing cables, and a tracer functionality that allows technicians to visually identify specific circuits by transmitting visible light through dedicated tracer fibers. In an embodiment, each cable may include multiple signal-carrying fibers and a dedicated tracer fiber. The tracer fiber may carry visible light, such as from a red LED or red laser, and may not carry data signals. Visual fault locators have traditionally been used to locate breaks or faults in fiber optic cables by observing where visible light leaks from a damaged fiber. The tracer fiber system described herein applies visible light transmission in a novel manner to identify specific circuits within a large fiber distribution system. By routing dedicated tracer fibers to a visible display at the front face of the shelf, the system enables technicians to positively identify which cable at one location corresponds to a specific cable at a remote location, without requiring electronic test equipment or interrupting active traffic. The fiber optic distribution system provides organized cable management, secure fiber retention, and efficient circuit tracing capabilities within a compact, accessible cabinet configuration that simplifies installation and maintenance operations.

The cabinet serves as the primary enclosure for the fiber optic distribution system. The cabinet includes a body that forms an interior space configured to house multiple shelves in a vertically stacked arrangement. The body provides structural framework and support for the shelves, splice trays, cable retention mechanisms, and tracer fiber components housed within the cabinet. The cabinet may include cable management features positioned along one side, with multiple guides arranged vertically to facilitate organized routing of cables from external sources to the respective shelves mounted within the interior. For example, the cabinet may include cable routing features such as spools, hooks, or channel guides that organize incoming cables and prevent tangling or excessive bending. These routing features may be positioned at multiple heights along the cabinet body to align with the respective shelves, ensuring that cables entering the cabinet are directed along defined pathways to their intended destinations. The cable management features help maintain proper bend radius for the fiber optic cables and reduce strain on the connections within the shelves. The cabinet body may be formed from metal, plastic, composite materials, or other suitable structural materials.

A frame of the cabinet provides the structural support for mounting multiple shelves within the cabinet. The frame extends vertically and includes a series of shelf brackets. The shelf brackets facilitate tool-less installation and removal of the shelves, allowing technicians to quickly add, remove, or reposition shelves without requiring specialized tools. Each shelf bracket is configured to receive and support a corresponding shelf. The shelf brackets may be coupled together to form the frame, and any number of shelf brackets may be coupled together depending on the desired capacity of the shelf assembly.

In an embodiment, each shelf bracket includes a top flange and a bottom flange (or other ledges, lips, rails, or projections) that are spaced apart to define a slot therebetween. The slot is configured to receive mounting components of the shelf. The shelf bracket includes notches, recesses, slots, or cutouts formed in the flanges that engage with corresponding protrusions, tabs, projections, or detents on the shelf to provide secure connection and alignment. The shelf bracket further includes retainers configured to route and receive cables as they pass through the bracket structure toward the shelf.

Each shelf includes a latching or locking mechanism that enables tool-less installation and removal of the shelf from the frame. The latching mechanism includes an arm having a slot formed therein that receives a post, pin, peg, or other projection extending from the top flange of the shelf bracket. During installation, the post is inserted into the slot while the latching mechanism is in an unlocked state. The engagement between the post and the slot defines a pivot point about which the shelf rotates when transitioning between open and closed positions. Once the post is received within the slot, the arm is moved to a locked state in which the post is retained within the slot, permitting the shelf to pivot between the open and closed positions while maintaining the connection between the shelf and the shelf bracket.

The arm includes a handle, grip, lever, tab, or other actuator that a user grasps to move the shelf between positions. As the shelf is moved toward the closed position, the handle slides along a ramped section of the latching mechanism, causing a locking tab, latch, detent, pawl, or catch to deflect. When the shelf reaches the closed position, a side of the handle abuts against a face of the locking tab, preventing the handle from moving to an unlocked position and thereby securing the shelf to the shelf bracket. The end of the handle is disposed within a pocket defined by an enclosure, which prevents disengagement or snagging on the end of the handle. To release the shelf from the closed position, the locking tab is deflected to disengage from the handle, permitting the arm to rotate and allowing the shelf to pivot to the open position.

The engagement between the shelf and the shelf bracket forms a hinged connection that permits the shelf to rotate relative to the shelf bracket. The post received within the slot of the arm establishes the hinge axis about which the shelf pivots. This hinged connection allows the shelf to swing outward from the cabinet to an open position for access to the trays and internal components, and to swing inward to a closed position for normal operation and storage within the cabinet. The shelf bracket and hinge arrangement is configured such that cables route through the shelf bracket structure and along the rotational axis of the hinge. By routing cables through the bracket and along the pivot axis, the cables experience minimal displacement as the shelf transitions between open and closed positions. This routing configuration reduces tugging, pulling, or strain on the cables during opening and closing operations, which helps prevent damage to the fiber optic cables and maintains the integrity of the connections within the trays.

Each shelf includes multiple trays arranged in rows for fiber optic cable management and splicing operations. In an embodiment, a shelf may include six trays arranged in two rows of three trays each. A spine extends along the center of the shelf between the two columns of trays, providing a central channel for routing cables to the individual trays. Each tray provides a designated area for fiber optic cable management and includes routing channels and storage areas for organizing fiber optic cables. The trays include a channel that provides a pathway for routing fiber optic cables, with openings positioned along the channel to facilitate routing. The trays include a base that forms the bottom surface, a shelf portion positioned within the tray for organizing and securing splice sleeves and fiber connections, and tabs, fingers, ribs, projections, or other retainers that serve to retain and guide fiber optic cables within the tray. The shelf portion and the base define separate loops, traces, or routing paths within the trays to distinguish those fiber optic cables that are in use from those that are unused. A splice region is located in a central portion of the tray, providing a designated area for housing splice sleeves and managing spliced fiber connections. The trays include hinges, pivots, living hinges, or other flexible connections that enable them to pivot between open and closed positions for access during splicing operations. In an embodiment, dark fiber may be stored in an outer track on top of the tray while active fiber may be routed below the tabs to the splice region. The trays may include a snap-on cap, cover, or lid that closes and protects the fiber optic cables and splice connections housed within the tray.

The shelf includes clamps, clips, fasteners, retainers, grippers, or other securing elements configured to secure cables within receptacles formed in the shelf. In contrast to prior cable retention approaches that require a cable to be threaded or slid horizontally through a restricted opening, the clamp described herein receives a cable loaded from above into the V-shaped opening, reducing installation time and eliminating the need for precise lateral alignment during cable placement.

Each clamp includes a top, a bottom, and a base from which a first arm and a second arm extend, forming a V-shaped configuration that defines an opening for receiving a cable. The clamp is movable between a first state and a second state. In the first state, the first arm and the second arm are spaced apart to receive a cable therebetween. When the clamp is depressed from the first state to the second state within a receptacle formed in the shelf, the first sidewall and the second sidewall of the receptacle act on the first arm and the second arm, respectively, urging the first arm and the second arm toward one another to pinch and secure a cable disposed between them. The secure retention of cables within the receptacles prevents cable movement that could otherwise cause signal degradation, fiber damage, or disconnection of spliced connections within the trays. The clamping mechanism also reduces the likelihood of cables being pulled out of the receptacles during installation, maintenance, or other handling operations.

The shelf may include any number of receptacles configured to receive the clamps, with each clamp being individually addressable and depressable to secure a corresponding cable. Each receptacle is defined by a first sidewall and a second sidewall that extend from a deck of the shelf, with a top surface disposed on the sidewalls. The receptacle includes an inlet through which cables enter and an outlet through which cables exit after being secured.

Cables entering the shelf are first secured by the clamps and then routed through a channel. A divider separates the channel into a first channel and a second channel. The first channel routes fiber optic cables toward the trays for splicing operations, while the second channel provides an alternative routing path for tracer fibers. In an embodiment, the tracer fibers may be bare, unpolished, and unterminated fibers that are cut without cleaving, such as with scissors. The inherent stiffness of the glass fiber may permit the tracer fiber to be pushed through the guides and compliant retainers without requiring pulling or specialized termination.

Guides, tubes, sleeves, channels, conduits, or other routing structures are positioned along the routing path to direct and manage the tracer fibers. The guides facilitate organized routing of the tracer fibers from the second channel toward passages in the tray that are used for tracing, maintaining proper alignment and preventing the tracer fibers from becoming tangled or displaced during installation and operation. The guides may also hold the tracer fibers in place, securing the cables within the defined routing path as they traverse the shelf toward the tracer system components. In an embodiment, each guide is formed by a first wall and a second wall that are spaced apart, with a top wall spanning between them to create an enclosed structure defining a passage through which tracer fibers can be routed. The passage may include internal surfaces angled or faceted to redirect a tracer fiber that enters at an oblique angle, guiding the tracer fiber toward a correct exit trajectory. This self-correcting geometry permits bare, unpolished tracer fibers to be pushed through the guide without precise angular alignment, accommodating natural variations in fiber stiffness and insertion angle during installation.

The shelf may include compliant retainers, elastomeric grippers, flexible fingers, resilient clips, spring-loaded retainers, or other flexible securing elements configured to secure tracer fibers. Each compliant retainer is depressable from a first state to a second state. In the second state, and while being depressed, tracer fibers may be disposed through the compliant retainers. When released, the compliant retainers return to the first state. In the first state, the compliant retainers secure the tracer fibers and prevent them from backing out. After passing through the compliant retainers, the tracer fibers may route through passages formed in a rail structure coupled to the shelf. In an embodiment, each compliant retainer includes a body from which a neck extends, with a first branch and a second branch extending from the neck. A passage is formed within the compliant retainer between the branches, providing a pathway through which tracer fibers are routed and retained. The compliant retainers may be formed as a strip including multiple compliant retainers arranged in a linear array along a common body. The strip may include tabs that secure the strip to the shelf, and slots formed in the body that receive alignment features of the coupler.

The shelf includes a door having apertures through which ends of the tracer fibers are visible. Each aperture aligns with a corresponding passage in the rail structure, allowing light transmitted through the tracer fibers to be visible through the door when the door is in a closed position. A screen, lens, diffuser, filter, translucent panel, or other light-dispersing element coupled to the door serves as a diffusing element that disperses light emerging from the tracer fibers, making the tracer function visible to a technician.

A coupler is configured to interface with the tracer fibers for circuit identification purposes. The coupler enables a technician to transmit visible light from a visual fault locator or similar light source through a selected tracer fiber, allowing the technician to visually confirm which circuit is being traced at the shelf. The tracer system may operate bidirectionally, such that either end of the tracer fiber may serve as the launch end or the receive end. A technician may couple a light source at one end and observe the light at the opposite end, or vice versa.

The coupler includes a housing that supports a ferrule, sleeve, bushing, alignment tube, or other alignment structure configured to receive and align a fiber optic cable for optical coupling. The coupler includes alignment features, such as prongs, tabs, flanges, pins, posts, projections, or keys, that extend from the housing and engage with corresponding receptacles on the shelf. A clip, clamp, retainer, fastener, or other strain relief element is disposed on the housing and secures a cable to the housing while providing strain relief. The ferrule defines a bore through which a fiber optic cable is disposed, with an opening at its distal end through which the fiber optic cable can interface with a tracer fiber. In an embodiment, the opening may include a conical acceptance cone that guides and centers the tracer fiber as the coupler is engaged with the shelf. The conical entrance may accommodate variations in the position or angle of the tracer fiber, guiding the tracer fiber toward the center of the bore for alignment with the fiber optic cable. The ferrule may be formed from stainless steel, ceramic, glass, or other suitable materials. When the coupler is engaged with the shelf, light transmitted through the fiber optic cable travels through the tracer fiber and emerges at the far end, allowing a technician to visually identify which circuit is being traced. The coupler is movable between different passages on the shelf, enabling the coupler to interface with different tracer fibers. By repositioning the coupler to engage with different passages, a technician can sequentially trace multiple circuits, troubleshoot connections across different fibers, and identify specific circuits within the fiber optic distribution system without requiring multiple coupling devices.

Although the foregoing description has focused on fiber optic cables, the systems and components described herein may be used with other types of cables, wires, conductors, or transmission media. For example, the cabinet, shelves, trays, clamps, receptacles, and routing structures may be configured to accommodate copper cables, coaxial cables, hybrid fiber-coaxial cables, electrical wires, data cables, or other signal-carrying media. The cable retention mechanisms, routing channels, and organizational features described herein are applicable to a variety of cable types and are not limited to fiber optic applications.

In an embodiment, the fiber optic distribution system may include a breakout kit configured to transition high-fiber-count trunk cables into smaller fiber groups for distribution to individual shelves. The breakout kit may include a housing having multiple slots or channels on opposing sides. A first set of slots may be configured to receive and strain-relieve a grouped fiber bundle entering the breakout kit, while a second set of slots may be configured to receive and strain-relieve individual fiber sub-groups exiting the breakout kit. The dual-side strain relief configuration may protect fibers during the breakout transition and prevent sleeve pullout and fiber exposure. The breakout kit may include a cover or cap that snaps onto the housing, locking the fiber groups in place and providing additional strain relief. The breakout kit may further include handles, latches, or other engagement features that permit the breakout kit to be inserted into and removed from the cabinet or frame. In an embodiment, the breakout kit may be assembled on a work surface and then snapped into the frame, facilitating tool-less installation.

The first set of slots may have a larger diameter than the second set of slots to accommodate the grouped fiber bundle, which has a greater outer diameter than the individual sub-groups. In an embodiment, each fiber group may be enclosed within a protective sleeving, such as a split sleeve, braided sleeve, heat-shrink tubing, or spiral wrap, prior to insertion into the slots. The outer diameter of the sleeving may be built up by wrapping one or more layers of tape, such as a felt-based tape, foam tape, self-fusing silicone tape, or fabric tape, around the sleeving to achieve a snug fit within the slot. The sleeving and tape may be dropped into the slot from above rather than threaded through, facilitating rapid, tool-less installation. Once the cover or cap is snapped onto the housing, the wrapped fiber groups are retained within the slots on both sides of the housing, providing strain relief at both the grouped bundle entry point and the individual sub-group exit points

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment, or instance, may be combined with the features of other embodiments or instances. Such modifications and variations are intended to be included within the scope of the disclosure and appended claims.

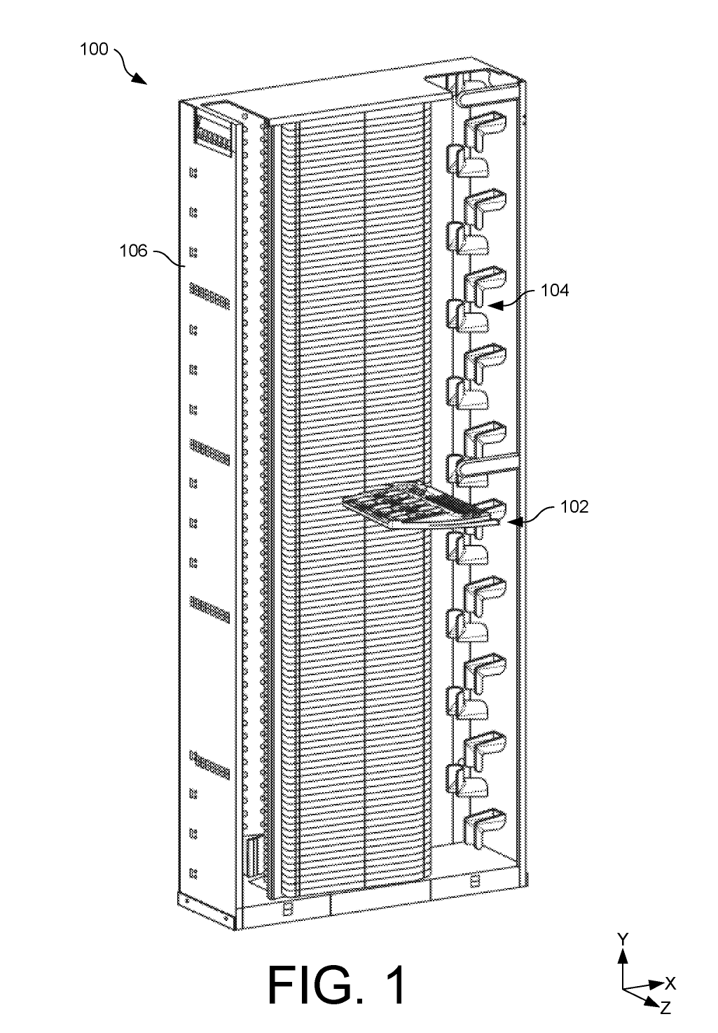

FIG. 1 illustrates an isometric view of a cabinet 100 configured to receive multiple shelves 102. The cabinet 100 includes a body 106 that forms an interior 104 within which the shelves 102 are disposed. As used herein, “shelves 102” may refer to a plurality of shelves, while “shelf 102” may refer to a single shelf. The body 106 provides structural framework and support for the shelves 102 and other components housed within the cabinet 100. The interior 104 of the cabinet 100 is configured to accommodate a plurality of shelves 102 arranged in a vertical stack. In an embodiment, one of the shelves 102 may be positioned in an extended or open position, pivoted outward from the body 106 to provide access to the shelf 102, while remaining shelves 102 may be positioned in a closed position within the interior 104 of the cabinet 100. The cabinet 100 may include cable management features along one side, with multiple spools, guides, or routing elements arranged vertically to facilitate routing of cables to the respective shelves 102. The body 106 of the cabinet 100 extends vertically and may include mounting provisions for securing the shelves 102 at various heights within the interior 104.

Although not shown in FIG. 1, a cover, door, panel, or other closure element may be coupled to the cabinet 100 to enclose the interior 104 and protect the shelves 102 and associated components from environmental conditions, debris, or unauthorized access. The cover may be hinged, removable, or slidable to provide access to the shelves 102 when needed. Additionally, any number of cabinets 100 may be arranged in various configurations, including stacked end to end, positioned side by side, or arranged in other orientations to accommodate the capacity requirements of a particular installation. Multiple cabinets 100 may be coupled together or mounted adjacent to one another to form a larger fiber optic distribution system.

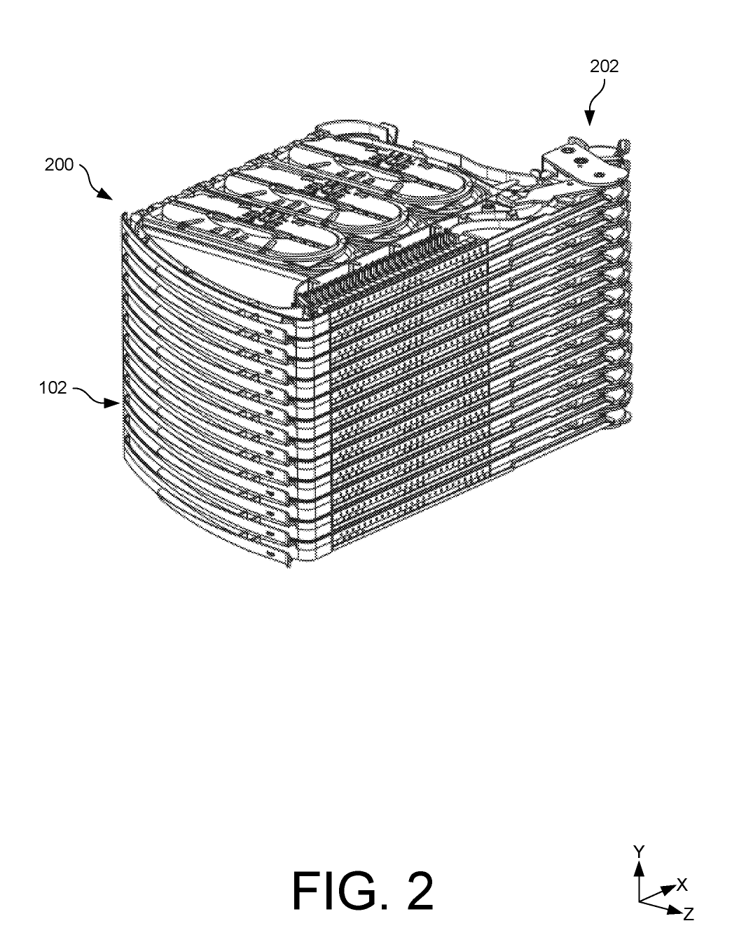

FIG. 2 illustrates an isometric view of a shelf assembly 200. The shelf assembly 200 includes a plurality of shelves 102 arranged in a stacked configuration. The shelves 102 are coupled to a frame 202, which provides structural support for the shelf assembly 200. The frame 202 is positioned at one side of the shelf assembly 200 and includes mounting features that enable the shelves 102 to be attached and supported. Each shelf 102 extends horizontally from the frame 202, creating multiple levels within the shelf assembly 200. The stacked arrangement of the shelves 102 allows for organized storage and management of components within the shelf assembly 200. The frame 202 facilitates the connection of the shelf assembly 200 to other structures or enclosures, such as the cabinet 100. In an embodiment, the frame 202 may be configured to receive any number of shelves 102 depending on the capacity requirements of a particular installation. The shelves 102 may be spaced apart along the frame 202 at uniform or varying intervals to accommodate different cable routing configurations and access requirements.

The shelf assembly 200, such as the frame 202, may be secured to the cabinet 100 using fasteners, brackets, clips, or other mounting hardware to maintain the position of the shelf assembly 200 within the interior 104 of the cabinet 100.

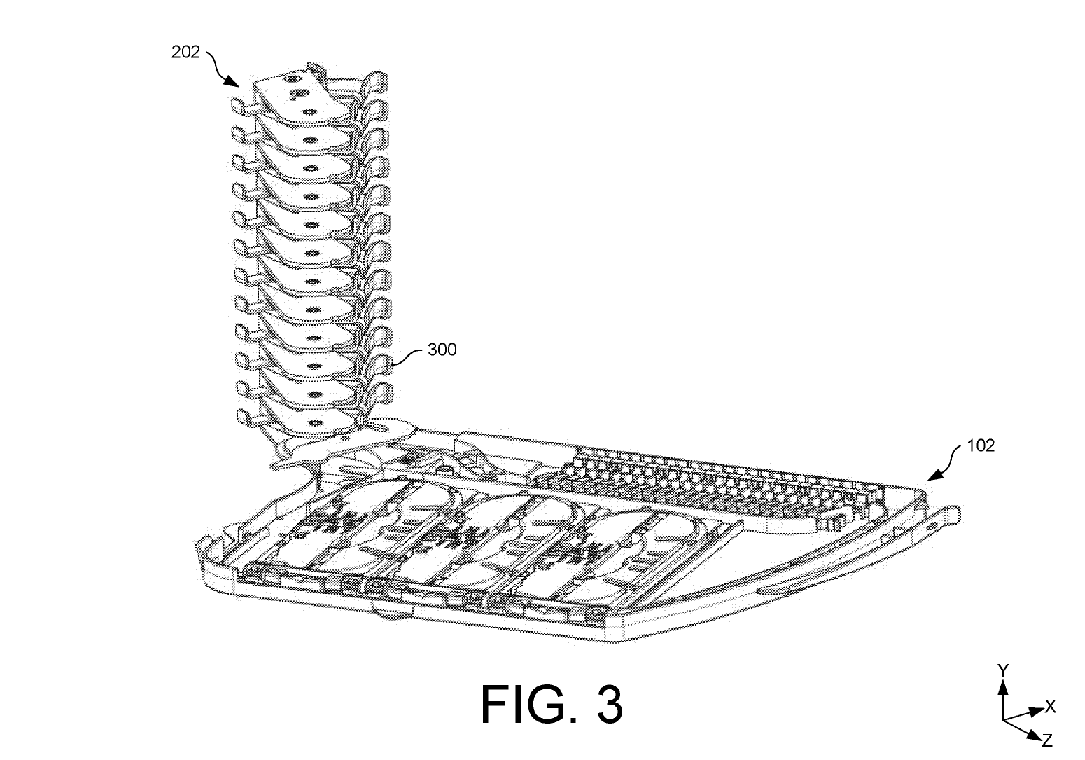

FIG. 3 illustrates an isometric view of the shelf assembly 200 including the frame 202 and a shelf 102. The frame 202 extends vertically and includes a series of shelf brackets 300 arranged along the length of the frame 202. Each shelf bracket 300 is configured to receive and support a shelf 102. A single shelf 102 is shown coupled to the frame 202 via one of the shelf brackets 300, with the remaining shelf brackets 300 shown without shelves installed. The frame 202 provides structural support for shelves 102, enabling the shelves 102 to be positioned at various heights along the frame 202. The shelf brackets 300 are spaced apart along the frame 202 to accommodate the shelves 102 in a vertically aligned configuration. A base portion of the frame 202 extends horizontally and may include features for mounting or positioning the shelf assembly 200. The arrangement of the shelf brackets 300 on the frame 202 facilitates organization and access to shelves 102 within the shelf assembly 200.

In an embodiment, the shelf brackets 300 may be coupled together to form the frame 202. The shelf brackets 300 may include coupling features, such as posts, receptacles, through holes, fastener openings, or interlocking elements, that enable adjacent shelf brackets 300 to be connected to one another. Any number of shelf brackets 300 may be coupled together depending on the desired capacity of the shelf assembly 200. For example, a shelf assembly 200 configured to support a larger number of shelves 102 may include a greater number of shelf brackets 300 coupled together, while a shelf assembly 200 configured to support fewer shelves 102 may include fewer shelf brackets 300. The modular configuration of the shelf brackets 300 allows the frame 202 to be assembled, expanded, or reconfigured to accommodate varying installation requirements.

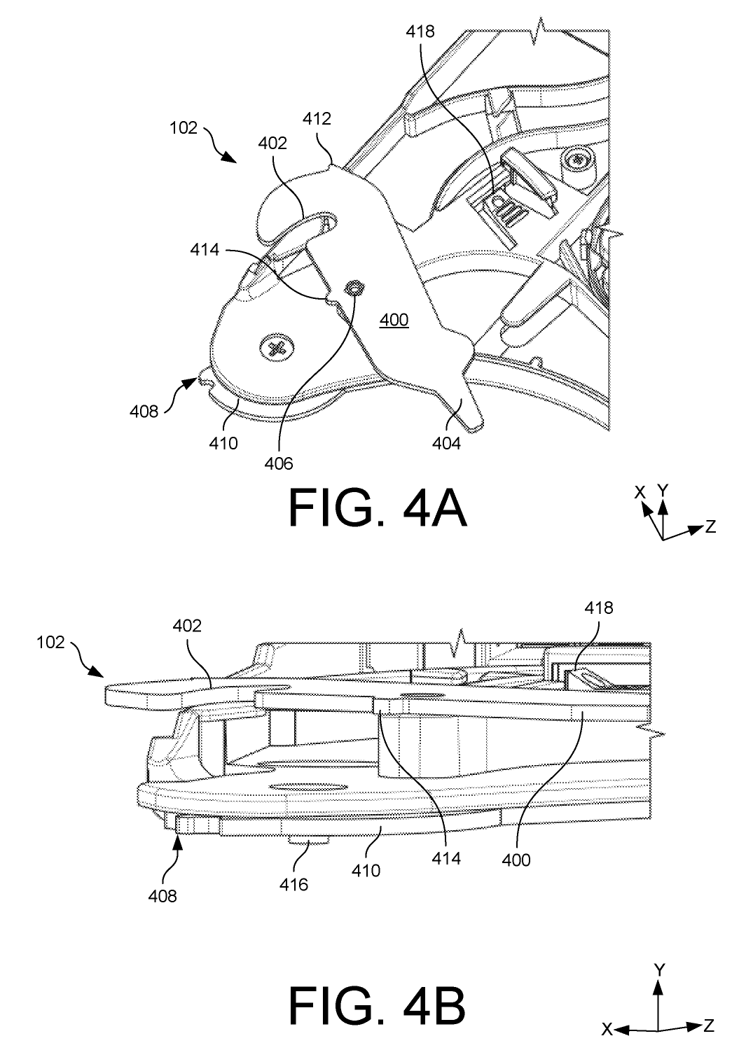

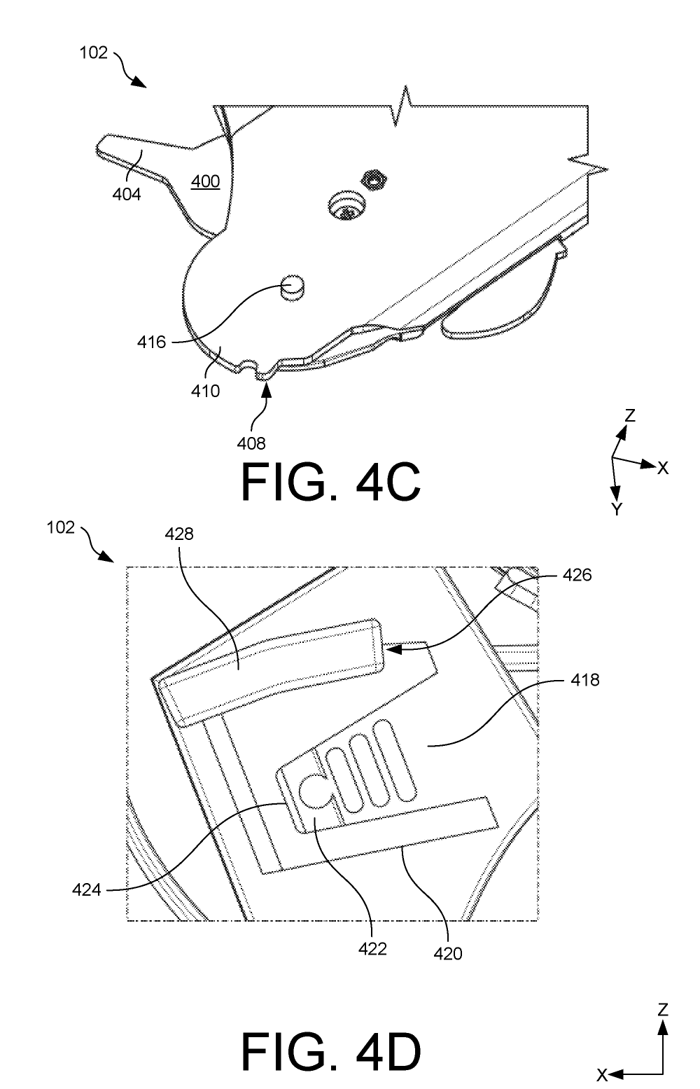

FIGS. 4A-4D illustrate views of the shelf 102 and associated mounting components for coupling the shelf 102 to the shelf bracket 300. The shelf 102 includes an arm 400 having a slot 402 formed therein. The slot 402 is configured to engage with corresponding features of the shelf bracket 300, enabling the shelf 102 to be positioned and pivoted between open and closed positions relative to the shelf bracket 300. A handle 404 extends from the arm 400 and provides a graspable surface that users can manipulate to move the shelf 102 between different positions. The arm 400 is configured to rotate about a pivot point 406, which enables the arm 400 to transition between locking and unlocking positions relative to the shelf bracket 300. As shown in FIGS. 4A-4D, the arm 400 is depicted in an unlocked position, with the slot 402 and handle 404 oriented to permit movement of the shelf 102 relative to the shelf bracket 300.

A protrusion 408 extends from the arm 400 and is configured to engage with corresponding features of the shelf bracket 300 to secure, orient, or align the shelf 102 in position. The shelf 102 includes a flange 410 that is disposable within a mounting slot formed in the shelf bracket 300. The flange 410 facilitates the structural connection between the shelf 102 and the shelf bracket 300. A protrusion 412 extends from the shelf 102 and is configured to engage with a corresponding notch on the shelf bracket 300 to provide positioning and alignment. Similarly, a protrusion 414 extends from the shelf 102 and is configured to engage with another notch on the shelf bracket 300 to provide additional positioning, alignment, and orientation stability. A post 416 extends from the flange 410 and is receivable within a corresponding receptacle formed in the shelf bracket 300. When the post 416 is received within the receptacle, the shelf 102 is secured in the closed position relative to the shelf bracket 300.

A locking tab 418 is positioned on the shelf 102 and is engageable with the handle 404 when the shelf 102 is in the closed state. The engagement between the locking tab 418 and the handle 404 locks the shelf 102 into place, preventing inadvertent movement or disengagement of the shelf 102 from the shelf bracket 300. A cutout 420 is formed as a relief or channel in the shelf 102 that provides clearance for the locking tab 418 to deflect during operation of the locking mechanism. A ramped section 422 is positioned along the path of the handle 404, and as the handle 404 slides along the ramped section 422 during movement toward the closed position, the locking tab 418 is caused to deflect into the cutout 420. A face 424 is formed on the locking tab 418 and is positioned such that when the shelf 102 is in the locked position, a side of the handle 404 abuts against the face 424. This abutment between the handle 404 and the face 424 prevents the handle 404 from moving to an unlocked position. A pocket 426 is formed in the shelf 102 and is configured to receive the end of the handle 404. An enclosure 428 defines the pocket 426 and includes a roof and sidewalls that surround the end of the handle 404 when disposed therein. The enclosure 428 prevents disengagement or snagging on the end of the handle 404 during operation.

In an embodiment, the locking mechanism is configured to operate without tools, enabling tool-less installation and removal of the shelf 102. To lock the shelf 102 to the shelf bracket 300, a user grasps the handle 404 and moves the arm 400 toward the closed position. As the arm 400 moves toward the closed position, the handle 404 slides along the ramped section 422, which causes the locking tab 418 to deflect into the cutout 420. When the shelf 102 reaches the closed position, the locking tab 418 returns to an undeflected state, and the face 424 of the locking tab 418 abuts against the handle 404. This abutment prevents the handle 404 from moving back toward the unlocked position, thereby securing the shelf 102 in the closed and locked configuration. To unlock the shelf 102, a user deflects the locking tab 418 to disengage the face 424 from the handle 404. Once the face 424 is disengaged, the arm 400 is permitted to rotate, which allows the shelf 102 to pivot from the closed position to the open position for access to the trays and internal components.

The arm 400 may be broadly referred to as a latching mechanism, locking mechanism, or securing mechanism that enables the shelf 102 to be secured to and removed from the shelf bracket 300. Although the arm 400 is described as a rotatable element that pivots about the pivot point 406, other mechanisms may be used to secure the shelf 102 to the shelf bracket 300. For example, the latching mechanism may include a slidable latch, a spring-loaded catch, a cam lock, a toggle clamp, a snap-fit connector, a magnetic latch, or other securing elements that provide tool-less attachment and detachment of the shelf 102 from the shelf bracket 300. The particular configuration of the latching mechanism may be selected based on the desired ease of operation, security requirements, and structural constraints of the shelf assembly 200.

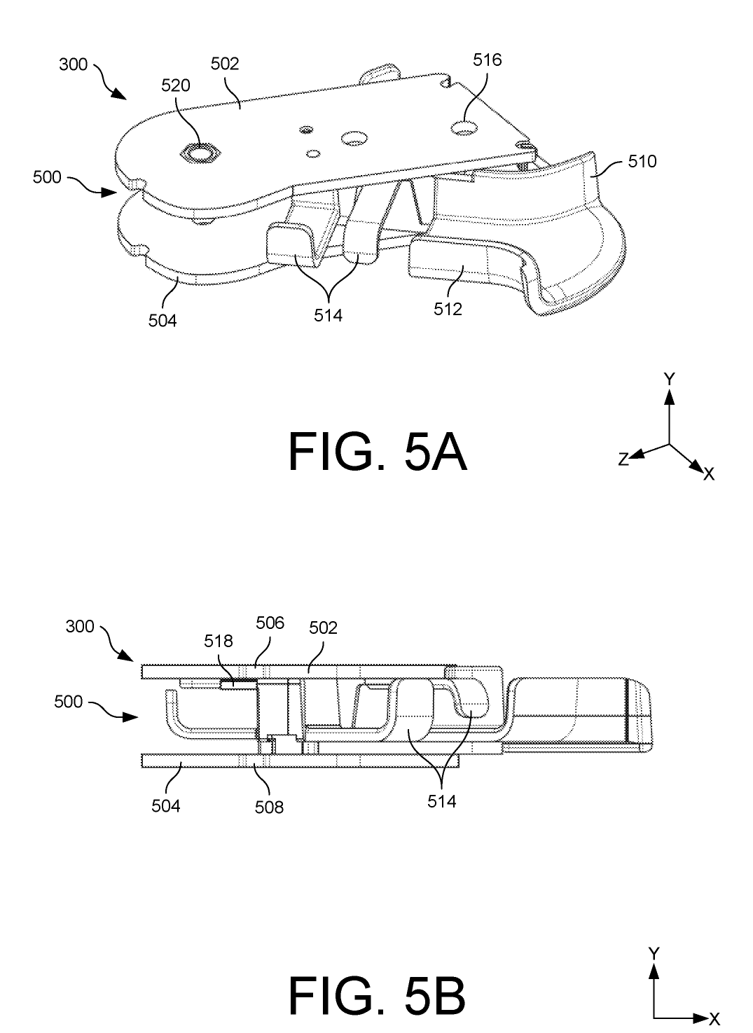

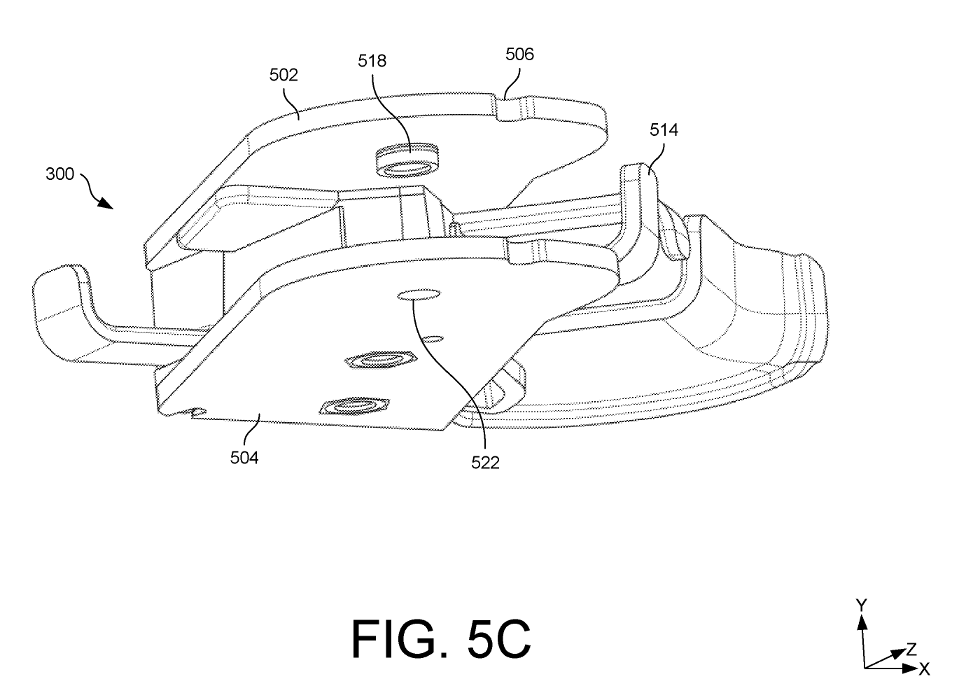

FIGS. 5A-5C illustrate views of the shelf bracket 300. The shelf bracket 300 includes a slot 500 configured to receive components of the shelf 102, such as the arm 400, the flange 410, etc. The slot 500 is defined in part by a top flange 502 and a bottom flange 504 that are spaced apart from one another. The top flange 502 is positioned above the slot 500, and the bottom flange 504 is positioned below the slot 500. The spacing between the top flange 502 and the bottom flange 504 defines the slot 500 into which the arm 400 and the flange 410 of the shelf 102 are at least partially disposed during installation, for example. The arm 400 and the flange 410 are rotatable within the slot 500 during opening and closing of the shelf 102, permitting the shelf 102 to pivot between the open and closed positions while the arm 400 and the flange 410 remain engaged with the shelf bracket 300.

The top flange 502 includes a notch 506 formed therein. The notch 506 is configured to receive and engage with a corresponding protrusion of the shelf 102, such as the protrusion 412, to provide positioning and alignment between the shelf 102 and the shelf bracket 300. The bottom flange 504 includes a notch 508 formed therein. The notch 508 may receive and engage with a corresponding protrusion of the shelf 102, such as the protrusion 408, to provide additional positioning and alignment.

The shelf bracket 300 includes a first sidewall 510 and a second sidewall 512 that extend from the body of the shelf bracket 300. The first sidewall 510 and the second sidewall 512 are configured to funnel and route wires through the shelf bracket 300. In an embodiment, the first sidewall 510 and the second sidewall 512 may define a channel or pathway through which cables pass as the cables are routed from external sources toward the shelf 102.

Retainers 514 are positioned on the shelf bracket 300 and are configured to route and receive cables. The retainers 514 may include tabs, hooks, clips, or other cable management features that guide cables along a defined path through the shelf bracket 300. The retainers 514 help organize and manage cables as the cables pass through the shelf bracket 300 toward the shelf 102.

The shelf bracket 300 includes a through hole 516 formed in the top flange 502. The through hole 516 may receive fasteners, pins, or other coupling elements that couple multiple shelf brackets 300 together when the shelf brackets 300 are assembled to form the frame 202.

A post 518 extends from the shelf bracket 300, such as from the top flange 502. The post 518 is configured to be disposed within the slot 402 of the arm 400 of the shelf 102. The engagement between the post 518 and the slot 402 defines the pivot point 406 about which the shelf 102 rotates when transitioning between open and closed positions. The post 518 serves as a hinge element that enables the shelf 102 to pivot relative to the shelf bracket 300. When the post 518 is disposed within the slot 402 of the arm 400 and the arm 400 moves to the locked position, the post 518 is retained within the slot 402, maintaining the pivoting connection between the shelf 102 and the shelf bracket 300.

The receptacle 520 may be formed as a bore, socket, or recess that receives the post of an adjacent shelf bracket 300, facilitating the coupling of multiple shelf brackets 300 to form the frame 202. The arrangement of the through hole 516 and the receptacle 520 enables the shelf brackets 300 to be stacked and connected in a modular configuration.

The bottom flange 504 includes a receptacle 522 formed therein. The receptacle 522 is configured to receive the post 416 that extends from the flange 410 of the shelf 102. When the shelf 102 is in the closed position, the post 416 is disposed within the receptacle 522, providing a secure engagement point between the shelf 102 and the shelf bracket 300. The receptacle 522 may be formed as a bore, socket, or recess that receives and retains the post 416, stabilizing the shelf 102 in its mounted position relative to the shelf bracket 300.

The shelf bracket 300 and the shelf 102 are configured such that cables route through the shelf bracket 300 and intersect a rotational axis that is concentrically disposed through or between the post 518 and the receptacle 522. By routing the cables through this rotational axis, the cables experience minimal displacement as the shelf 102 transitions between the open and closed positions. This routing configuration reduces tugging or pulling on the cables during opening and closing operations, and minimizes the overall movement of the cables as the shelf 102 pivots about the post 518. The reduced cable movement helps prevent strain on the fiber optic cables and maintains the integrity of the connections within the trays housed on the shelf 102.

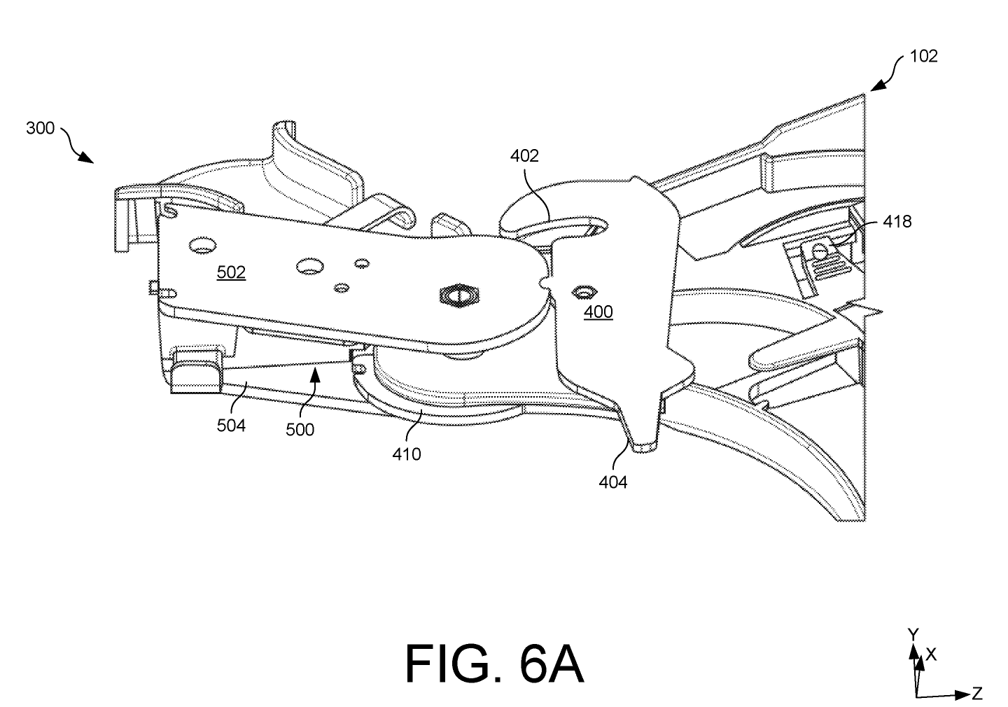

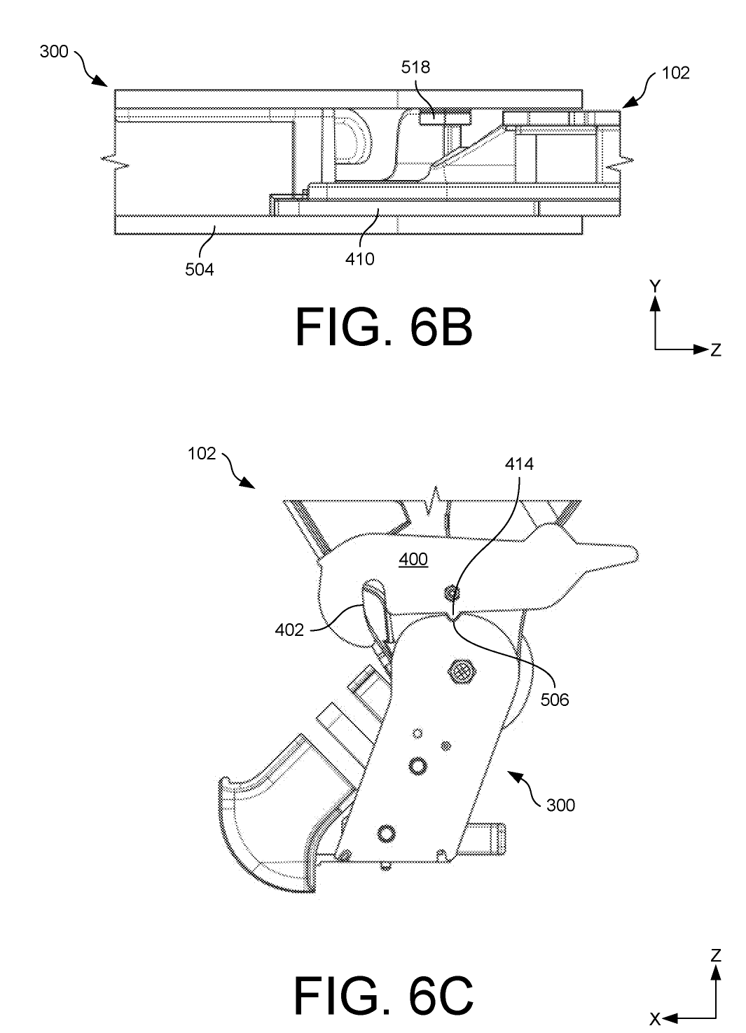

FIGS. 6A-6C illustrate the shelf 102 engaged with the shelf bracket 300, with the arm 400 shown in an unlocked state. The slot 402 of the arm 400 receives the post 518 extending from the top flange 502, establishing the pivot point about which the shelf 102 rotates when transitioning between open and closed positions. The flange 410 extends into the slot 500 defined between the top flange 502 and the bottom flange 504, while the post 416 is disposed within the receptacle 522 formed in the bottom flange 504 to secure the shelf 102 in the closed position. The handle 404 extends from the arm 400 and remains accessible for user manipulation.

The protrusion 414 of the shelf 102 engages with the notch 506 of the shelf bracket 300, providing positioning and alignment between the components. This engagement, together with the interaction between the post 518 and the slot 402, maintains the shelf 102 in position relative to the shelf bracket 300 while enabling rotational movement.

The arrangement of the arm 400 within the slot 500 allows the shelf 102 to rotate between open and closed positions relative to the shelf bracket 300. When the shelf 102 is in the partially open position, the arm 400 and the flange 410 remain engaged with the shelf bracket 300 while the shelf 102 pivots outward to provide access to the trays and internal components. The engagement between the slot 402 and the post 518 maintains the pivoting connection throughout the range of motion of the shelf 102.

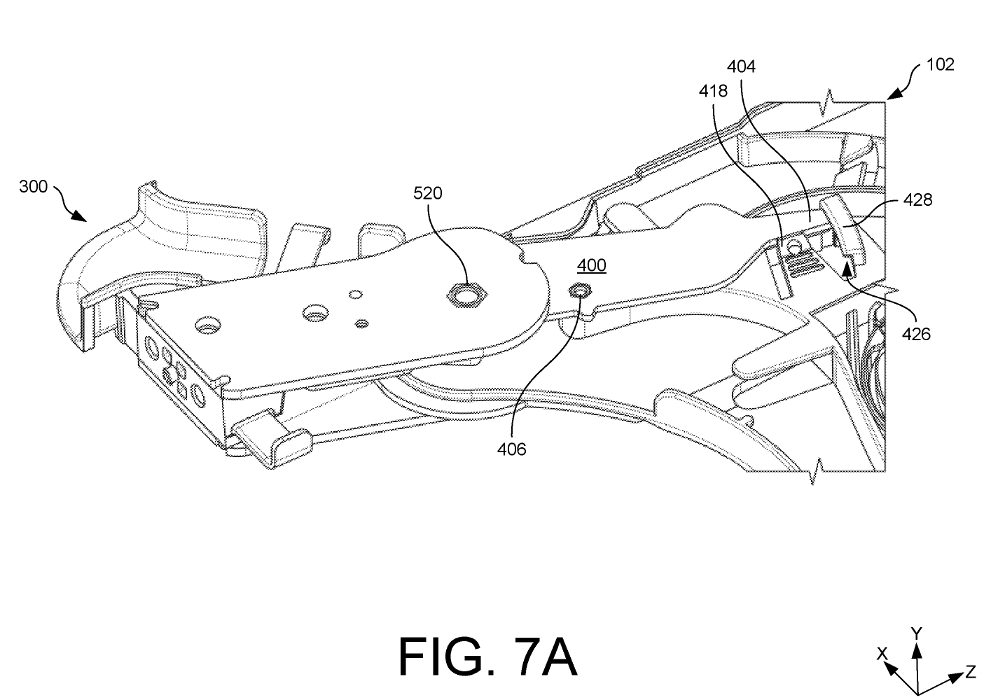

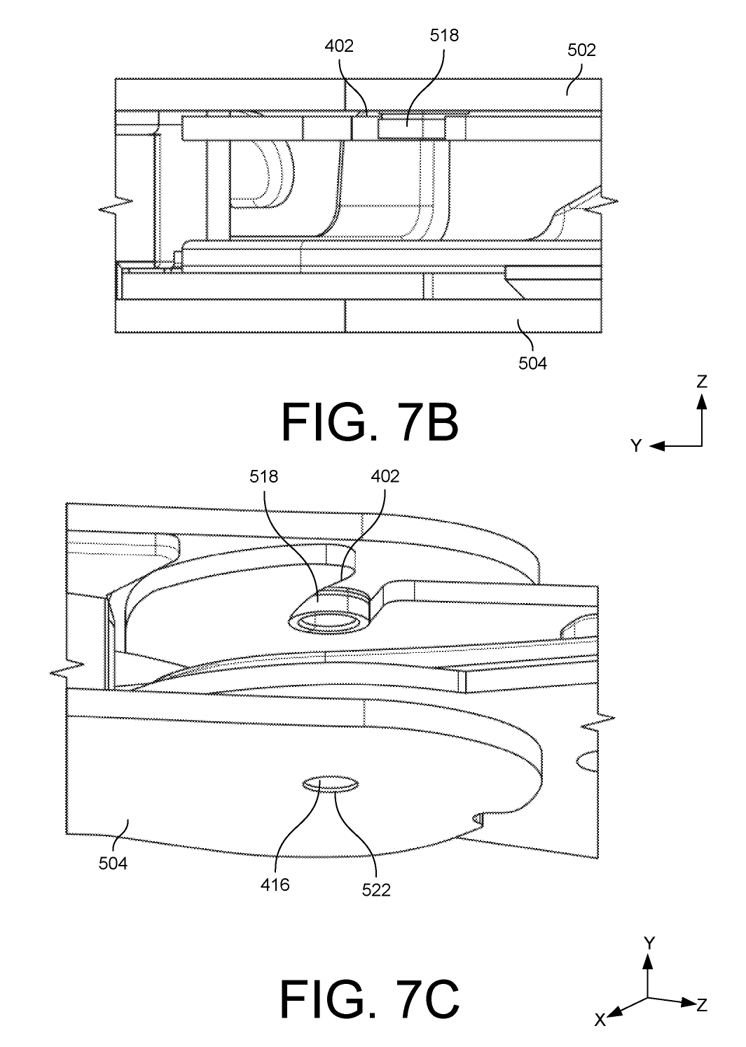

FIGS. 7A-7C illustrate views of the shelf 102 coupled to the shelf bracket 300. The shelf 102 is shown in an assembled configuration with the shelf bracket 300. The arm 400 extends from the shelf 102 and includes the handle 404 positioned at one end for user manipulation. The arm 400 is configured to rotate about the pivot point 406, enabling the shelf 102 to transition between open and closed positions relative to the shelf bracket 300. The engagement between the shelf 102 and the shelf bracket 300 forms a hinged connection that permits the shelf 102 to rotate relative to the shelf bracket 300. The post 518 received within the slot 402 of the arm 400 establishes the hinge axis about which the shelf 102 pivots. This hinged connection allows the shelf 102 to swing outward from the cabinet to an open position for access to the trays and internal components, and to swing inward to a closed position for normal operation and storage within the cabinet.

The locking tab 418 is disposed on the shelf 102 and is configured to engage with features on the arm 400 to secure the shelf 102 in a closed or locked state. The enclosure 428 defines the pocket 426 that receives an end of the handle 404 when the arm 400 is in a locked position, preventing inadvertent disengagement or snagging on the handle 404. The receptacle 520 is formed on a top flange of the shelf bracket 300 and is configured to receive a post from an adjacent shelf bracket 300, facilitating stacking or alignment of multiple shelves 102 within the shelf assembly 200. The arrangement of the arm 400, handle 404, locking tab 418, pocket 426, and enclosure 428 provides a tool-less mechanism for securing and releasing the shelf 102 from the shelf bracket 300.

The slot 402 of the arm 400 engages with the post 518 that extends from the top flange 502. The bottom flange 504 is positioned below the top flange 502, providing structural support for the shelf bracket 300. The slot 402 receives the post 518 to facilitate the rotational mounting of the shelf 102 within the shelf bracket 300.

The post 416 extends from the flange 410 of the shelf 102 and engages with a receptacle 700 formed in the bottom flange 504. The receptacle 700 is configured to receive the post 416, providing a secure engagement point between the shelf 102 and the shelf bracket 300. The top flange 502 and the bottom flange 504 define the slot 500 within which the arm 400 and the flange 410 of the shelf 102 are disposed. The post 518 extends from the top flange 502 and is disposable within the slot 402 of the arm 400, while the receptacle 700 in the bottom flange 504 receives the post 416 to stabilize the shelf 102 in the mounted position.

A gap distance is defined between the arm 400 and the flange 410 to accommodate cables routed through the shelf bracket 300. This gap distance provides clearance for the cables to pass between the arm 400 and the flange 410 as the cables are routed along the rotational axis of the shelf 102. The spacing between the arm 400 and the flange 410 ensures that the cables are not pinched or compressed during installation or during pivoting movement of the shelf 102 between the open and closed positions.

In the locked state, the post 518 is retained within the slot 402 by the arm 400, permitting the shelf 102 to hinge between the open and closed positions without disengagement of the post 518 from the slot 402. This configuration allows the shelf 102 to pivot freely about the post 518 while maintaining the secure connection between the shelf 102 and the shelf bracket 300, ensuring that the shelf 102 remains coupled to the shelf bracket 300 throughout its range of rotational movement.

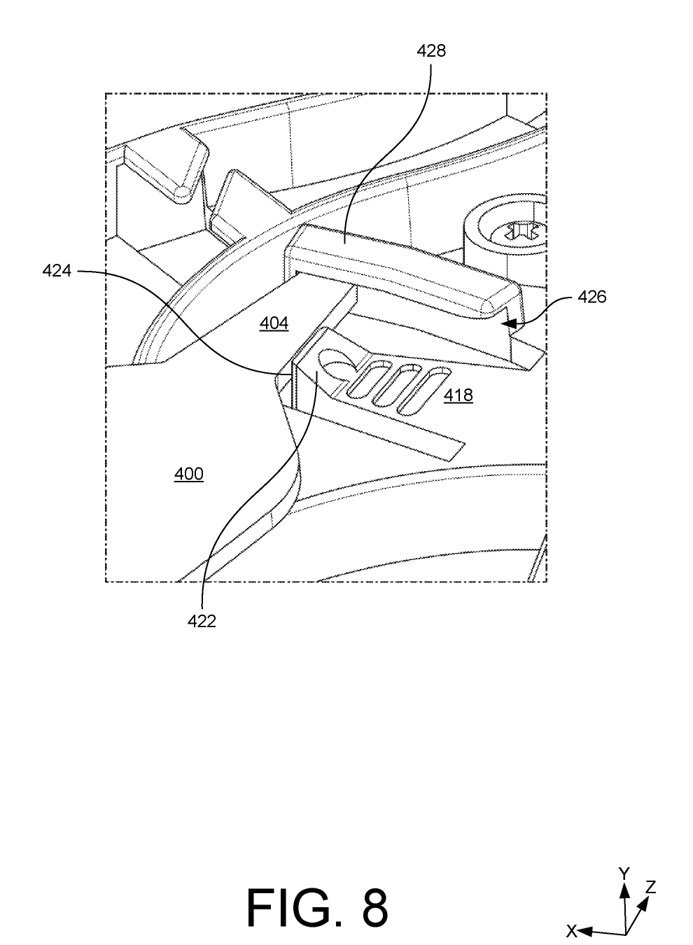

FIG. 8 illustrates a detailed view of a portion of the shelf 102, focusing on the locking mechanism and handle assembly. The arm 400 extends from the shelf 102 and includes the handle 404, which provides a graspable surface for users to manipulate the arm 400 between different positions. The locking tab 418 is positioned on the shelf 102 adjacent to the path of the handle 404.

The ramped section 422 is disposed along the path that the handle 404 travels as the arm 400 moves toward the closed position. As the handle 404 slides along the ramped section 422, the locking tab 418 deflects to permit the handle 404 to pass. The ramped section 422 may include an inclined surface that gradually urges the locking tab 418 to deflect as the handle 404 advances toward the locked position.

The face 424 is formed on the locking tab 418 and is oriented such that when the shelf 102 reaches the closed position, a side of the handle 404 abuts against the face 424. This abutment between the handle 404 and the face 424 prevents the handle 404 from moving back toward an unlocked position. The face 424 may be oriented substantially perpendicular to the direction of travel of the handle 404, providing a stop surface that resists movement of the handle 404 in the unlocking direction.

The pocket 426 is formed in the shelf 102 and is configured to receive an end of the handle 404 when the arm 400 is in the locked position. The enclosure 428 defines the pocket 426 and includes a roof and sidewalls that surround the end of the handle 404 when the handle 404 is disposed within the pocket 426. The enclosure 428 prevents disengagement or snagging on the end of the handle 404 during operation. By enclosing the end of the handle 404 within the pocket 426, the enclosure 428 reduces the likelihood of inadvertent contact with the handle 404 that could cause unintended release of the locking mechanism.

In operation, a user grasps the handle 404 and rotates the arm 400 toward the closed position. As the arm 400 rotates, the handle 404 travels along the ramped section 422, causing the locking tab 418 to deflect. When the handle 404 clears the ramped section 422 and reaches the locked position, the locking tab 418 returns to an undeflected state, and the face 424 of the locking tab 418 engages with the handle 404. The end of the handle 404 is received within the pocket 426 defined by the enclosure 428. In this configuration, the shelf 102 is secured in the closed position, and the engagement between the face 424 and the handle 404 prevents the arm 400 from rotating toward the unlocked position.

To release the shelf 102 from the closed position, a user deflects the locking tab 418 to disengage the face 424 from the handle 404. Once the face 424 is disengaged, the arm 400 may rotate, permitting the shelf 102 to pivot from the closed position to the open position. The locking mechanism may operate without tools, enabling tool-less installation and removal of the shelf 102 from the shelf bracket 300.

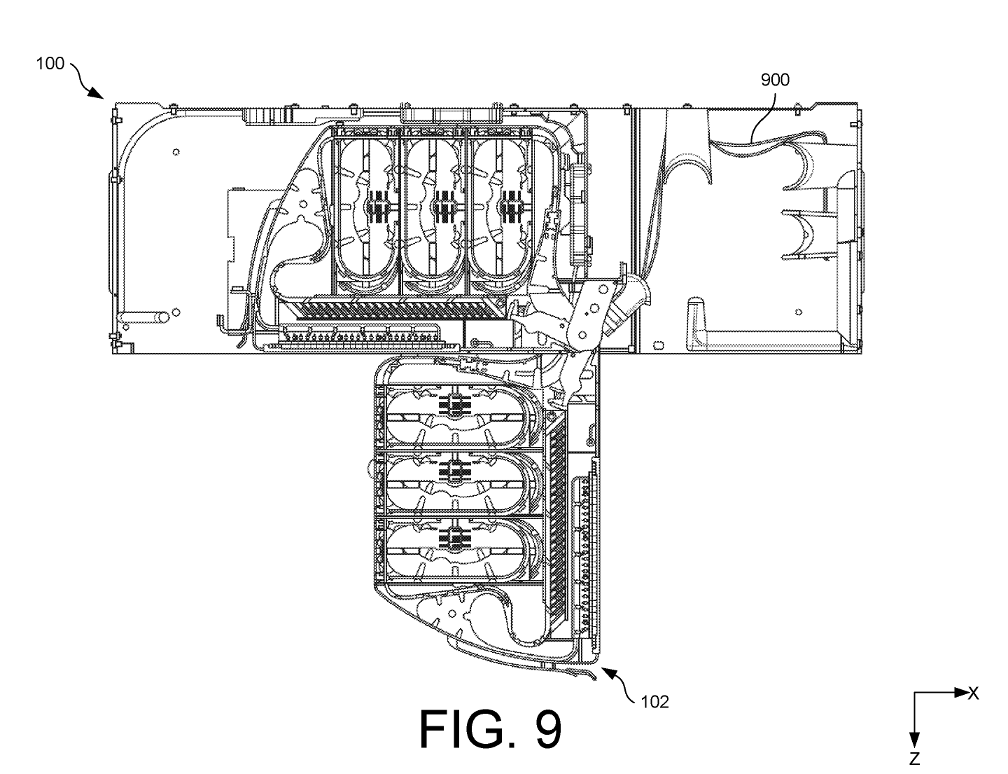

FIG. 9 illustrates a top view of the shelf 102 in an open position relative to the cabinet 100. The shelf 102 is shown pivoted outward from the cabinet 100, revealing the internal components and routing paths within the shelf 102, or more generally, the cabinet 100. A cable 900 is routed through the shelf 102. The cable 900 enters the shelf 102 and follows a defined path through the internal structure of the shelf 102.

The open position of the shelf 102 provides access to the interior of the shelf 102 for installation, maintenance, or inspection of the cable 900 and other internal components. When the shelf 102 is in the open position, a technician may install new cables, reroute existing cables, perform splicing operations within the trays, or inspect the connections and routing paths within the shelf 102. The open position also facilitates troubleshooting and repair operations by exposing the cable 900 and the internal routing channels of the shelf 102.

The cabinet 100 provides the housing structure that receives and supports the shelf 102 when the shelf 102 is in the closed position. The arrangement of the shelf 102 relative to the cabinet 100 demonstrates the pivoting relationship between the shelf 102 and the cabinet 100, with the shelf 102 configured to pivot between the open and closed states to facilitate cable routing and management operations. When the shelf 102 is returned to the closed position, the shelf 102 is received within the interior of the cabinet 100, and the cable 900 remains routed through the shelf 102 along the defined path.

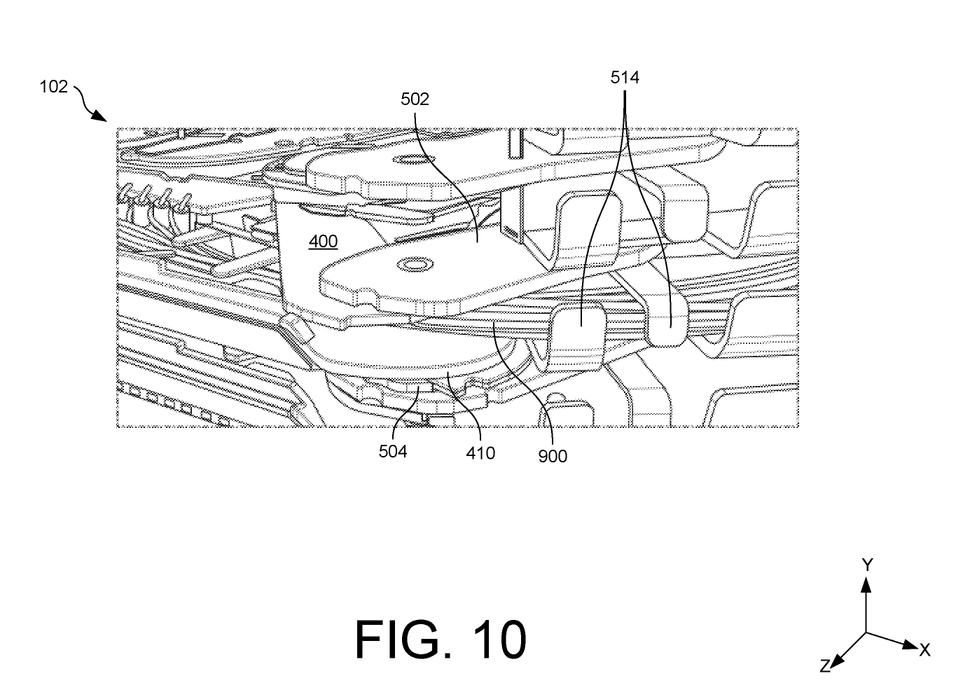

FIG. 10 illustrates a perspective view of a portion of the shelf 102 and associated shelf bracket components, showing the routing of cables 900 through the shelf bracket and the shelf 102. The arm 400 and the flange 410 of the shelf 102 are disposed within a slot formed between the top flange 502 and the bottom flange 504 of the shelf bracket. The top flange 502 and the bottom flange 504 are spaced apart to define the slot that receives the arm 400 and the flange 410 of the shelf 102.

Retainers 514 are positioned on the top flange 502 and are configured to route and receive cables 900. The cables 900 are routed through the retainers 514, which may include tabs, hooks, or other cable management features that guide the cables 900 along a defined path through the shelf bracket. The retainers 514 help organize and manage the cables 900 as the cables 900 pass through the bracket structure toward the shelf 102.

In an embodiment, the retainers 514 may be formed as integral features of the top flange 502, extending from the surface of the top flange 502 to capture and direct the cables 900. The retainers 514 may define openings or channels through which the cables 900 pass, maintaining the cables 900 in a predetermined routing path as the cables 900 transition from external sources into the shelf 102. The arrangement of the retainers 514 on the top flange 502 positions the cables 900 proximate to the rotational axis of the shelf 102, which may reduce displacement of the cables 900 as the shelf 102 pivots between open and closed positions.

The cables 900 may enter the shelf bracket from an external cable management system and pass through the retainers 514 before entering the shelf 102. The retainers 514 may secure the cables 900 in position while permitting the cables 900 to slide or flex as the shelf 102 rotates. In an embodiment, the retainers 514 may include resilient or flexible portions that accommodate movement of the cables 900 during opening and closing operations of the shelf 102.

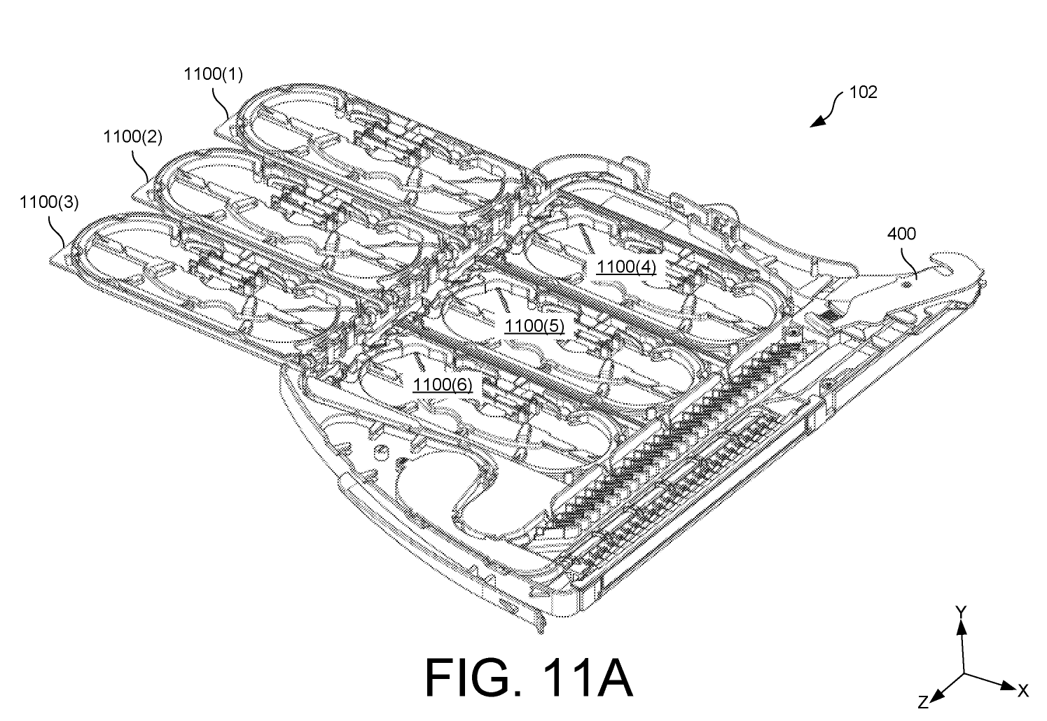

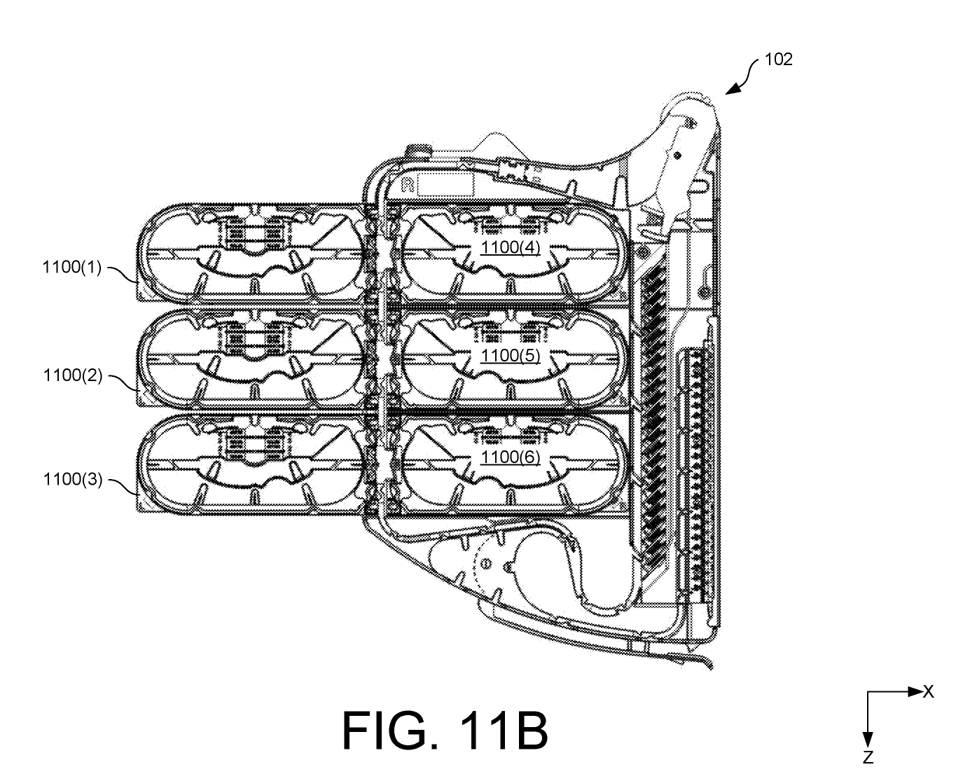

FIGS. 11A and 11B illustrate views of the shelf 102 showing the arrangement of multiple trays 1100 within the shelf 102. As used herein, “trays 1100” may refer to a plurality of trays, while “tray 1100” may refer to a single tray. As shown in FIGS. 11A and 11B, the trays 1100 are depicted in an open position. The trays 1100 may move to a closed position for storage and protection of the fiber optic cables and splice connections housed within the trays.

The shelf 102 includes the arm 400 positioned along one side, which facilitates the pivoting and securing of the shelf 102 within the frame 202. The shelf 102 includes six of the trays 1100 arranged in two rows of three trays each. A first row includes a tray 1100(1), a tray 1100(2), and a tray 1100(3), positioned sequentially from a rear portion toward a front portion of the shelf 102. A second row includes a tray 1100(4), a tray 1100(5), and a tray 1100(6), similarly arranged in sequence. Each tray 1100 provides a designated area for fiber optic cable management and splicing operations.

In an embodiment, the trays 1100(1), 1100(2), and 1100(3) may be similar in structure and configuration. The trays 1100(4), 1100(5), and 1100(6) may be similar in structure and configuration. The trays 1100(1), 1100(2), and 1100(3) may differ from the trays 1100(4), 1100(5), and 1100(6) in one or more structural features, dimensions, or routing configurations.

The trays 1100 are configured to nest within the shelf 102, with each tray 1100 featuring routing channels and storage areas for organizing fiber optic cables. The configuration of the shelf 102 with six of the trays 1100 allows for organized fiber management, with each tray 1100 capable of accommodating multiple splice connections and providing storage for fiber loops.

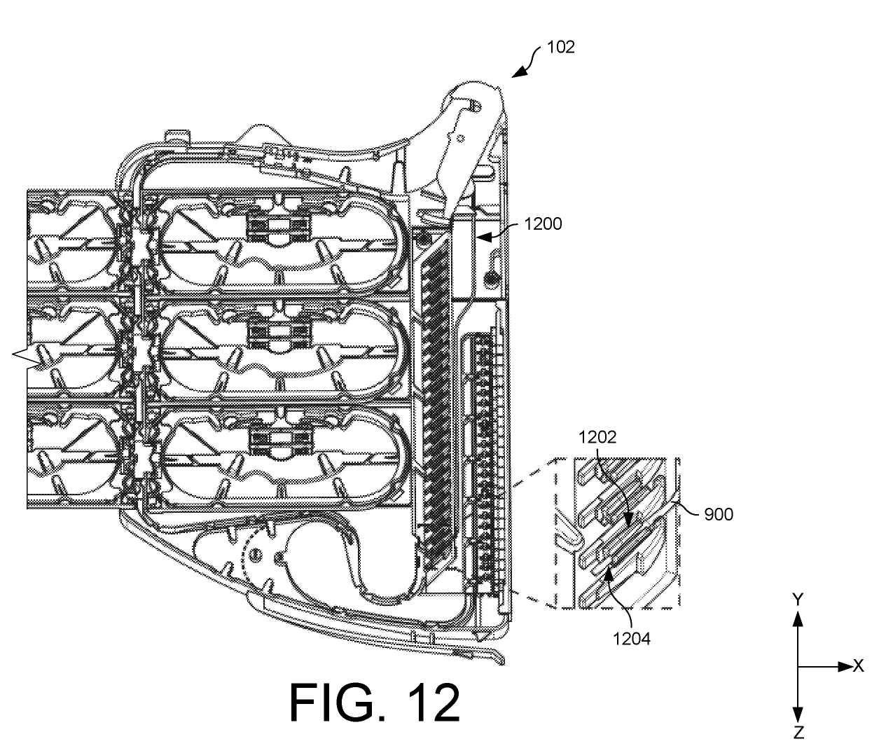

FIG. 12 illustrates an isometric view of the shelf 102 with a detailed inset showing cable routing and retention components. The shelf 102 includes a channel 1200, such as a trough, raceway, conduit, or other routing structure, to route cables 900 into the shelf 102. The channel 1200 receives multiple cables 900 that extend toward the interior of the shelf 102.

The detailed inset of FIG. 12 provides a closer view of a cable retention mechanism. The cable retention mechanism includes a clamp 1202 shown receiving a cable 900. The clamp 1202 is disposed within a receptacle 1204 formed in the shelf 102. The receptacle 1204 receives the clamp 1202 and provides a defined location for securing the cables 900 as the cables 900 enter the shelf 102 from the channel 1200. The shelf 102 includes additional clamps 1202 disposed within corresponding receptacles 1204, with each clamp 1202 configured to secure a cable 900.

As will be explained herein, the clamp 1202 may be depressed to secure the cable 900 within the shelf 102. As shown in FIG. 12, the clamp 1202 is in an undepressed state, with the arms of the clamp 1202 spaced apart to receive the cable 900 therebetween. In the undepressed state, the clamp 1202 is positioned above the receptacle 1204, and the cable 900 may be placed between the arms prior to depressing the clamp 1202 into the receptacle 1204. When the clamp 1202 is subsequently depressed into the receptacle 1204, the sidewalls of the receptacle 1204 act on the arms of the clamp 1202, urging the arms toward one another to pinch and secure the cable 900 disposed between them.

Although described herein as a clamp 1202, the cable retention mechanism may be implemented using various alternative securing elements. The clamp 1202 may represent a clip, fastener, retainer, gripper, holder, or other securing device configured to capture and retain cables within the shelf 102. In an embodiment, the cable retention mechanism may include spring-loaded clips that automatically grip cables when inserted, snap-fit retainers that engage with cables through interference fit, hook-and-loop fasteners that wrap around cables, tie-down anchors that receive cable ties or straps, or elastomeric grommets that frictionally engage with cables passing therethrough. The cable retention mechanism may also include saddle clamps having curved surfaces that conform to the cable profile, wedge-type retainers that secure cables through tapered engagement, or cam-actuated clamps that rotate to capture and release cables. In an embodiment, the cable retention mechanism may include magnetic retainers for cables having ferromagnetic components, adhesive-backed clips that bond to the shelf surface, or threaded fasteners that compress against cables when tightened. The particular configuration of the cable retention mechanism may be selected based on the cable diameter, required retention force, ease of installation and removal, and the frequency with which cables are expected to be added or repositioned within the shelf 102.

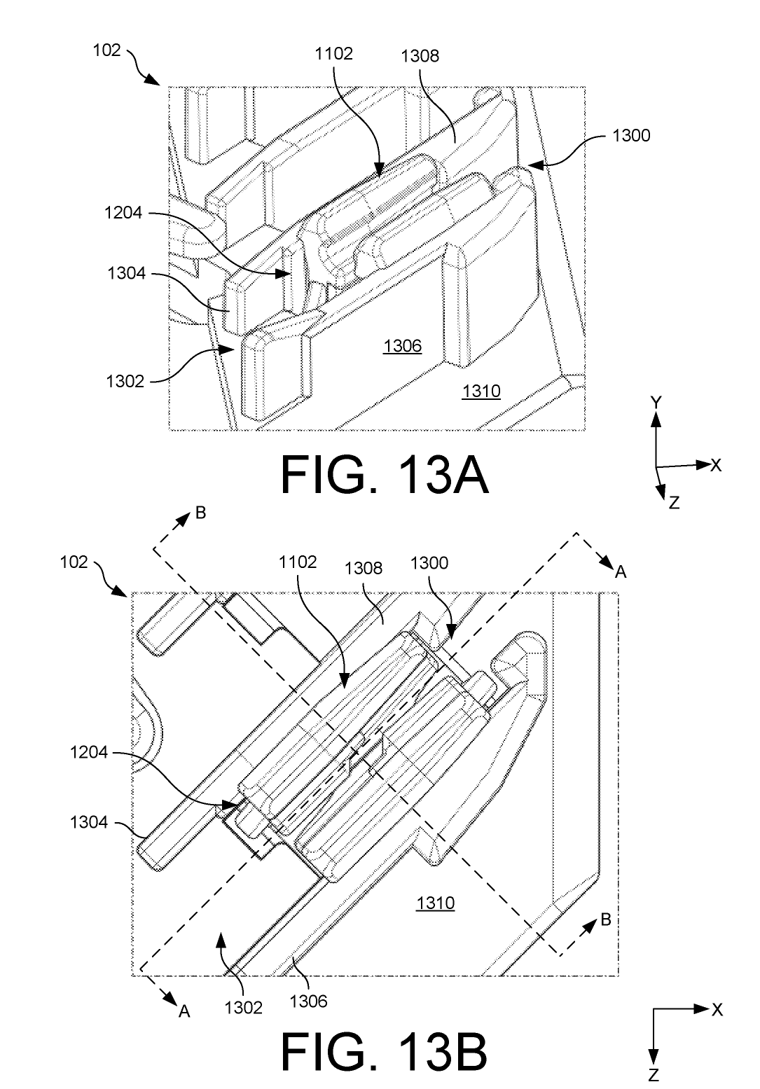

FIGS. 13A and 13B illustrate views of the receptacle 1204 of the shelf 102. In FIGS. 13A and 13B, the cable 900 is shown removed and the clamp 1202 is shown in an undepressed state. The receptacle 1204 includes an inlet 1300 and an outlet 1302.

The receptacle 1204 is defined by a first sidewall 1304 and a second sidewall 1306. The first sidewall 1304 and the second sidewall 1306 are spaced apart from one another to form the receptacle 1204 therebetween that receives the clamp 1202. A top surface 1308 is disposed on the first sidewall 1304 and the second sidewall 1306. The top surface 1308 may form an upper boundary of the receptacle 1204. In the undepressed state, a top of the clamp 1202 is disposed above the top surface 1308, with the clamp 1202 extending upwardly from the receptacle 1204 to permit placement of a cable between the arms of the clamp 1202.

A deck 1310, such as a floor, platform, or base surface, forms a surface of the shelf 102 from which the first sidewall 1304 and the second sidewall 1306 extend. The deck 1310 may serve as a base surface that supports the clamp 1202 when the clamp 1202 is depressed into the receptacle 1204. The first sidewall 1304 and the second sidewall 1306 extend from the deck 1310 to define the receptacle 1204.

In an embodiment, the first sidewall 1304 and the second sidewall 1306 may be tapered or angled inwardly toward one another as the sidewalls extend from the top surface 1308 toward the deck 1310. The tapered configuration of the first sidewall 1304 and the second sidewall 1306 may act on the arms of the clamp 1202 as the clamp 1202 is depressed into the receptacle 1204, urging the arms toward one another to secure a cable disposed between the arms. The spacing between the first sidewall 1304 and the second sidewall 1306 at the deck 1310 may be less than the spacing between the first sidewall 1304 and the second sidewall 1306 at the top surface 1308.

The inlet 1300 and the outlet 1302 may be positioned at opposite ends of the receptacle 1204, defining a path through which cables traverse the receptacle 1204. Cables may enter the receptacle 1204 through the inlet 1300, pass through the channel defined by the first sidewall 1304 and the second sidewall 1306, and exit through the outlet 1302. The clamp 1202 may secure the cable at a location between the inlet 1300 and the outlet 1302.

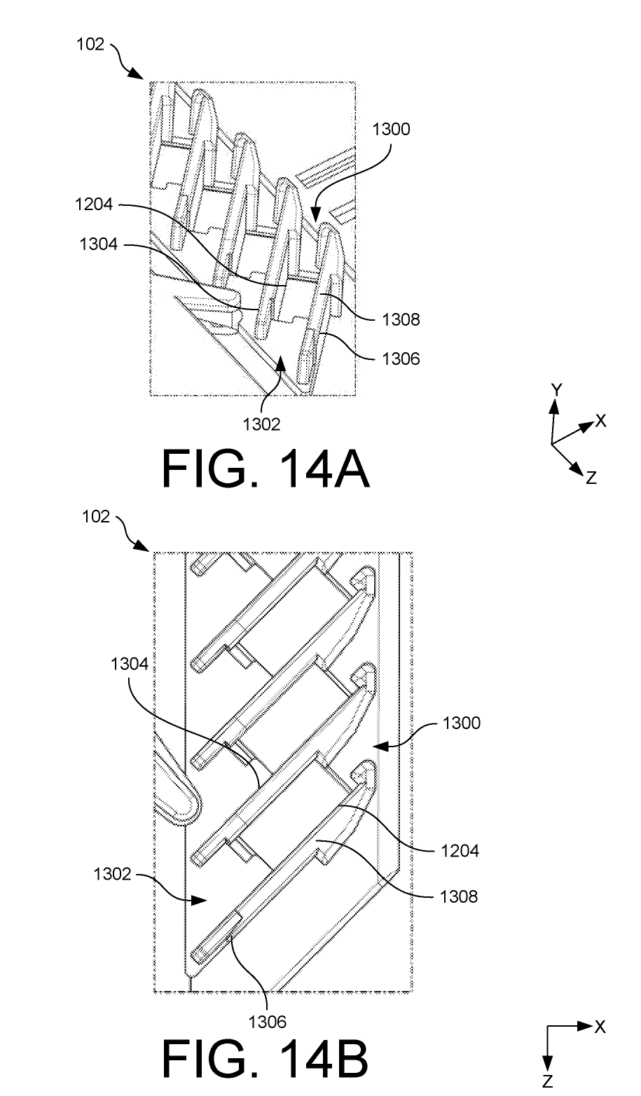

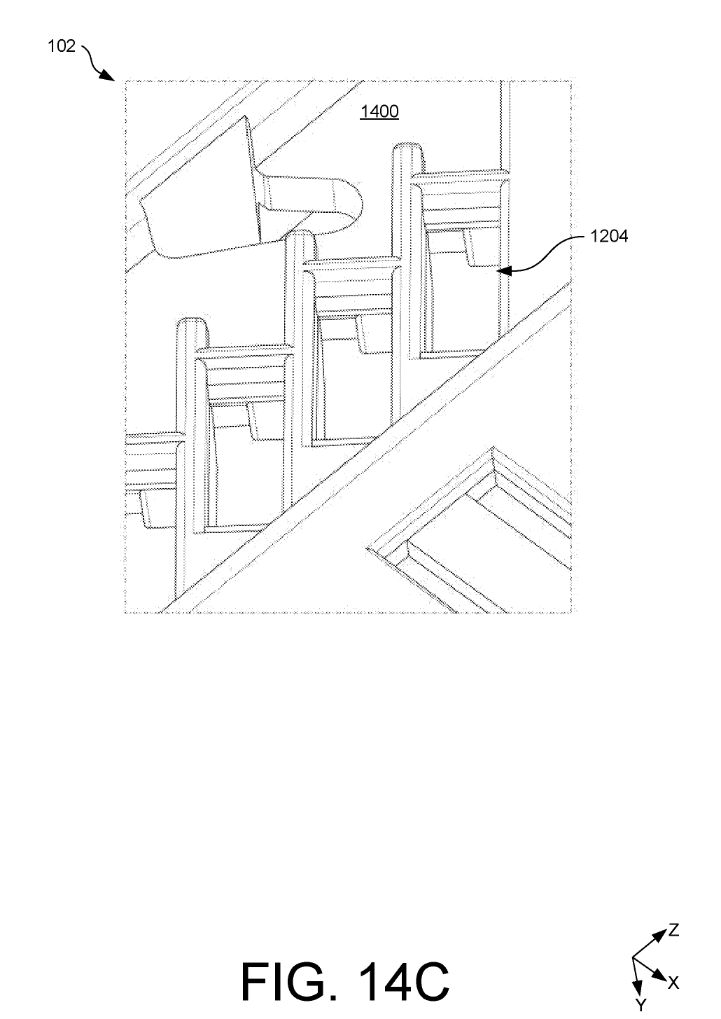

FIGS. 14A-14C illustrate views of the shelf 102 showing the arrangement of multiple receptacles 1204. The receptacles 1204 are arranged in a row along the shelf 102. Each receptacle 1204 includes the inlet 1300 through which cables enter and the outlet 1302 through which cables exit after being secured. The receptacles 1204 are defined by the first sidewall 1304 and the second sidewall 1306 that are spaced apart from one another. The top surface 1308 is disposed on the first sidewall 1304 and the second sidewall 1306, forming an upper boundary of each receptacle 1204. The shelf 102 includes a bottom surface 1400 that forms the underside of the shelf 102. The clamps may be advanced into the receptacles 1204 from the bottom surface 1400.

In an embodiment, the receptacles 1204 may be numbered or otherwise marked to indicate positions for organizing multiple cables along the shelf 102. The arrangement of the receptacles 1204 in a row facilitates sequential cable routing and provides defined locations for securing cables as the cables enter the shelf 102. The inlets 1300 and outlets 1302 of the receptacles 1204 may be positioned to facilitate cable routing through the shelf 102, with each receptacle 1204 providing a pathway that directs cables toward the trays 1100 or other internal components. The receptacles 1204 are arranged in a linear configuration along the shelf 102, with each receptacle 1204 providing an inlet and outlet for routing cables through the shelf 102.

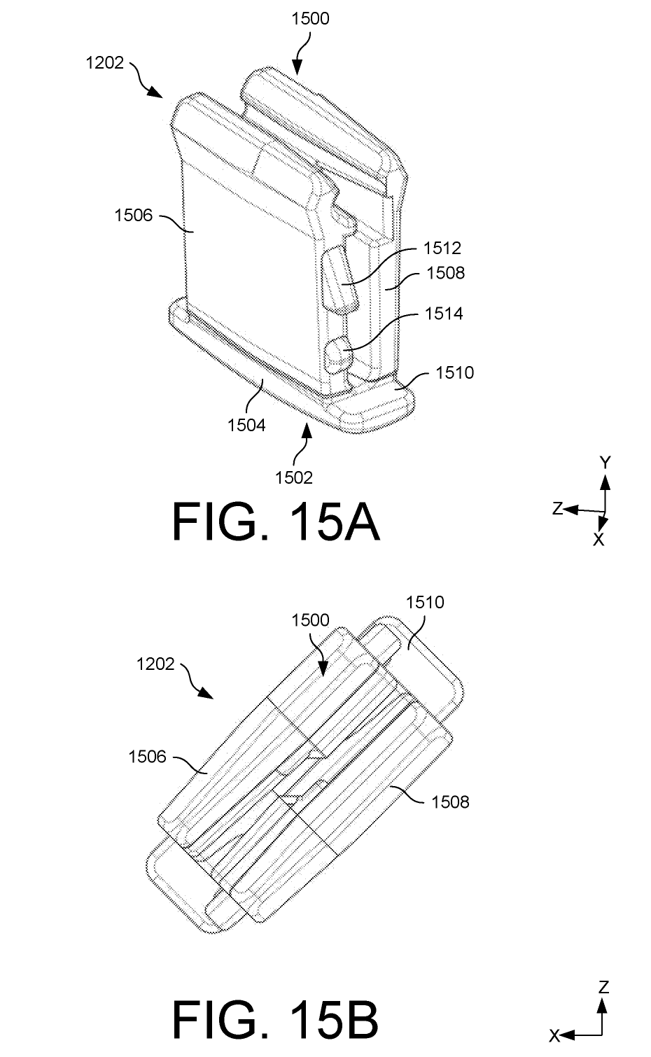

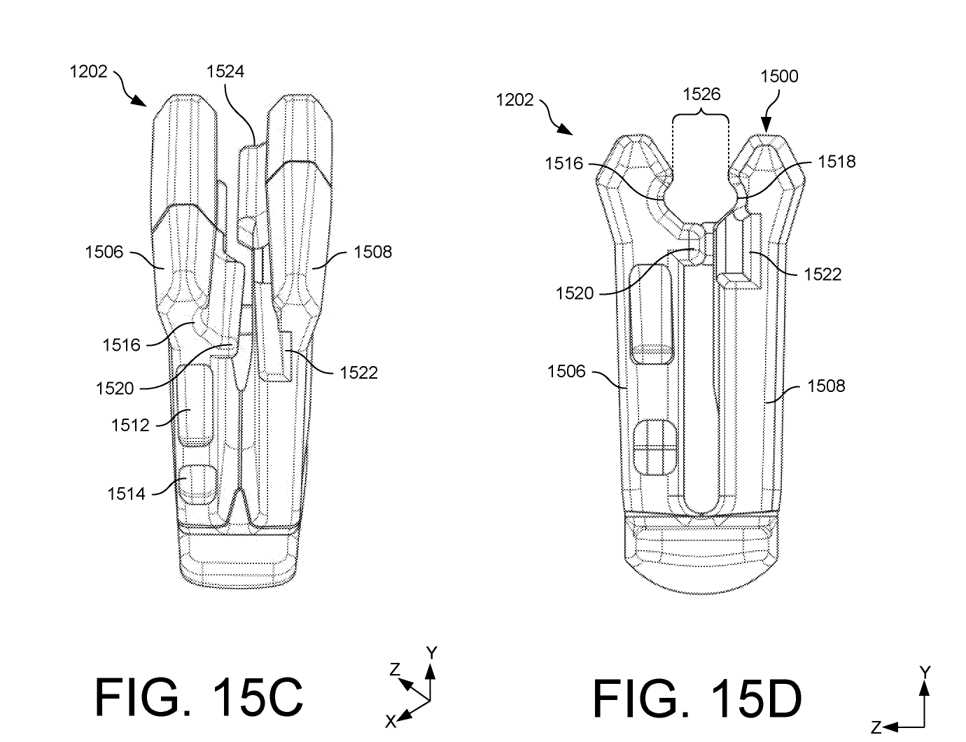

FIGS. 15A-15D illustrate views of the clamp 1202, showing perspective views and structural details of the clamp 1202. The clamp 1202 includes a top 1500, a bottom 1502, and a base 1504. The top 1500 is disposed above the top surface 1308 when the clamp 1202 is in an undepressed state, and may be aligned with the top surface 1308 when the clamp 1202 is in a depressed state. The bottom 1502 is disposed below the bottom surface 1400

A first arm 1506 and a second arm 1508 extend from the base 1504. The first arm 1506 and the second arm 1508 are spaced apart from one another and extend upwardly from the base 1504, forming a V-shaped configuration that defines an opening therebetween for receiving the cable 900. The V-shaped configuration of the first arm 1506 and the second arm 1508 permits a cable to be positioned between the first arm 1506 and the second arm 1508 prior to depressing the clamp 1202 into the receptacle 1204.

A flange 1510 extends from each side of the base 1504 and may engage with features of the receptacle 1204 to secure the clamp 1202 in position. For example, the flanges 1510 may engage with the bottom surface 1400 to prevent the clamp 1202 from being fully pushed through the receptacle 1204. The flanges 1510 may assist in anchoring the clamp 1202 within the receptacle 1204 and may prevent inadvertent displacement of the clamp 1202 during operation.

A projection 1512 extends from the first arm 1506 and engages with the deck 1310 to prevent the clamp 1202 from being pushed completely through the shelf 102 or out the bottom surface 1400. The projection 1512 may function as a catch, barb, lip, or tooth that provides additional engagement or retention capability. A nub 1514 is disposed on the second arm 1508 and may engage with the sidewalls of the receptacle 1204 to hold the clamp 1202 in position within the receptacle 1204. The nub 1514 may be characterized as a bulge or protrusion that assists in securing the clamp 1202 within the receptacle 1204 and retaining a cable between the first arm 1506 and the second arm 1508.

The first arm 1506 includes a groove 1516 configured to receive the cable 900, and the second arm 1508 includes a groove 1518 configured to receive the cable 900 (i.e., an opposing side of the cable 900). The groove 1516 and the groove 1518 may be positioned to align with one another when the first arm 1506 and the second arm 1508 are brought together, forming a channel that at least partially surrounds and secures a cable disposed therebetween.

The first arm 1506 includes a rib 1520 that extends along a surface of the first arm 1506. The second arm 1508 includes a channel 1522 configured to receive the rib 1520 when the first arm 1506 and the second arm 1508 are brought together. The engagement between the rib 1520 and the channel 1522 may facilitate alignment of the first arm 1506 and the second arm 1508 during clamping operations. A rib 1524 extends from an upper portion of the first arm 1506 and may provide additional structural support or alignment functionality. In an embodiment, the clamp 1202 may include other features, projections, ribs, flanges, tabs, detents, barbs, or other structural elements configured to enhance cable retention, facilitate alignment between the first arm 1506 and the second arm 1508, or provide engagement with the receptacle 1204.

A distance 1526 is defined between the first arm 1506 and the second arm 1508 when the clamp 1202 is in an unclamped state. The distance 1526 represents the spacing between the first arm 1506 and the second arm 1508 prior to engagement with the cable and insertion into the receptacle 1204. When the clamp 1202 is depressed into the receptacle 1204, the first sidewall 1304 and the second sidewall 1306 of the receptacle 1204 act on the first arm 1506 and the second arm 1508, respectively, urging the first arm 1506 and the second arm 1508 toward one another and reducing the distance 1526. The reduction in the distance 1526 causes the first arm 1506 and the second arm 1508 to pinch and secure the cable 900 disposed between the groove 1516 and the groove 1518.

The clamp 1202 may be formed from a pliable, deformable, or resilient material that permits the first arm 1506 and the second arm 1508 to flex toward one another when acted upon by the sidewalls of the receptacle 1204. In an embodiment, the clamp 1202 may be formed from a polymer, thermoplastic, elastomer, or other flexible material that provides sufficient rigidity to retain the cable 900 while permitting elastic deformation during insertion and clamping operations. The material of the clamp 1202 may be selected to provide a balance between flexibility and retention force, enabling the arms to deflect inwardly when depressed into the receptacle 1204 and to maintain clamping pressure on the cable 900 once secured. In an embodiment, the clamp 1202 may be formed from materials such as nylon, polypropylene, polyethylene, acetal, or other engineering plastics that exhibit suitable flexibility, durability, and resistance to fatigue under repeated clamping cycles. The clamp 1202 may also be formed from over-molded or multi-material constructions in which a rigid base portion is combined with a more compliant gripping portion to optimize both structural integrity and cable retention characteristics.

In an embodiment, the clamp 1202 may be configured to receive more than one cable 900. In such instances, the clamp 1202 may include more than two grooves formed in the first arm 1506 and the second arm 1508, with each pair of opposing grooves configured to receive and secure a respective cable. Alternatively, more than one cable may be secured within the groove 1516 and the groove 1518, with multiple cables being retained together between the first arm 1506 and the second arm 1508 when the clamp 1202 is depressed into the receptacle 1204.

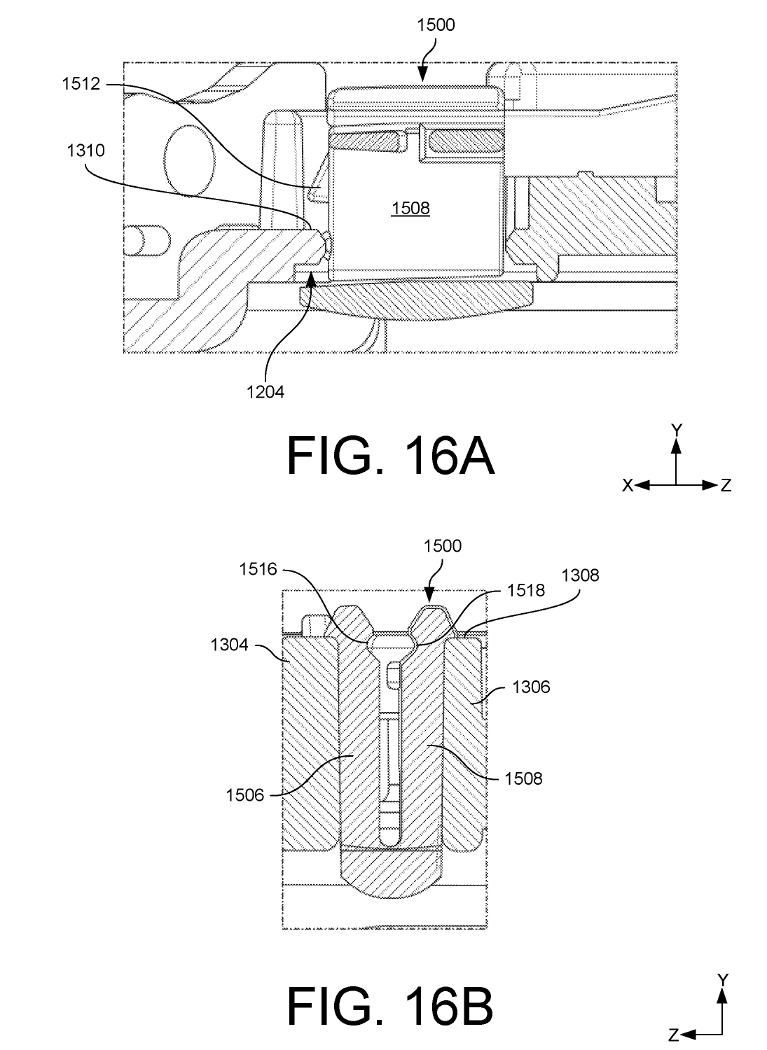

FIGS. 16A and 16B illustrate cross-sectional views of the clamp 1202 disposed within the receptacle 1204 of the shelf 102. FIG. 16A is a cross-sectional view taken along line A—A of FIG. 13B, and FIG. 16B is a cross-sectional view taken along line B—B of FIG. 13B. The cross-sectional views show the relationship between the clamp 1202 and the receptacle 1204 in an assembled configuration. In FIGS. 16A and 16B, the clamp 1202 is shown disposed within the receptacle 1204, the clamp 1202 is shown in an undepressed state, and the cable is shown absent.

The receptacle 1204 is defined by the first sidewall 1304 and the second sidewall 1306, which extend upward from the deck 1310. The top surface 1308 is disposed at an upper portion of the first sidewall 1304 and the second sidewall 1306. The clamp 1202 is positioned within the receptacle 1204, with the first arm 1506 and the second arm 1508 extending from the base of the clamp 1202. The projection 1512 extends from the clamp 1202 and engages with features of the receptacle 1204.

The cross-sectional views show the top 1500 of the clamp 1202 and the arrangement of the first arm 1506 and the second arm 1508 within the receptacle 1204. The groove 1516 is formed in the first arm 1506 and the groove 1518 is formed in the second arm 1508, with each groove configured to receive the same cable, or a portion of the cable. The first sidewall 1304 and the second sidewall 1306 are spaced apart to define the receptacle 1204, and the top surface 1308 is positioned at an upper extent of the first sidewall 1304 and the second sidewall 1306.

The cross-sectional views demonstrate how the clamp 1202 is received within the receptacle 1204 and how the first arm 1506 and the second arm 1508 are configured to secure cables within the groove 1516 and the groove 1518. When the clamp 1202 is depressed into the receptacle 1204, the first sidewall 1304 acts on the first arm 1506 and the second sidewall 1306 acts on the second arm 1508, urging the first arm 1506 and the second arm 1508 toward one another. The inward movement of the first arm 1506 and the second arm 1508 causes the groove 1516 and the groove 1518 to converge, thereby capturing and securing the cable 900 disposed between the first arm 1506 and the second arm 1508.

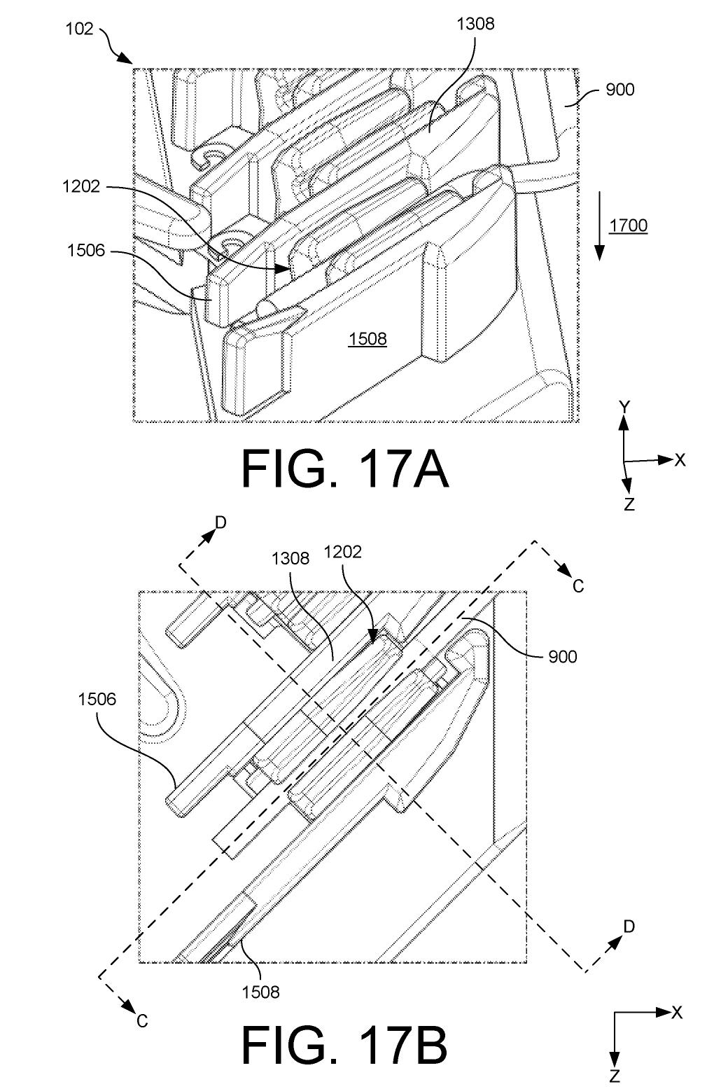

FIGS. 17A and 17B illustrate views of the shelf 102 showing the clamp 1202 in a depressed state with the cable 900 secured therein. The shelf 102 includes multiple clamps 1202 positioned within receptacles defined by sidewalls having the top surface 1308. Each clamp 1202 includes the first arm 1506 and the second arm 1508 that extend from the base 1504. The cables 900 are routed through the clamps 1202, with the first arm 1506 and the second arm 1508 positioned on opposite sides of each cable 900.

The clamp 1202 is pushed in the direction 1700 to move from the unclamped state to the clamped state. As the clamp 1202 is pressed in the direction 1700, the first arm 1506 and the second arm 1508 engage with the sidewalls of the receptacle 1204, causing the first arm 1506 and the second arm 1508 to converge and secure the cable 900 therebetween.

The top surface 1308 of the sidewalls is visible, and the first arm 1506 and the second arm 1508 of the clamp 1202 are shown in positions relative to the cable 900. As the clamp 1202 is pressed in the direction 1700, the first sidewall 1304 and the second sidewall 1306 of the receptacle 1204 act on the first arm 1506 and the second arm 1508, respectively, causing the first arm 1506 and the second arm 1508 to compress together and secure the cable 900 between the first arm 1506 and the second arm 1508. The cables 900 extend through the clamps 1202 and continue along routing paths within the shelf 102.

In an embodiment, the clamp 1202 may be pressed in the direction 1700 by applying manual force to the top 1500 of the clamp 1202. As the clamp 1202 advances in the direction 1700, the tapered configuration of the first sidewall 1304 and the second sidewall 1306 progressively urges the first arm 1506 and the second arm 1508 toward one another. The groove 1516 of the first arm 1506 and the groove 1518 of the second arm 1508 converge around the cable 900, capturing and retaining the cable 900 within the clamp 1202. The projection 1512 and the nub 1514 may engage with features of the receptacle 1204 to retain the clamp 1202 in the depressed position, maintaining clamping pressure on the cable 900.

In an embodiment, the clamp 1202 may be released from the depressed position by applying an upward force opposite to the direction 1700. The upward force may disengage the projection 1512 and the nub 1514 from the receptacle 1204, permitting the clamp 1202 to be withdrawn from the receptacle 1204. As the clamp 1202 is withdrawn, the first arm 1506 and the second arm 1508 may return toward the unclamped configuration, releasing the cable 900 from the groove 1516 and the groove 1518.

Although the cable 900 is shown terminating at the outlet 1302 in the figures, the cable 900 may continue beyond the clamp 1202 and route to other portions of the shelf 102 after being secured within the clamp 1202. For example, the cable 900 may extend from the outlet 1302 toward the trays 1100 for splicing operations, toward the spine 3900 for distribution to other trays, or toward other routing features within the shelf 102. The clamp 1202 serves to hold the cable 900 in a fixed position at the point of entry into the shelf 102, providing strain relief and preventing movement of the cable 900 at the secured location. The clamping action resists tugging, pulling, or displacement of the cable 900 during maintenance operations, installation of additional cables, splicing activities, or other handling that may occur within the shelf 102. By securing the cable 900 at the receptacle 1204, the clamp 1202 isolates the secured portion of the cable 900 from forces applied to other portions of the cable 900, thereby protecting the fiber optic connections within the trays 1100 from strain or damage that could result from cable movement.

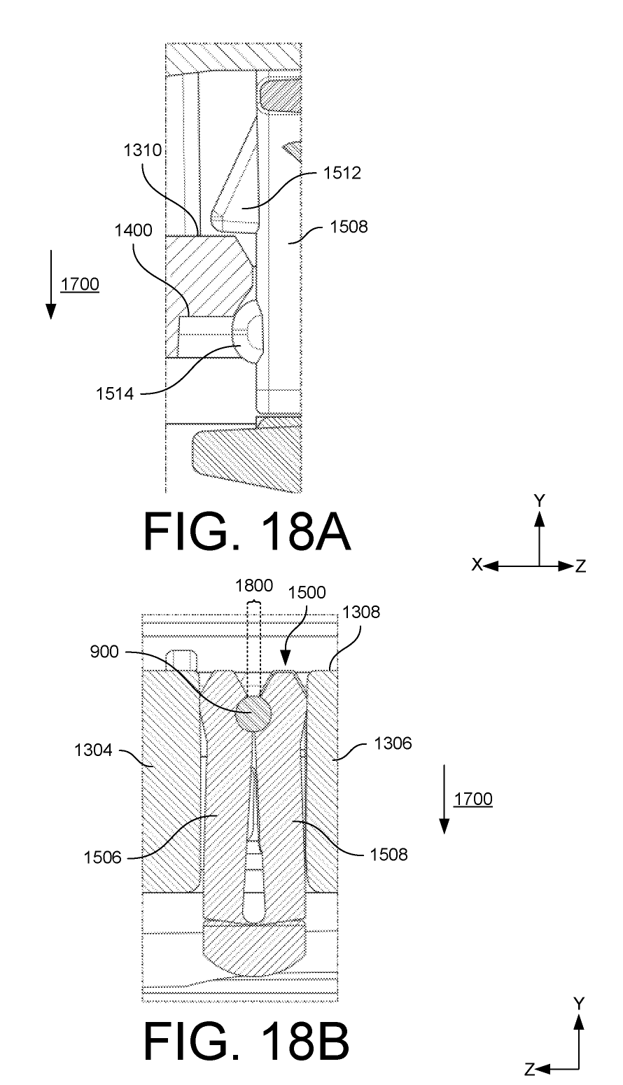

FIGS. 18A and 18B illustrate sectional views of the clamp 1202 engaging with the receptacle 1204 to secure the cable 900 on the shelf 102. FIG. 18A is a cross-sectional view taken along line C—C of FIGS. 17B, and FIG. 18B, is a cross-sectional view taken along line D—D of FIG. 17B. In FIGS. 18A and 18B, the clamp 1202 is shown in the depressed state. In FIG. 18A, the top 1500 of the clamp 1202 is positioned proximate to, flush with, or aligned with the top surface 1308, such that the distance between the top 1500 and the top surface 1308 is less than in the unclamped state. In the depressed state, the first arm 1506 and the second arm 1508 are urged toward one another, with the cable 900 secured therebetween.

The projection 1512 and the nub 1514 are visible on the clamp 1202. The direction 1700 indicates the downward movement path for engaging the clamp 1202 into the receptacle 1204. The clamp 1202 is shown in the depressed position where the cable 900 is secured between the first arm 1506 and the second arm 1508. The first sidewall 1304 and the second sidewall 1306 define the receptacle 1204, with the deck 1310 forming the base surface. The projection 1512 may engage with the deck 1310 to prevent further advancement of the clamp 1202 in the direction 1700. The nub 1514 may engage with the sidewalls of the receptacle 1204 and/or the bottom surface 1400 to hold the clamp 1202 in place within the receptacle 1204. A distance 1800 represents the spacing between the first arm 1506 and the second arm 1508 in the clamped state, which is reduced compared to the distance 1526 in the unclamped state. As the clamp 1202 is pressed in the direction 1700, the tapered sidewalls of the receptacle 1204 urge the first arm 1506 and the second arm 1508 toward one another, thereby capturing and securing the cable 900.

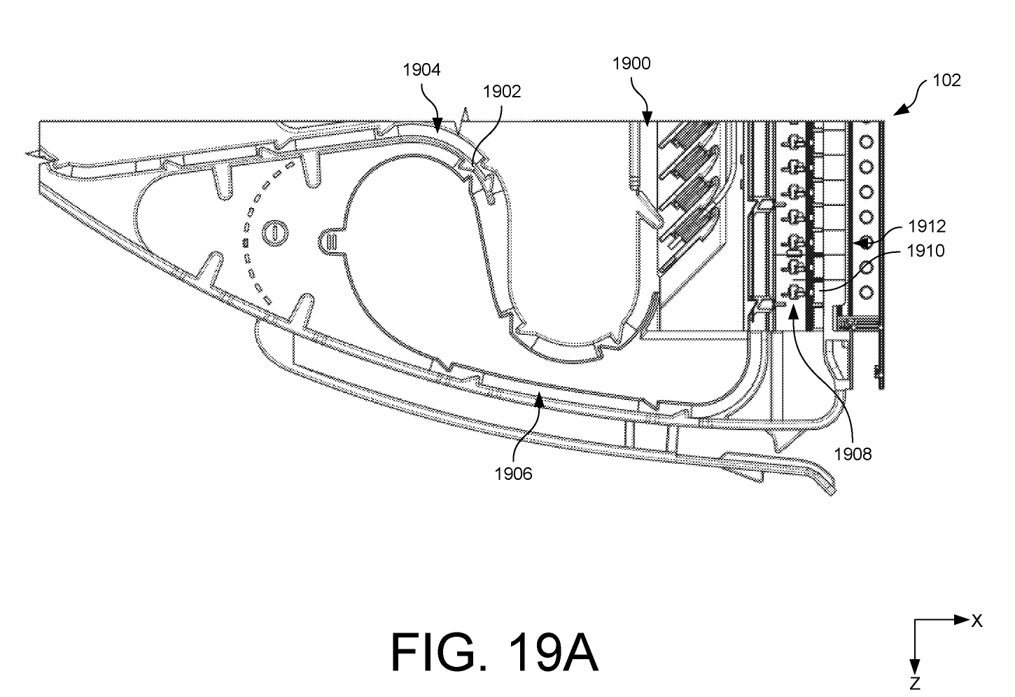

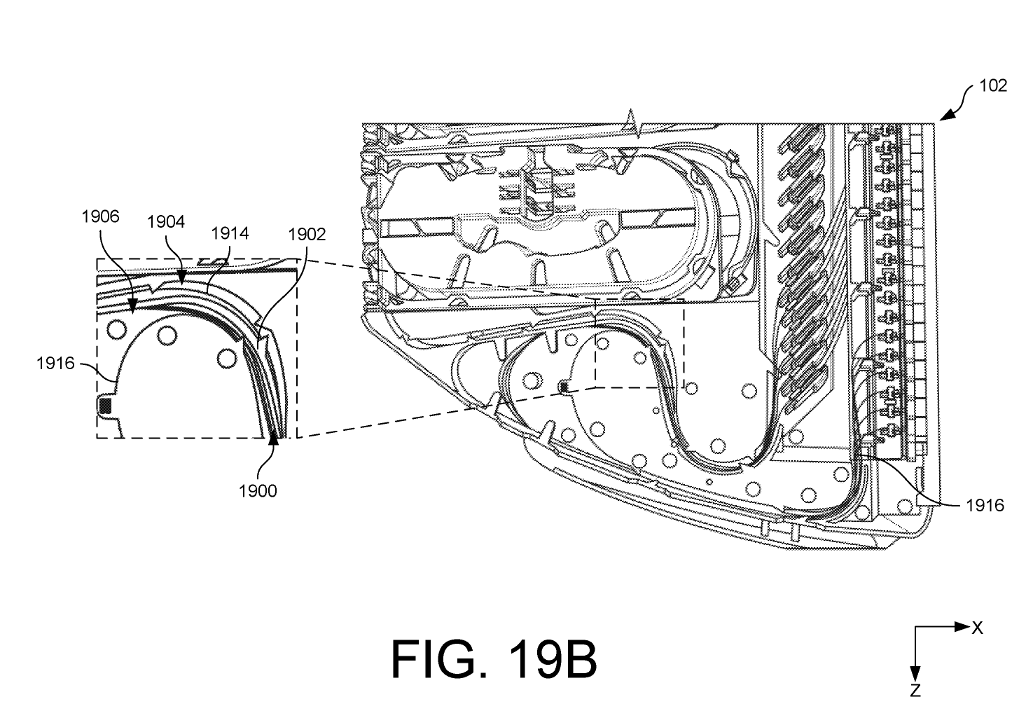

FIGS. 19A and 19B illustrate views of the shelf 102 showing a routing configuration for fiber optic cables within the shelf 102. The shelf 102 includes a channel 1900 that serves as a pathway for cables entering the shelf 102. A divider 1902 separates the channel 1900 into distinct routing paths, creating a first channel 1904 and a second channel 1906. The divider 1902 may be formed as a wall, rib, partition, or other structural element that extends along a portion of the channel 1900 to maintain separation between the first channel 1904 and the second channel 1906. The first channel 1904 extends toward an interior of the shelf 102 and is configured to route fiber optic cables toward the trays 1100 for splicing operations. The second channel 1906 provides an alternative routing path that directs tracer cables toward guides 1908 and compliant retainers 1910 for circuit identification purposes.

The guide 1908 is positioned along the routing path to direct and manage the tracer cables as they traverse the shelf 102. The guide 1908 is disposed on the shelf 102 and is configured to receive and direct tracer cables through the compliant retainers 1910, making the tracer cables visible at the ends 1912. In an embodiment, the shelf 102 may include multiple guides 1908 arranged in a row, each guide 1908 configured to receive and align a respective tracer cable.

The shelf 102 further includes a compliant retainer 1910 arranged along one side of the shelf 102. The compliant retainer 1910 is configured to hold tracer cables in place as the tracer cables pass through the compliant retainer 1910. In an embodiment, the shelf 102 may include multiple compliant retainers 1910 arranged in a vertical array. The compliant retainers 1910 may be numbered or otherwise marked to facilitate identification and organization of individual fiber connections within the shelf 102.

An end 1912 represents an end of a passage through which the end of a tracer cable is visible when the tracer cable is installed within the compliant retainer 1910, enabling a technician to visually identify specific circuits. Each compliant retainer 1910 has a corresponding end 1912 through which the tracer cable can be observed.

Fiber optic cables 1914 are routed through the first channel 1904. The fiber optic cables 1914 may represent active fibers, payload fibers, or other fiber optic cables that are directed toward the trays 1100 for splicing operations. In an embodiment, the fiber optic cables 1914 may include trunk fibers, ribbon fibers, or other fiber optic cables that carry data signals and are routed to the trays 1100 for connection with patch cables.

Each individual tracer cable 1916 is routed through a guide 1908 and a compliant retainer 1910, where each tracer cable 1916 is visible at an end 1912 of the passage for circuit identification purposes. The divider 1902 maintains separation between the fiber optic cables 1914 and the tracer cables 1916 as the cables pass through the channel 1900. The separation provided by the divider 1902 prevents the fiber optic cables 1914 and the tracer cables 1916 from becoming tangled or intermingled during installation and operation. The routing configuration of the first channel 1904 and the second channel 1906 facilitates organized management of different cable types within the shelf 102.

In an embodiment, the channel 1900, the first channel 1904, and/or the second channel 1906 may include retention features configured to maintain the fiber optic cables 1914 and/or the tracer cables 1916 in position within their respective channels. The retention features may include barbs, prongs, tabs, fingers, ribs, hooks, or other projections that extend into the channel to engage with the cables and prevent the cables from backing out or shifting during installation and operation. The retention features may be integrally formed with the channel walls or may be separate components secured to the channel structure. The first channel 1904 may include retention features that engage with the fiber optic cables 1914 to maintain the fiber optic cables 1914 in position as the fiber optic cables 1914 are routed toward the trays 1100. The second channel 1906 may include retention features that engage with the tracer cables 1916 to maintain the tracer cables 1916 in position as the tracer cables 1916 are routed toward the guides 1908 and compliant retainers 1910. The retention features may be configured to permit insertion of the cables in one direction while resisting removal or displacement of the cables in the opposite direction.

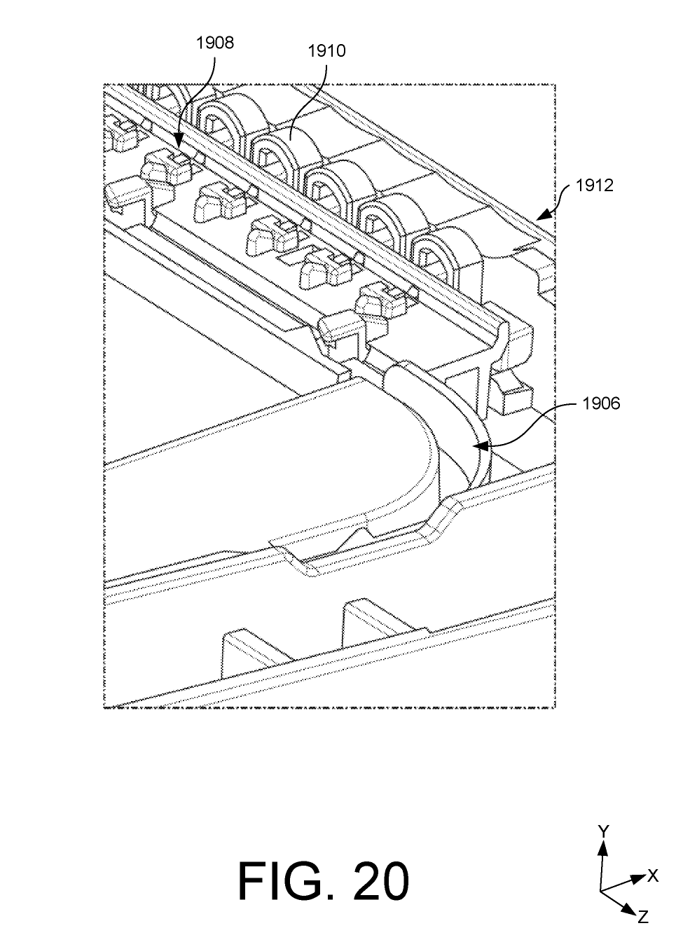

FIG. 20 illustrates a perspective view of a portion of the shelf 102, showing the second channel 1906, the guide 1908, the compliant retainer 1910, and the end 1912. The second channel 1906 is positioned along the shelf 102 and provides a pathway for routing tracer cables 1916. The second channel 1906 curves around a corner portion of the shelf 102, facilitating the routing of the tracer cables 1916 from one area of the shelf 102 toward the guide 1908 and the compliant retainer 1910. The guide 1908 is disposed on the shelf 102 and includes multiple guide structures arranged in a row, each guide structure configured to receive and direct a tracer cable 1916. The compliant retainer 1910 is positioned adjacent to the guide 1908 and includes a series of elastomeric elements that are configured to secure the tracer cables 1916 passing through them. The end 1912 is visible at the compliant retainer 1910, representing the location where the tracer cables 1916 emerge after passing through the compliant retainer 1910. The tracer cables 1916 may be routed through the second channel 1906, through the guide 1908, through the compliant retainer 1910, and out the end 1912 for circuit identification purposes. The arrangement of the guide 1908 and the compliant retainer 1910 enables the tracer cables 1916 to be aligned and secured in preparation for connection or viewing through the tracer functionality of the shelf 102.

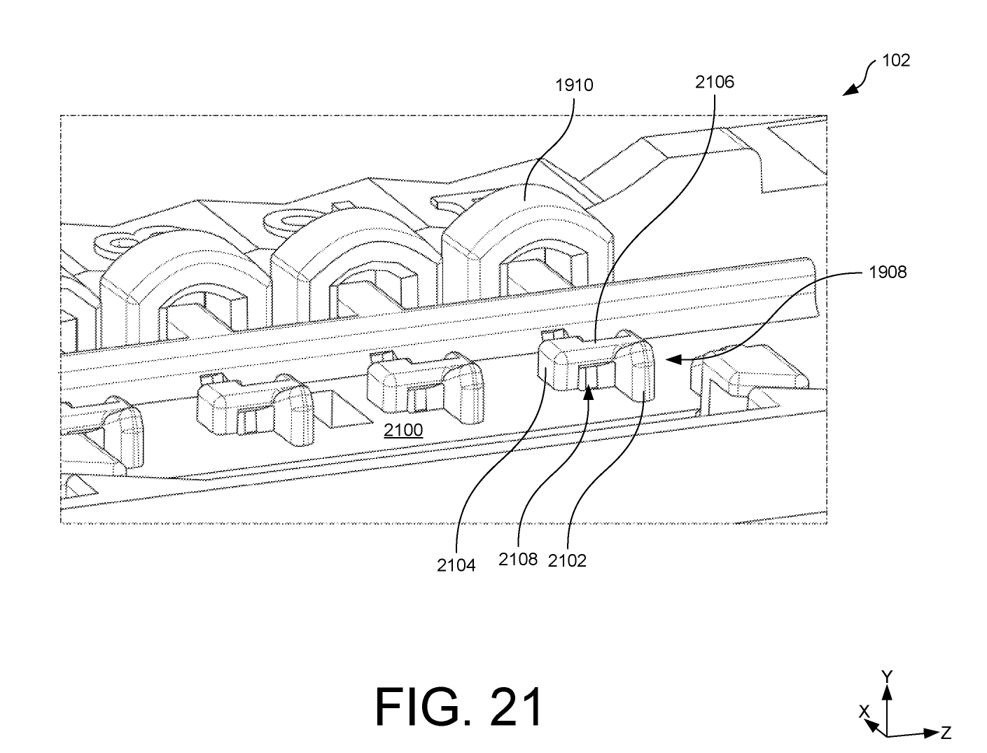

FIG. 21 illustrates a detailed view of a portion of the shelf 102, showing details of the guide 1908. A top surface 2100 of a body defines and includes the guide 1908. In an embodiment, the shelf 102 may form the guide 1908 as an integral feature of the shelf 102. In other embodiments, an insert, body, frame, bracket, or other component may form the guide 1908 and couple to the shelf 102. Although referred to herein as a guide 1908, other routing mechanisms may be implemented, including ducts, channels, conduits, tubes, sleeves, troughs, or other structures configured to direct and manage the tracer cables 1916 along a defined path.

The guide 1908 is formed by a first wall 2102 and a second wall 2104, which are spaced apart from one another. A top wall 2106 spans between the first wall 2102 and the second wall 2104, creating an enclosed structure. A passage 2108 of the guide 1908 is defined by the space between the first wall 2102, the second wall 2104, and the top wall 2106, providing a channel through which tracer cables 1916 may be routed. The tracer cables 1916 may be routed into the guides 1908 from the second channel 1906, with each tracer cable 1916 being directed from the second channel 1906 into a respective guide 1908. For example, an end of the tracer cable 1916 may be pushed into the passage 2108. In an embodiment, multiple guides 1908 may be arranged in a row along the shelf 102, each guide 1908 having the same structural configuration with the first wall 2102, the second wall 2104, the top wall 2106, and the passage 2108. Each guide 1908 may receive a respective tracer cable 1916.

The compliant retainers 1910 are positioned adjacent to the guides 1908 and are depressible elastomeric elements through which tracer cables 1916 may be routed. The compliant retainers 1910 may be depressed from their resting position to permit the tracer cables 1916 to be pushed through and out the end 1912. The arrangement of the guides 1908 and the compliant retainers 1910 on the top surface 2100 of the shelf 102 facilitates organized routing and retention of tracer cables 1916 within the shelf 102.

The enclosed structure formed by the first wall 2102, the second wall 2104, and the top wall 2106 may protect the tracer cables 1916 as the tracer cables 1916 pass through the passage 2108. The passage 2108 may be sized to receive one or more tracer cables 1916 while maintaining the tracer cables 1916 in a defined position within the guide 1908. In an embodiment, the first wall 2102 and the second wall 2104 may extend from the top surface 2100 of the shelf 102, with the top wall 2106 connecting the first wall 2102 and the second wall 2104 at an upper extent of the walls. The passage 2108 extends through the guide 1908 to direct tracer cables 1916 toward the compliant retainers 1910.

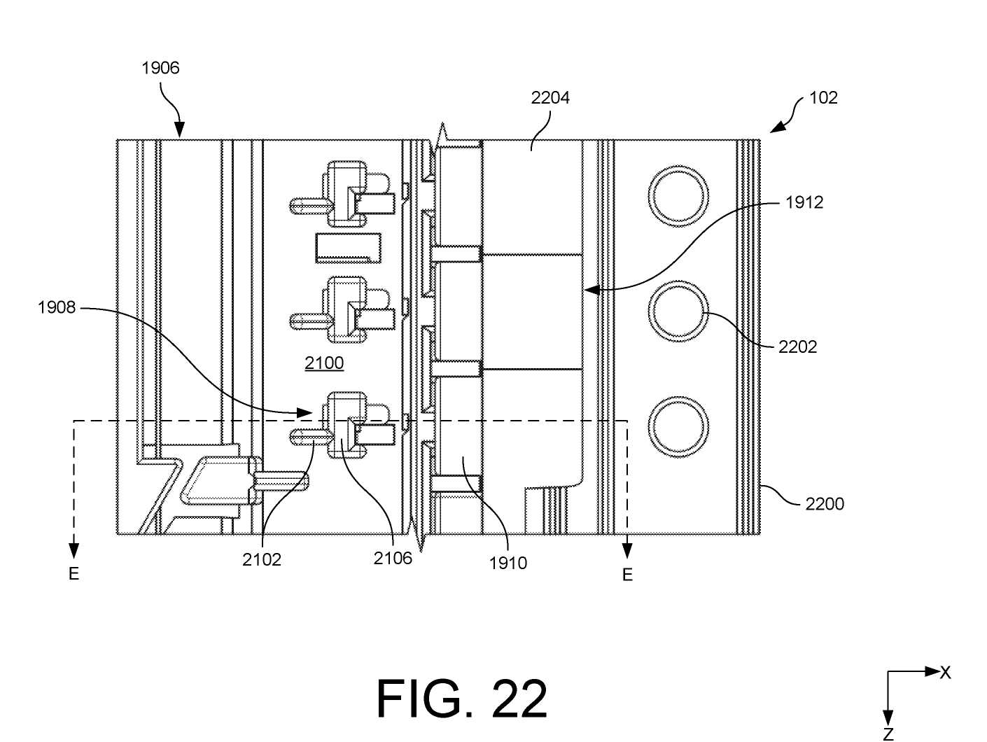

FIG. 22 illustrates components of the shelf 102 associated with the tracer fiber routing and retention system. The shelf 102 includes the second channel 1906 positioned along one side of the view, which provides a pathway for routing the tracer cables 1916. Adjacent to the second channel 1906 are the guides 1908. The guides 1908 are configured to receive and align the tracer cables 1916 as the tracer cables 1916 are routed toward the compliant retainers 1910 and out the end 1912.

A door 2200, such as a panel, cover, flap, or other closure element, is hingedly coupled to the shelf 102 and is movable between an open position and a closed position. In FIG. 22, the door 2200 is in the open position. The door 2200 includes apertures 2202. Each aperture 2202 provides an opening through which an end of a respective tracer cable 1916 is visible for tracer identification purposes. A rail 2204 extends along the shelf 102 adjacent to the door 2200. The rail 2204 includes passages formed therein that are configured to receive and guide the tracer cables 1916 toward the apertures 2202 in the door 2200. Each of the apertures 2202 aligns with a corresponding passage in the rail 2204 and end 1912 to permit the tracer cables 1916 to be visible when the door 2200 is in the closed position. When a visual fault locator or other light source transmits visible light through a tracer cable 1916, the light travels through the guide 1908, through the compliant retainer 1910, through the passage in the rail 2204, and emerges at the end 1912. The aperture 2202 aligned with the end 1912 permits the light to be visible through the door 2200, enabling a technician to identify the circuit being traced.

In an embodiment, the apertures 2202 may be formed as openings, windows, holes, slots, or other passages through the door 2200. The apertures 2202 may be sized and positioned to correspond with the passages in the rail 2204 and the ends 1912 of the compliant retainers 1910, providing a direct line of sight from the exterior of the door 2200 to the ends 1912 where the tracer cables 1916 terminate.

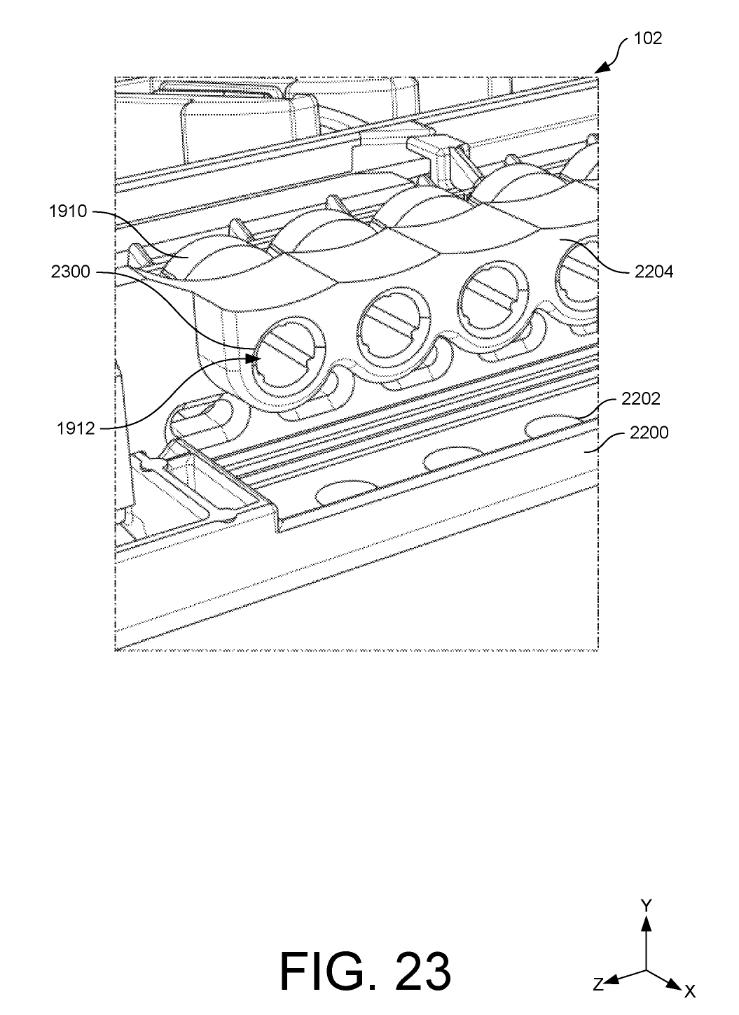

FIG. 23 illustrates an isometric view of a portion of the shelf 102, showing the door 2200, the rail 2204, and passages 2300. The rail 2204 extends along the shelf 102 adjacent to the door 2200 and includes a plurality of passages 2300 formed therein. The passages 2300 are configured to receive and guide tracer cables 1916 toward the apertures 2202 in the door 2200. Each passage 2300 includes an end 1912 through which the tracer cables 1916 are visible.

The passages 2300 are arranged in a linear configuration along the rail 2204, with each passage 2300 corresponding to an aperture 2202 in the door 2200. The ends 1912 of the passages 2300 are aligned with the apertures 2202, permitting the tracer cables 1916 routed through the passages 2300 to be visible through the door 2200 when the door 2200 is in the closed position. In an embodiment, the passages 2300 may be formed as circular openings, bores, channels, or other through-features in the rail 2204 that receive the ends of the tracer cables 1916.

The compliant retainer 1910 is positioned along the shelf 102 in proximity to the rail 2204. The compliant retainer 1910 are configured to capture and hold the tracer cables 1916 in position as the tracer cables 1916 are routed toward the passages 2300. The tracer cables 1916 may pass through the compliant retainer 1910 before entering the passages 2300 in the rail 2204.

The arrangement of the compliant retainer 1910, the rail 2204 with the passages 2300, and the door 2200 with the apertures 2202 provides a pathway for routing tracer cables 1916 from the interior of the shelf 102 to a visible location at the front of the shelf 102. When a visual fault locator or other light source transmits visible light through a tracer cable 1916, the light travels through the compliant retainer 1910, through a respective passage 2300 in the rail 2204, and emerges at the corresponding end 1912 of the passage 2300. The tracer cables 1916 are visible out the ends 1912, and the aperture 2202 aligned with the end 1912 permits the light to be observed through the door 2200. The linear arrangement of the passages 2300 facilitates organized presentation of multiple tracer cables 1916, enabling a technician to identify individual circuits by observing which aperture 2202 emits light during tracing operations.

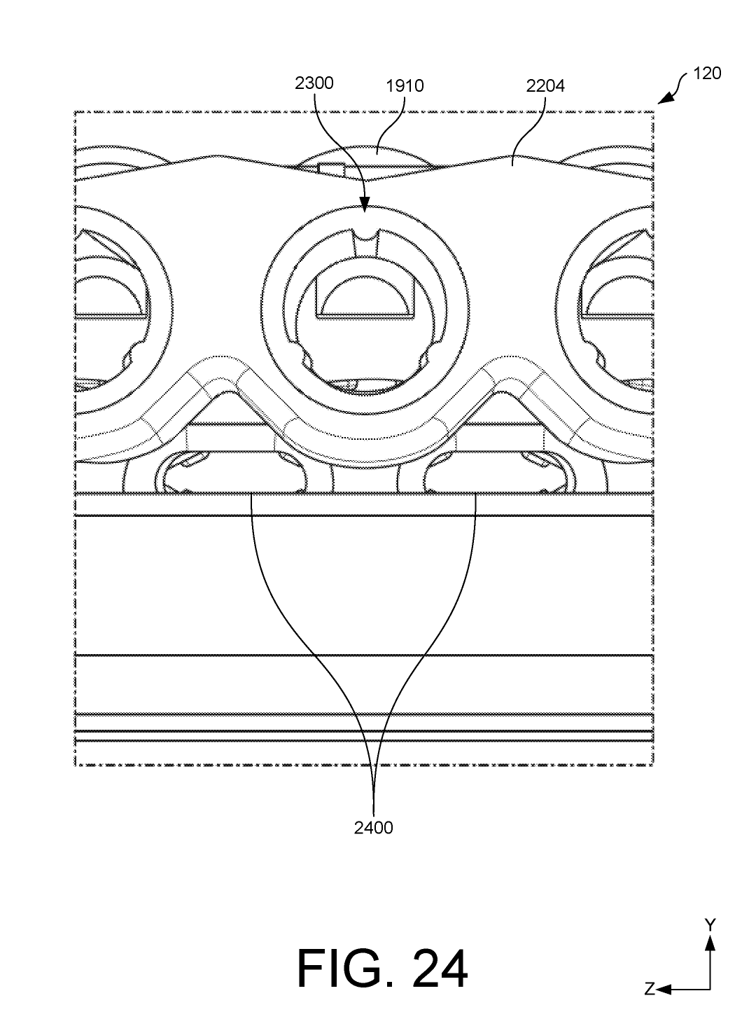

FIG. 24 illustrates a front view of a portion of a shelf 120, showing the compliant retainers 1910, the passages 2300, and receptacles 2400. The shelf 120 includes the compliant retainers 1910 positioned along an upper portion of the view. Each compliant retainer 1910 is configured to receive and secure tracer cables. The passages 2300 are formed in the rail 2204 and are positioned to guide tracer cables through the shelf 120. The passages 2300 appear as circular openings arranged in a linear pattern.

The receptacles 2400 are positioned below the compliant retainers 1910 and the passages 2300. The receptacles 2400 are configured to receive prongs of a connector, providing alignment and coupling functionality for the connector when the connector is engaged with the shelf 120. In an embodiment, the receptacles 2400 may be formed as channels, grooves, bores, slots, or recesses that extend along a portion of the shelf 120. The receptacles 2400 may be sized and shaped to correspond with the prongs of the connector, enabling the prongs to be inserted into the receptacles 2400 to establish a secure and aligned connection between the connector and the shelf 120.

In an embodiment, the receptacles 2400 may include features that engage with the prongs of the connector to retain the connector in position relative to the shelf 120. The receptacles 2400 may include tapered surfaces, detents, friction-fit regions, or other engagement features that resist inadvertent disengagement of the connector from the shelf 120. The arrangement of the compliant retainers 1910, the passages 2300, and the receptacles 2400 facilitates the routing, securing, and connection of tracer cables within the shelf 120.

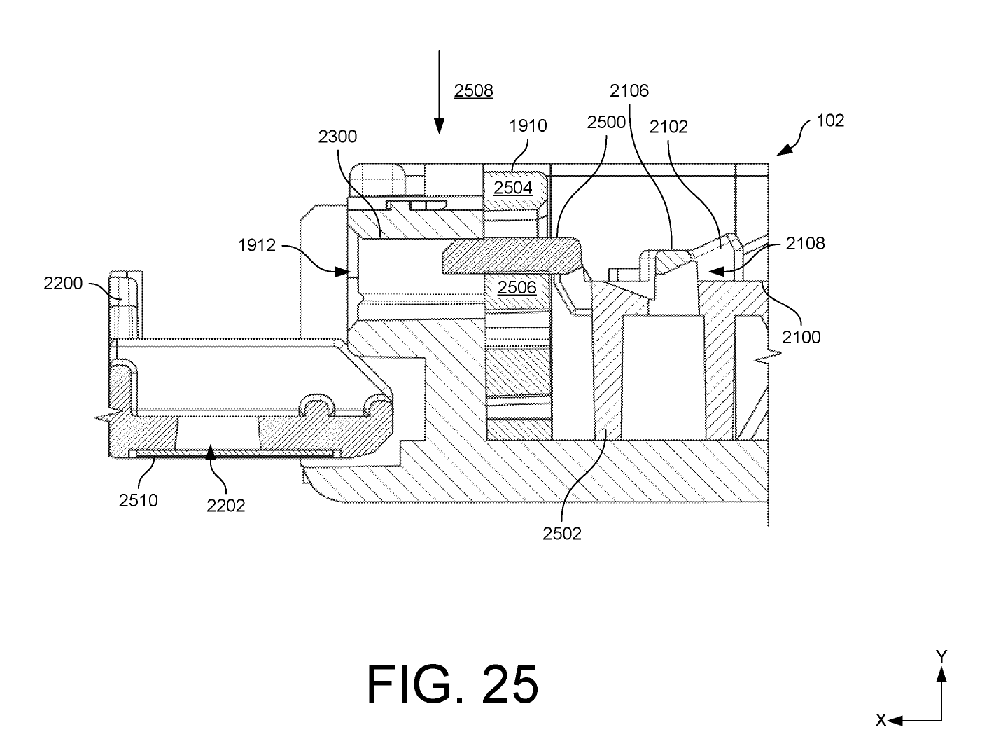

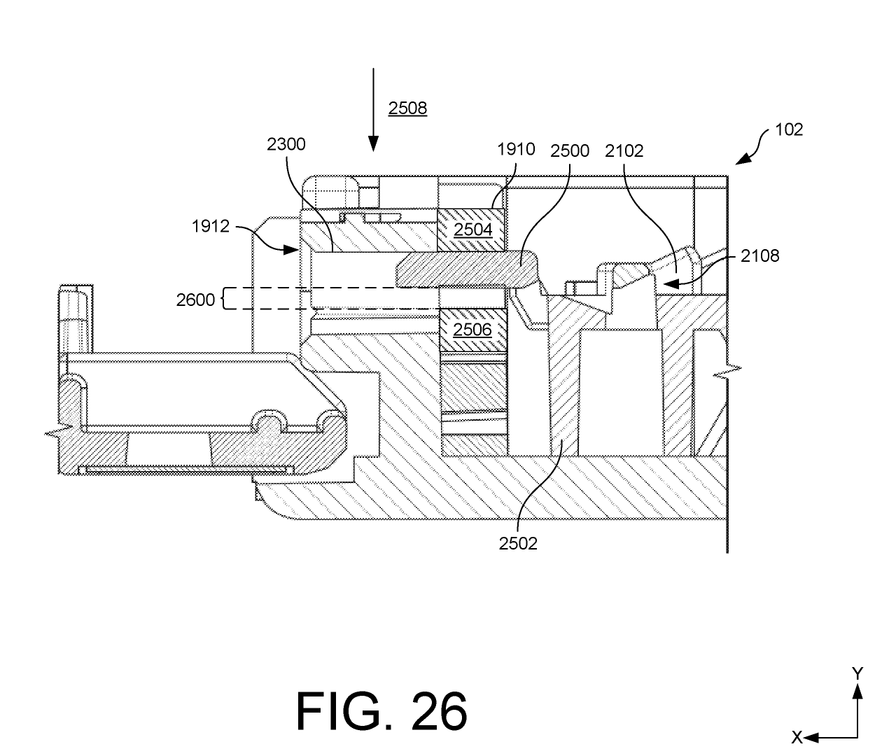

FIG. 25 illustrates a cross-sectional view taken along line E—E of FIG. 22, showing a portion of the shelf 102 and the arrangement and interaction of components associated with the compliant retainer 1910. The guide 1908 is formed by the first wall 2102 and the top wall 2106, which together define the passage 2108 through which tracer cables 1916 may be routed. The passage 2108 extends through the guide 1908 to direct tracer cables 1916 toward the compliant retainer 1910. In an embodiment, the guide 1908 may form a tortuous path, such as a serpentine, winding, or curved pathway, that holds the tracer cable 1916 in place through frictional engagement or interference fit as the tracer cable 1916 traverses the passage 2108. The tortuous path may include bends, turns, or constrictions that resist movement of the tracer cable 1916 in the reverse direction, thereby retaining the tracer cable 1916 within the guide 1908 without requiring additional retention features. After passing through the guide 1908, the tracer cable 1916 may exit the passage 2108. The tracer cable 1916 may then pass through the compliant retainer 1910, beneath a flange 2500. The flange 2500 may be formed by a frame 2502, such as a body, frame, housing, or other structural component, and the guide 1908 may additionally be formed via the insert. The frame 2502 may couple to the shelf 102.

The compliant retainer 1910 is positioned adjacent to the guide 1908 and includes a first arm 2504 and a second arm 2506. The tracer cable 1916 may pass through a space between the flange 2500 and the second arm 2506 of the compliant retainer 1910. The compliant retainer 1910 may be depressed in a direction 2508, thereby moving the second arm 2506 away from the flange 2500 and providing a space through which the tracer cable 1916 may be routed and into the passages 2300. The end 1912 of the compliant retainer 1910 represents the location where the tracer cables 1916 emerge and may be viewed.

The door 2200 includes the aperture 2202 that aligns with the end 1912 of the compliant retainer 1910. The alignment between the aperture 2202 and the end 1912 permits light transmitted through a tracer cable 1916 to be visible when the door 2200 is in a closed position. A screen 2510 is associated with the door 2200 and serves as a diffusing element that disperses light emerging from the tracer cables 1916. The screen 2510 may make the tracer function visible to a technician by spreading the light emitted from the end 1912 of the tracer cable 1916.

FIG. 26 illustrates a cross-sectional view taken along a line similar to that of line E—E of FIG. 22, but showing the compliant retainer 1910 being depressed in the direction 2508. For example, a user may press on the first arm 2504 to displace the first arm 2504 until it contacts a top surface of the flange 2500. Depression in the direction 2508 displaces the second arm 2506 from a bottom surface of the flange 2500. This forms a gap distance 2600 through which the tracer cable 1916 may be routed after exiting the guide 1908.

When the compliant retainer 1910 is released, its resilient nature may cause the tracer cable 1916 to be retained between the second arm 2506 and the flange 2500. The tracer cables 1916 may then be routed through the compliant retainer 1910 and into the passages 2300. In an embodiment, the gap distance 2600 in a resting state may be sized to retain the tracer cables 1916 within the compliant retainer 1910 while permitting insertion of the tracer cables 1916 when the compliant retainer 1910 is depressed. The first arm 2504 and the second arm 2506 may return toward the resting position when the compliant retainer 1910 is released, reducing the gap distance 2600 and securing the tracer cables 1916 in position. The frame 2502 supports the flange 2500 and provides structural support for the compliant retainer 1910 and associated routing components. The first wall 2102 forms part of a guide structure that assists in directing tracer cables 1916 toward the passage 2108 and subsequently through the compliant retainer 1910 to the passages 2300.

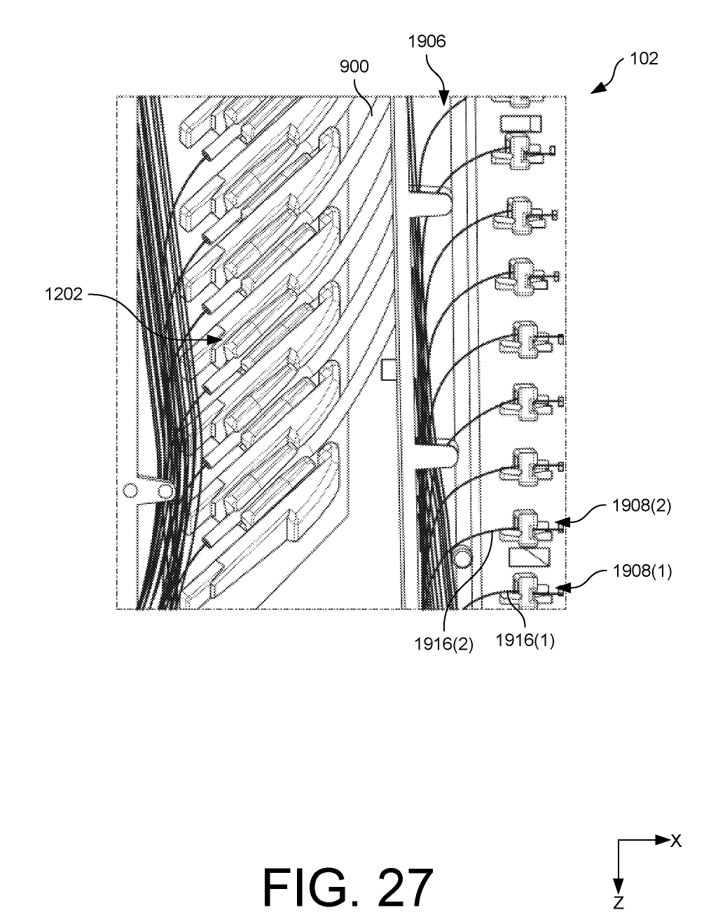

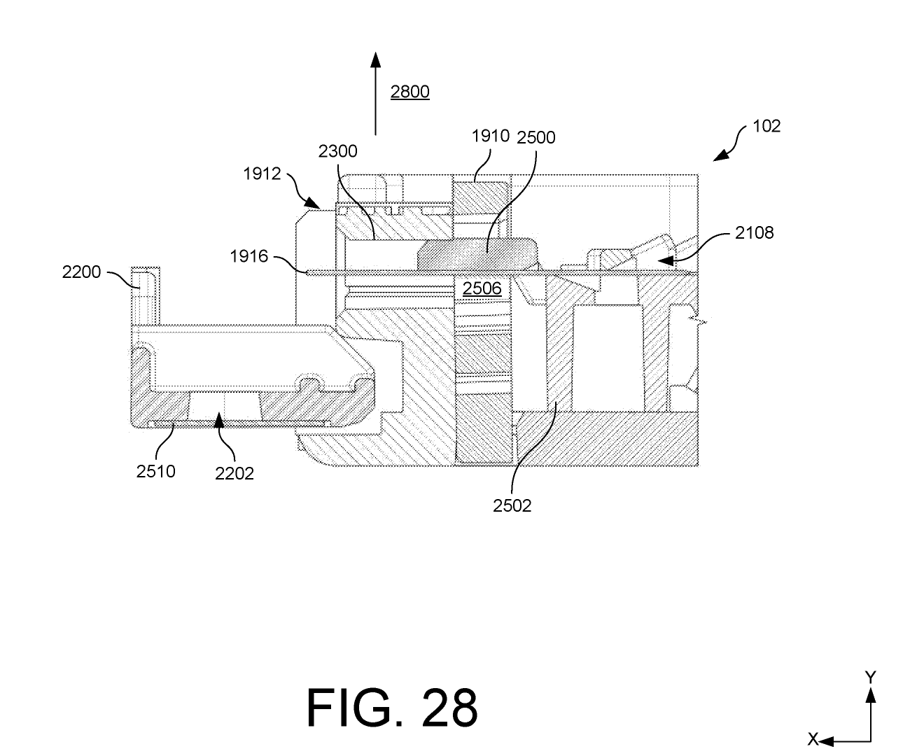

FIG. 27 illustrates a detailed view of a portion of the shelf 102 showing the routing of cables 900 and tracer cables 1916 through the second channel 1906 and guides 1908. The second channel 1906 is positioned adjacent to the guides 1908 and provides a pathway for routing the tracer cables 1916. A first guide 1908(1) and a second guide 1908(2) are visible on the shelf 102, each configured to receive and direct a respective tracer cable 1916. The first guide 1908(1) and the second guide 1908(2) include passages through which the tracer cables 1916 are routed. A first tracer cable 1916(1) extends through the first guide 1908(1), while a second tracer cable 1916(2) extends through the second guide 1908(2). The first tracer cable 1916(1) and the second tracer cable 1916(2) extend from the second channel 1906 through the first guide 1908(1) and the second guide 1908(2), respectively, to emerge at ends visible on an exterior of the shelf 102. The first tracer cable 1916(1) and the second tracer cable 1916(2) are provided as examples, and other tracer cables 1916 may be routed through other guides 1908 in a similar manner.

The cables 900 are secured within the shelf 102 using retention features. The arrangement of the first guide 1908(1) and the second guide 1908(2) facilitates organized routing of the tracer cables 1916 within the shelf 102 structure. The first guide 1908(1) may direct the first tracer cable 1916(1) toward a corresponding compliant retainer 1910, and the second guide 1908(2) may direct the second tracer cable 1916(2) toward a corresponding compliant retainer 1910 for circuit identification purposes. The routing configuration enables individual tracer cables 1916 to be traced by transmitting visible light through a tracer cable 1916 and observing the light at the corresponding end 1912.

FIG. 28 illustrates a cross-sectional view of a portion of the shelf 102, similar to that taken along line E—E of FIG. 22, but with the tracer cable 1916 routed through the passage 2108. The cross-sectional view depicts the visibility of light through the door 2200 and is taken in a direction 2800 that is opposite to the direction 2508 in which the compliant retainer 1910 is depressed during operation.

The tracer cable 1916 extends through the passage 2108 and through the compliant retainer 1910. The frame 2502 supports the flange 2500, which assists in routing the tracer cable 1916 into the passages 2300. The tracer cable 1916 is pinched or clamped between the second arm 2506 of the compliant retainer 1910 and the flange 2500, holding the tracer cable 1916 in position within the passages 2300. The end 1912 of the compliant retainer 1910 represents the location where the tracer cable 1916 emerges and is visible. In an embodiment, the tracer cable 1916 may be pushed out the end 1912 and then cut to permit the door 2200 to be closed. The cutting of the tracer cable 1916 at or near the end 1912 provides a flush or near-flush termination that does not interfere with the closing of the door 2200 while maintaining the tracer functionality.

The door 2200 is positioned at the front of the shelf 102 and includes the aperture 2202 that aligns with the passage 2108. The screen 2510 is coupled to the door 2200 and functions as a diffusing screen. The screen 2510 is positioned to diffuse light transmitted through the tracer cable 1916 when a tracer function is activated.

When a visual fault locator or other light source is coupled to the tracer cable 1916, visible light travels through the tracer cable 1916, through the passage 2108, through the compliant retainer 1910, and emerges at the end 1912. The screen 2510 disperses the light emerging from the end 1912 of the tracer cable 1916, making the light visible to a technician through the aperture 2202 in the door 2200. The diffusing function of the screen 2510 spreads the light emitted from the tracer cable 1916, enhancing visibility of the tracer function when the door 2200 is in a closed position.

In an embodiment, the screen 2510 may be formed from a translucent material, a frosted material, a textured material, or other light-dispersing material that permits light to pass through while spreading the light across a larger viewing area. The screen 2510 may be integrally formed with the door 2200 or may be a separate component coupled to the door 2200. The arrangement of the passage 2108, the aperture 2202, and the screen 2510 enables a technician to visually identify which circuit is being traced by observing which aperture 2202 emits light during tracing operations.

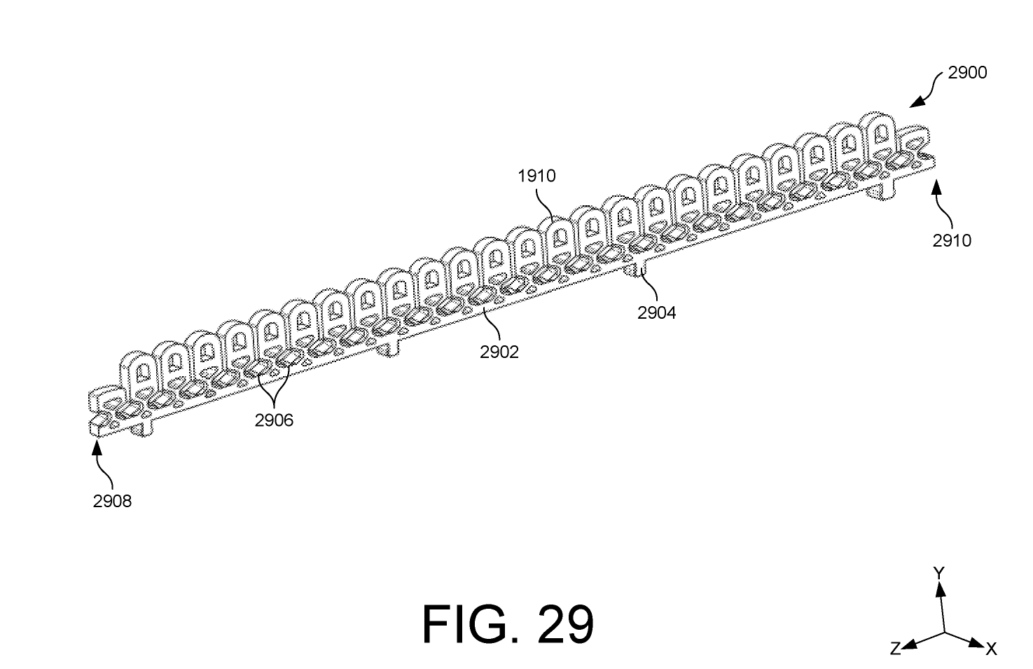

FIG. 29 illustrates an isometric view of a strip 2900, such as a bar, rail, carrier, or other elongated support, that includes compliant retainers 1910. The strip 2900 includes a body 2902 from which the compliant retainers 1910 are formed. The body 2902 extends longitudinally between a first end and a second end 2910, and supports a plurality of the compliant retainers 1910 disposed between the first end and the second end 2910. The compliant retainers 1910 are arranged in a linear array along the length of the strip 2900. Each compliant retainer 1910 includes a structure configured to receive and retain tracer cables 1916.

Tabs 2904 extend from the body 2902 and are configured to secure the strip 2900 to the shelf 102. The tabs 2904 are positioned at intervals along the body 2902. In an embodiment, the tabs 2904 may engage with corresponding features on the shelf 102, such as slots, recesses, apertures, or other mounting features, to retain the strip 2900 in position relative to the shelf 102.

Slots 2906 are formed in the body 2902 and function as channels, receptacles, or bores that receive prongs of a connector. The slots 2906 are positioned adjacent to the compliant retainers 1910. In an embodiment, the slots 2906 may align with the receptacles 2400 to facilitate engagement between the connector and the strip 2900 when the connector is coupled to the shelf 102.

The strip 2900 provides a modular configuration that allows multiple compliant retainers 1910 to be installed simultaneously on the shelf 102. The modular configuration of the strip 2900 facilitates the routing and retention of tracer cables 1916 within the shelf 102 by providing a plurality of the compliant retainers 1910 in a single component. In an embodiment, the strip 2900 may be formed from an elastomeric material, a resilient polymer, or other flexible material that permits the compliant retainers 1910 to be depressed and to return to a resting position when released. The body 2902 may provide structural support for the compliant retainers 1910 while permitting individual compliant retainers 1910 to flex independently during installation of tracer cables 1916.

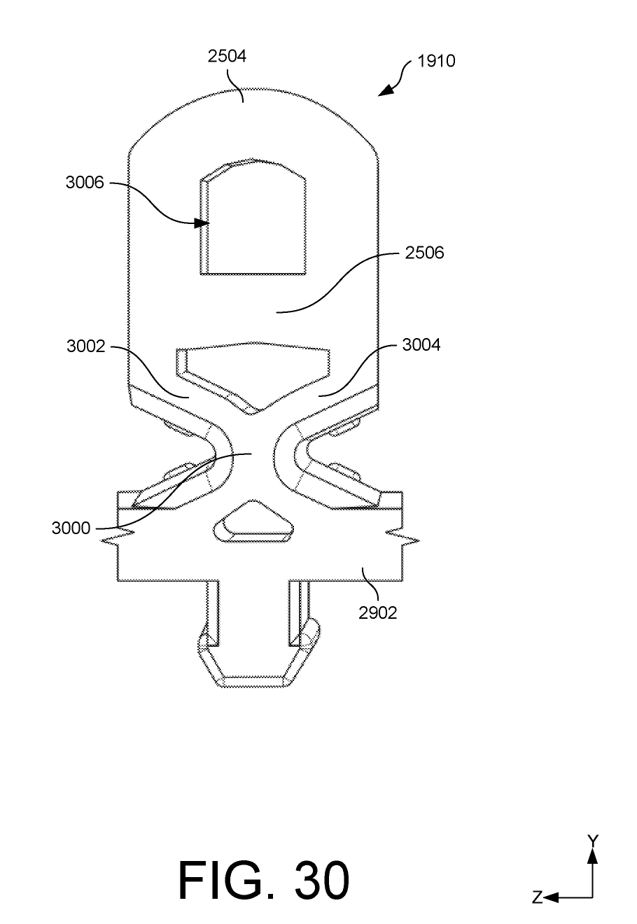

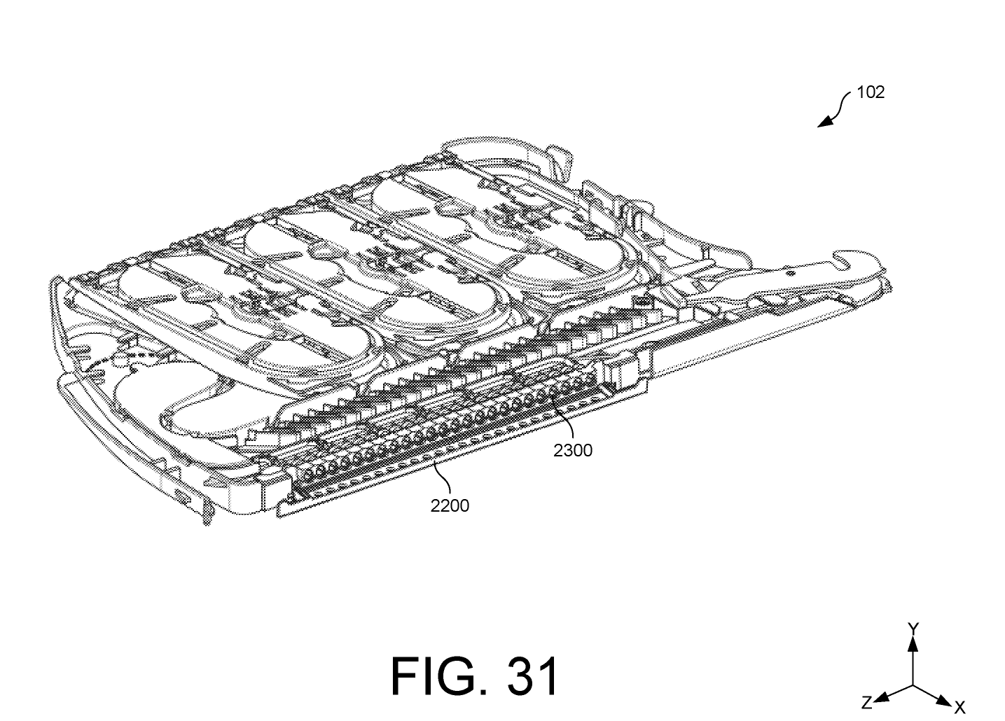

FIG. 30 illustrates details of the compliant retainer 1910. The compliant retainer 1910 includes the body 2902 from which a neck 3000 extends. The neck 3000 provides a structural connection between the body 2902 and upper portions of the compliant retainer 1910. A first branch 3002 extends from the neck 3000 on one side, and a second branch 3004 extends from the neck 3000 on an opposing side. The first branch 3002 and the second branch 3004 provide structural support and define an overall shape of the compliant retainer 1910. The first branch 3002 and the second branch 3004 provide the resilient or biasable nature of the compliant retainer 1910, enabling the compliant retainer 1910 to deflect when depressed and return to a resting position when released.

The first arm 2504 extends from an upper region of the compliant retainer 1910, and the second arm 2506 is positioned adjacent to the first arm 2504. The first arm 2504 and the second arm 2506 are configured to facilitate retention and positioning of tracer cables 1916 within the shelf 102. A passage 3006 is formed within the compliant retainer 1910, positioned between the first arm 2504 and the body 2902. The passage 3006 provides an opening to receive the tracer cable 1916 and a pathway through which tracer cables 1916 may be routed and retained.

In an embodiment, the first branch 3002 and the second branch 3004 may extend outwardly from the neck 3000 to form a widened region of the compliant retainer 1910. The first branch 3002 and the second branch 3004 may provide flexibility to the compliant retainer 1910, permitting the first arm 2504 and the second arm 2506 to deflect when the compliant retainer 1910 is depressed. The configuration of the first branch 3002 and the second branch 3004 may distribute forces applied to the compliant retainer 1910 during depression, enabling the compliant retainer 1910 to return to a resting position when released. The resilient or biasable characteristics of the first branch 3002 and the second branch 3004 permit the compliant retainer 1910 to be repeatedly depressed and released while maintaining its ability to secure tracer cables 1916.

The passage 3006 may be sized to receive one or more tracer cables 1916. In an embodiment, the passage 3006 may extend through the compliant retainer 1910 from an entry point proximate to the body 2902 toward an exit point proximate to the first arm 2504 and the second arm 2506. The tracer cables 1916 may be routed through the passage 3006 and retained by the interaction between the first arm 2504, the second arm 2506, and the flange 2500 when the compliant retainer 1910 is in a resting state.

The compliant retainer 1910 may be configured to permit depression of the first arm 2504 and the second arm 2506 to allow insertion of tracer cables 1916 through the passage 3006. When the compliant retainer 1910 is released, the first arm 2504 and the second arm 2506 may return to a resting position, securing the tracer cables 1916 within the passage 3006. The resilient nature of the compliant retainer 1910, including the flexibility and biasable characteristics provided by the neck 3000, the first branch 3002, and the second branch 3004, may enable the compliant retainer 1910 to repeatedly receive and retain tracer cables 1916 without permanent deformation.

FIG. 31 illustrates a perspective view of the shelf 102, showing the door 2200 in an open state. In the open state, the passages 2300 are exposed and accessible for installation of tracer cables or for coupling a connector to the shelf 102 for tracer identification purposes.

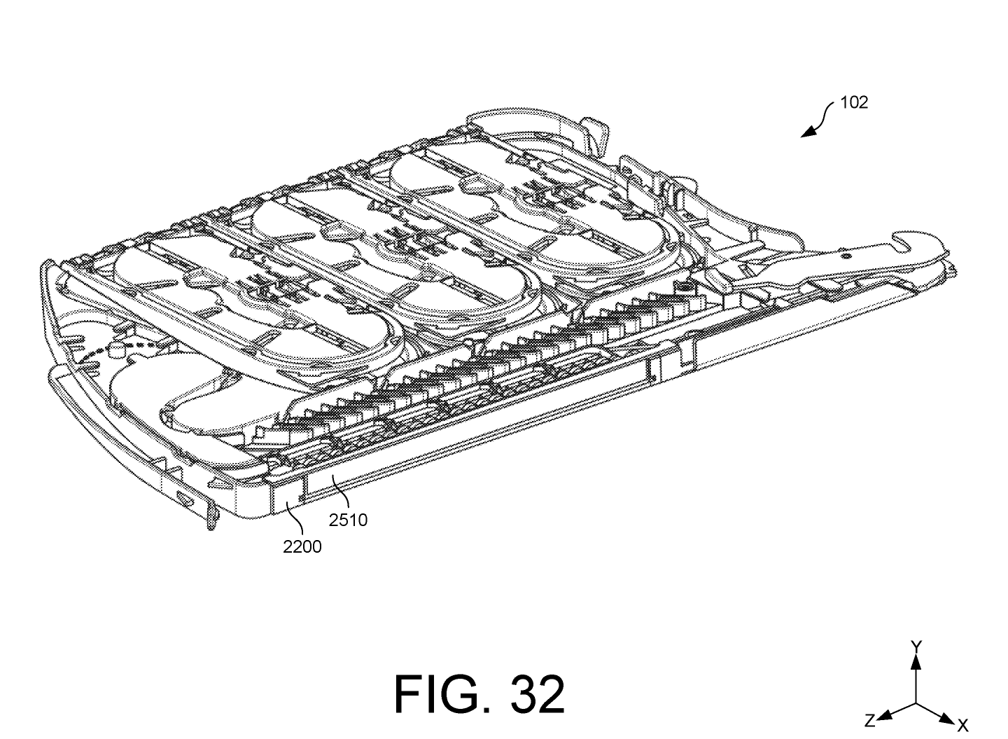

FIG. 32 illustrates an isometric view of the shelf 102 showing the door 2200 in a closed position and the screen 2510. The screen 2510 is coupled to the door 2200 and disperses light transmitted through the tracer cables 1916, making the light visible to a technician through the apertures 2202 without requiring the door 2200 to be opened. In an embodiment, the screen 2510 may be positioned on an exterior surface of the door 2200, aligned with the apertures 2202. The screen 2510 may be formed from a textured material, such as textured polycarbonate, textured plexiglass, frosted plastic, or other light-dispersing material. The screen 2510 may be configured as a label, decal, overlay, or panel that is adhered, bonded, or otherwise coupled to the door 2200. The screen 2510 may include markings, numbers, or other indicia that correspond to the apertures 2202 and the associated tracer cables 1916, facilitating identification of individual circuits during tracing operations.

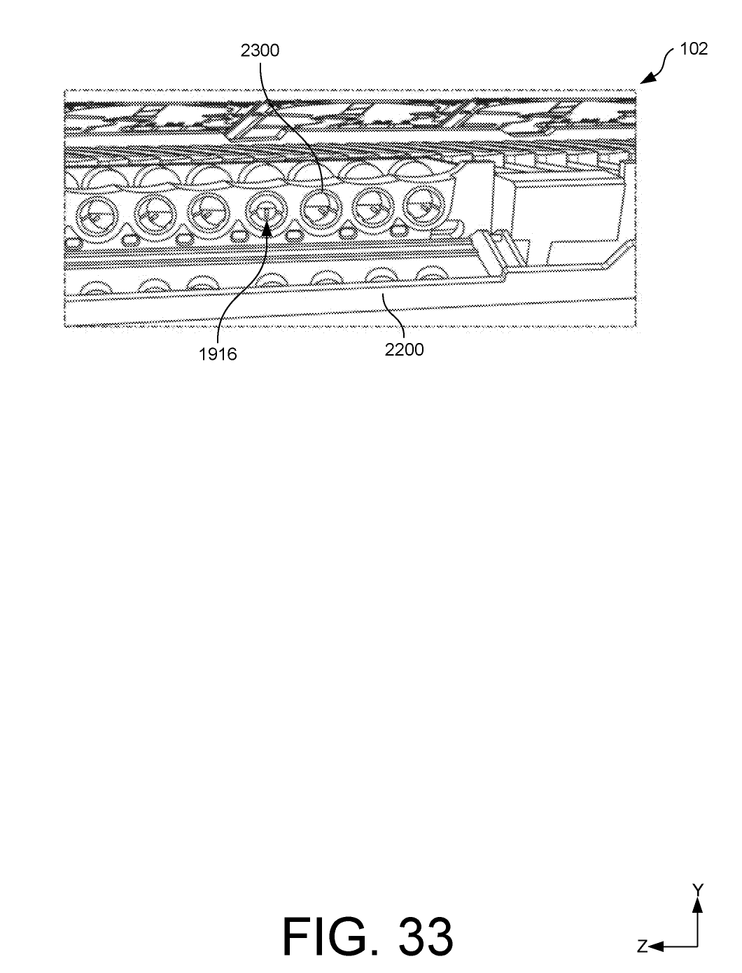

FIG. 33 illustrates a perspective view of a portion of the shelf 102 showing the tracer cables 1916 routed toward the passages 2300 in the door 2200. The tracer cables 1916 extend along the shelf 102 and are positioned adjacent to the passages 2300 formed in the door 2200. The passages 2300 are arranged in a linear array along the door 2200, with each passage 2300 configured to receive an end of a tracer cable 1916.

The tracer cables 1916 may be routed from the second channel 1906, through the guides 1908, through the compliant retainers 1910, and into the passages 2300. The ends of the tracer cables 1916 terminate at or within the passages 2300, positioning the fiber ends for visual tracing through the door 2200. When the door 2200 is in a closed position, the apertures 2202 formed in the door 2200 align with the passages 2300, permitting light transmitted through the tracer cables 1916 to be visible through the door 2200.

In an embodiment, the tracer cables 1916 may be trimmed or cut at the passages 2300 to provide a flush or near-flush termination that does not interfere with the closing of the door 2200. The positioning of the tracer cables 1916 within the passages 2300 enables a technician to transmit visible light from a visual fault locator or other light source through a tracer cable 1916 and observe the light at the corresponding passage 2300 through the door 2200. The arrangement of the tracer cables 1916 relative to the passages 2300 and the door 2200 facilitates circuit identification by providing a visible indication of which circuit is being traced when light is transmitted through the tracer cables 1916.

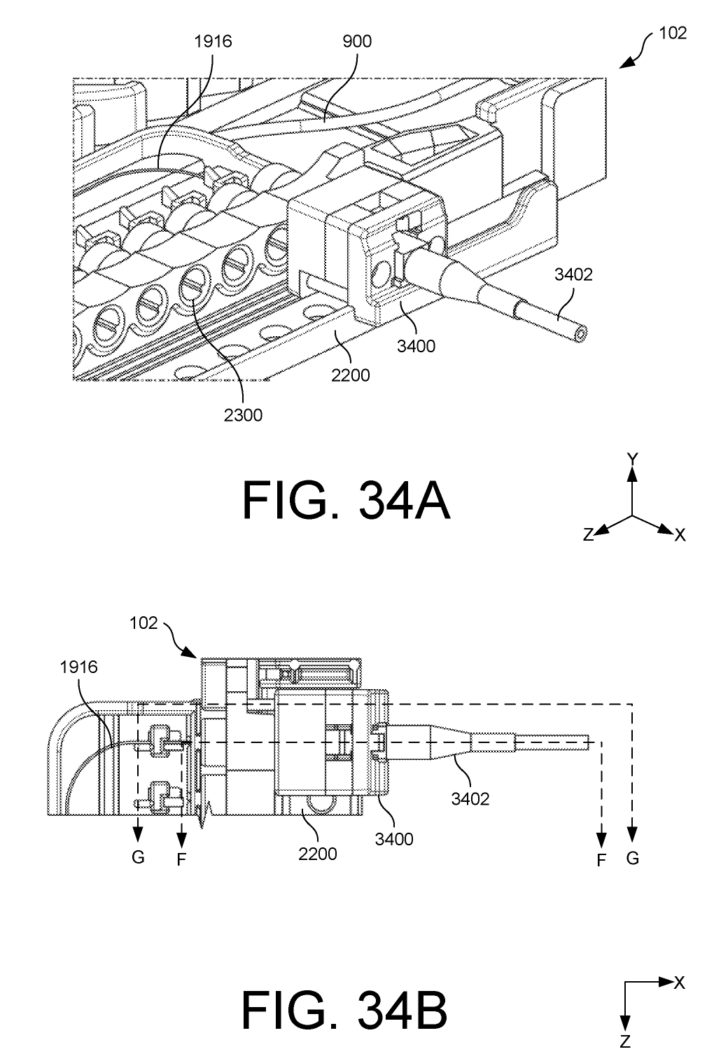

FIGS. 34A and 34B illustrate views of the shelf 102 with a coupler 3400 and a cable 3402 positioned adjacent to the door 2200 and the passages 2300 for circuit identification purposes. The coupler 3400 is configured to interface with the tracer cables 1916 for circuit identification purposes. The housing of the coupler 3400 may be formed from plastic, metal, composite materials, or other suitable structural materials. The cable 3402 is secured to the coupler 3400 and may be coupled to a visual fault locator or other light source for transmitting visible light through the coupler 3400 and into a tracer cable 1916.

The views show the shelf 102 with the door 2200 in an open position and the passages 2300 visible, illustrating the spatial relationship between the components. The tracer cables 1916 are routed through the shelf 102 and extend toward the passages 2300. The coupler 3400 is positioned adjacent to the shelf 102, with the cable 3402 secured to and extending from the coupler 3400.

The coupler 3400 may be engaged with the shelf 102 when the door 2200 is in the open position to establish optical coupling with a tracer cable 1916 routed through the passages 2300. The coupler 3400 secures to the shelf 102 while the door 2200 remains in the open position, providing access to the passages 2300 for coupling operations. When the coupler 3400 is engaged with the shelf 102, visible light transmitted through the cable 3402 secured to the coupler 3400 may travel through the coupler 3400 and into the tracer cable 1916. The light may then travel through the tracer cable 1916 and emerge at a remote location, enabling a technician to visually identify which circuit is being traced. The coupler 3400 may be repositioned to engage with different passages 2300 on the shelf 102, enabling the coupler 3400 to interface with different tracer cables 1916 for tracing multiple circuits.

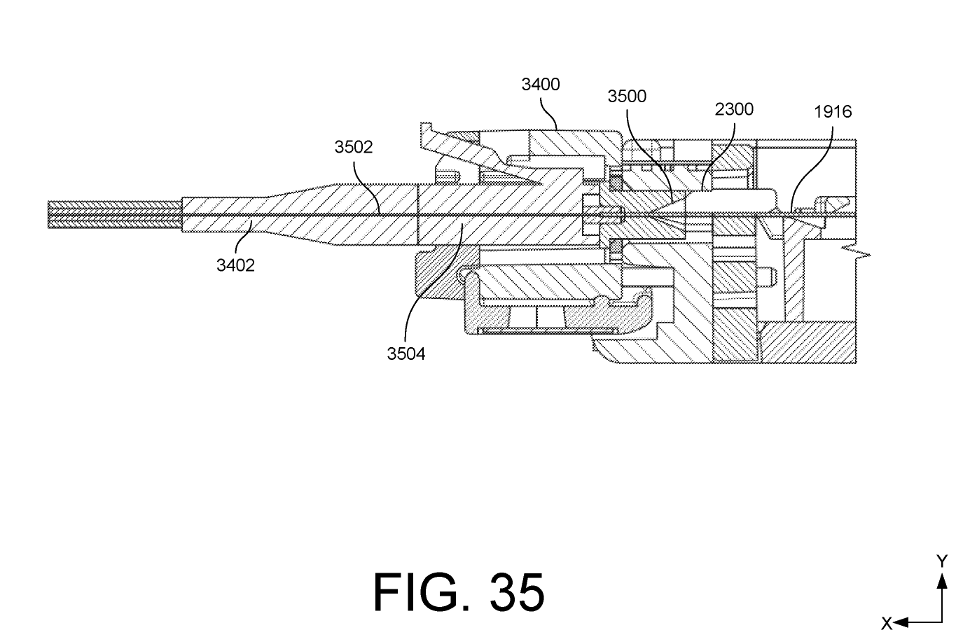

FIG. 35 illustrates a cross-sectional view taken along line F—F of FIG. 34B, showing the coupler 3400 engaged with the shelf 102. The coupler 3400 is connected to the cable 3402 that extends from the coupler 3400. The cable 3402 contains a fiber optic cable 3502 that runs through the length of the cable 3402. The cable 3402 secures to a connector 3504, where the connector 3504 removably secures to the coupler 3400.

The connector 3504 is positioned at an interface between the coupler 3400 and the shelf 102. The tracer cable 1916 may be routed into a bore 3500, where the bore 3500 is disposed within the passage 2300. The bore 3500 receives and aligns the tracer cable 1916 for optical coupling with the fiber optic cable 3502. When light is supplied, light travels from the fiber optic cable 3502 within the cable 3402 to the tracer cable 1916. The alignment between the fiber optic cable 3502 and the tracer cable 1916 within the bore 3500 enables optical coupling between a light source carried by the fiber optic cable 3502 and the tracer cable 1916. The passages 2300 guide the tracer cables 1916 into proper alignment with the bore 3500, facilitating the transmission of visible light for circuit tracing purposes.

In an embodiment, the bore 3500 may be configured as a large-bore ferrule that accommodates the tracer cable 1916 without requiring precise polishing or termination of the tracer cable 1916. The large-bore configuration of the bore 3500 may permit the tracer cable 1916 to be inserted into the bore 3500 with sufficient clearance to establish optical coupling while accommodating variations in the position or angle of the tracer cable 1916. In an embodiment, the bore 3500 may include a conical entrance, such as a conical acceptance cone, at an entry end of the bore 3500. The conical entrance may guide and center the tracer cable 1916 as the coupler 3400 is engaged with the shelf 102. The conical entrance may accommodate variations in the position or angle of the tracer cable 1916, guiding the tracer cable 1916 toward the center of the bore 3500 for alignment with the fiber optic cable 3502. The conical entrance may be formed as a tapered, flared, chamfered, or funnel-shaped opening that transitions from a larger diameter at the entry end to a smaller diameter corresponding to the bore 3500. When a visual fault locator or other light source is coupled to the cable 3402, visible light travels through the fiber optic cable 3502, through the connector 3504, and into the tracer cable 1916 received within the bore 3500. The light may then travel through the tracer cable 1916 and emerge at a remote location, enabling a technician to visually identify which circuit is being traced.

In an embodiment, the cable 3402 may include a single fiber optic cable 3502 for illuminating a single tracer cable 1916, or the cable 3402 may include multiple fiber optic cables 3502. When the cable 3402 includes multiple fiber optic cables 3502, each fiber optic cable 3502 may be insertable into a respective passage 2300 for illuminating different tracer cables 1916. In such instances, different colors of visible light may be transmitted through the respective fiber optic cables 3502 to facilitate identification of multiple circuits simultaneously. For example, a first fiber optic cable 3502 may transmit red light to a first tracer cable 1916 while a second fiber optic cable 3502 transmits green light to a second tracer cable 1916, enabling a technician to distinguish between the traced circuits based on the color of light observed at the remote location. The use of multiple fiber optic cables 3502 with different light colors may reduce the time required to trace multiple circuits by permitting simultaneous tracing operations rather than sequential repositioning of a single coupler 3400.

Although referred to herein as a coupler 3400, other optical coupling devices may be used to interface with the tracer cables 1916 for circuit identification purposes. For example, the coupler 3400 may represent an adapter, interface device, optical connector, coupling assembly, fiber interface, or other optical coupling mechanism configured to transmit visible light from a light source into a selected tracer cable 1916. The particular configuration of the optical coupling device may be selected based on the type of light source being used, the termination style of the tracer cables 1916, the accessibility requirements of the shelf 102, and the frequency with which tracing operations are performed. In an embodiment, the optical coupling device may be integrated with a visual fault locator or other light source, eliminating the need for a separate cable 3402 between the light source and the coupling device. In other embodiments, the optical coupling device may include multiple coupling ports that simultaneously engage with multiple passages 2300, enabling a technician to trace multiple circuits without repositioning the coupling device.

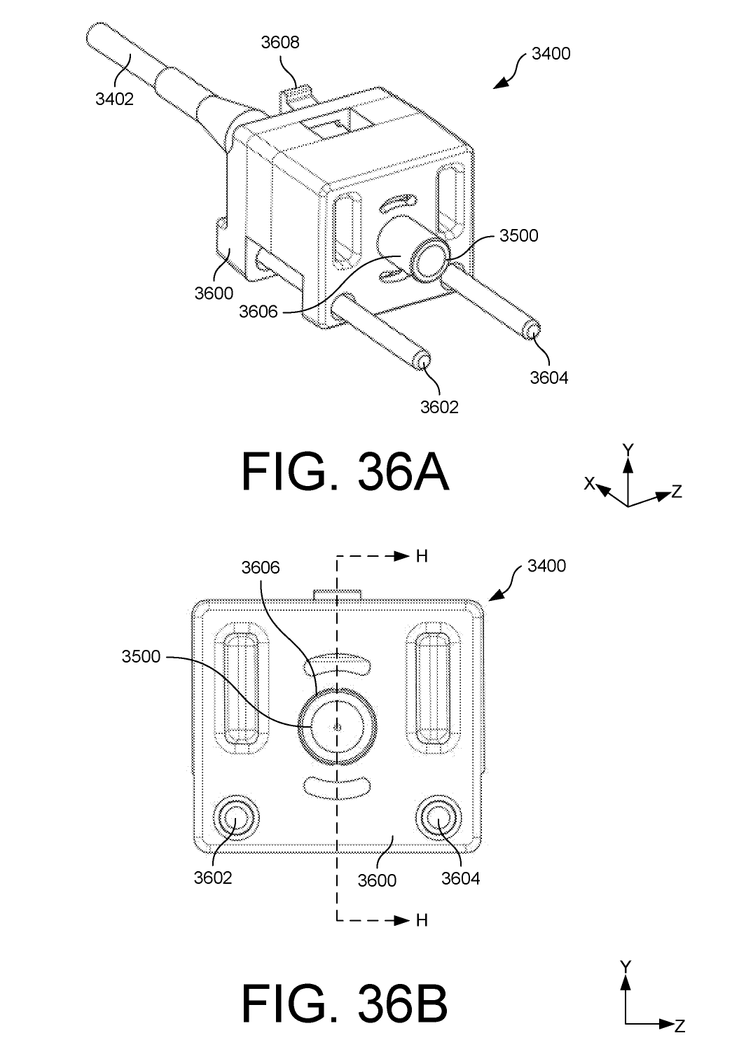

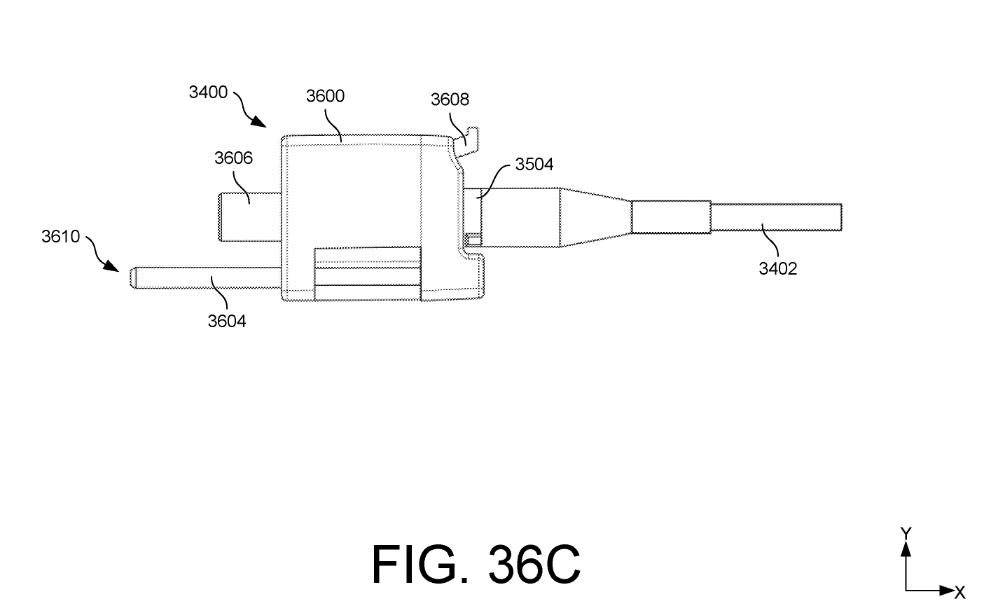

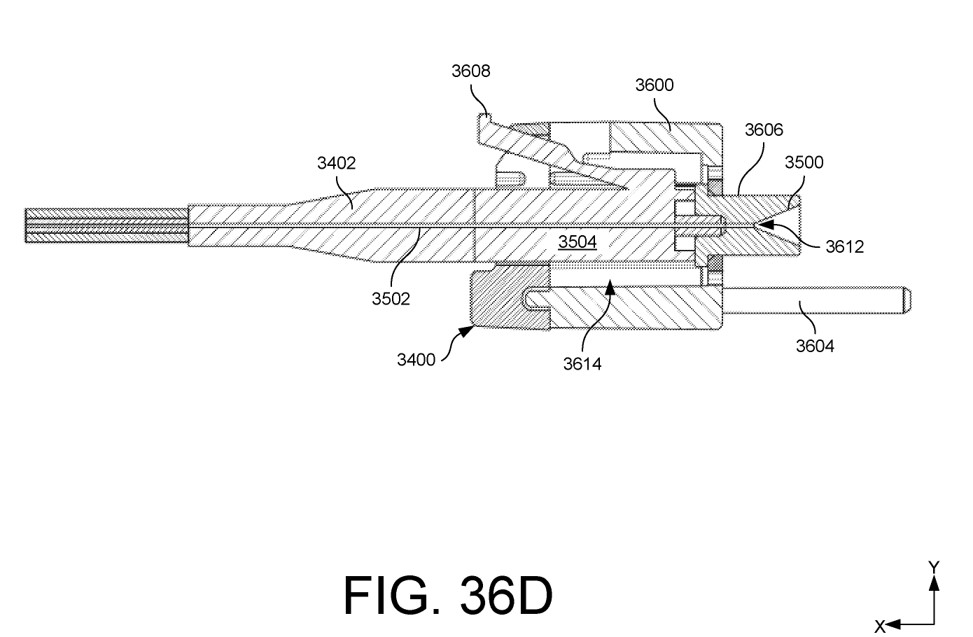

FIGS. 36A-36D illustrate various views of the coupler 3400, with FIG. 36D providing a cross-sectional view taken along line H—H of FIG. 36B. The coupler 3400 includes a housing 3600 that forms the main body of the coupler 3400. Alignment features in the form of a first prong 3602 and a second prong 3604 extend from the housing 3600 and are configured to engage with corresponding receptacles on the shelf 102. The first prong 3602 and the second prong 3604 are spaced apart from one another on opposite sides of a ferrule 3606, providing stable alignment when the coupler 3400 is inserted into a mating component on the shelf 102. The first prong 3602 and the second prong 3604 are insertable into the receptacles 2400 formed in the shelf 102 to position the coupler 3400 relative to the passages 2300 and the tracer cables 1916.

The ferrule 3606 protrudes from a surface of the housing 3600 and is configured to receive and align the fiber optic cable 3502 with the tracer cable 1916 for optical coupling purposes. The ferrule 3606 defines the bore 3500 through which the fiber optic cable 3502 is disposed, and the bore 3500 routes the tracer cable 1916 into optical coupling with the fiber optic cable 3502. In an embodiment, an end of the tracer cable 1916 is insertable into the opening 3612. A clip 3608 is disposed on the housing 3600 and secures the connector 3504 to the housing 3600.

An end 3610 of the second prong 3604 is visible at the termination point of the second prong 3604 and is insertable into the receptacles 2400 formed in the shelf 102 to align and secure the coupler 3400 in position relative to the passages 2300 and the tracer cables 1916. The ferrule 3606 includes an opening 3612 at its distal end through which the fiber optic cable 3502 interfaces with the tracer cable 1916. A receptacle 3614 is formed in the housing 3600 and receives the connector 3504, providing a secure interface between the connector 3504 and the coupler 3400.

The fiber optic cable 3502 is routed through the connector 3504 and into the bore 3500 of the ferrule 3606, enabling light to be coupled from the cable 3402 into a tracer cable 1916 when the coupler 3400 is engaged with the shelf 102. In an embodiment, the first prong 3602 and the second prong 3604 may be configured to engage with the slots 2906 formed in the strip 2900 of compliant retainers 1910. The engagement between the first prong 3602 and the second prong 3604 with the slots 2906 and the receptacles 2400 may align the ferrule 3606 with a passage 2300, positioning the bore 3500 to receive the tracer cable 1916 routed through the passage 2300. The alignment provided by the first prong 3602 and the second prong 3604 facilitates optical coupling between the fiber optic cable 3502 within the cable 3402 and the tracer cable 1916 without requiring precise manual positioning of the coupler 3400.

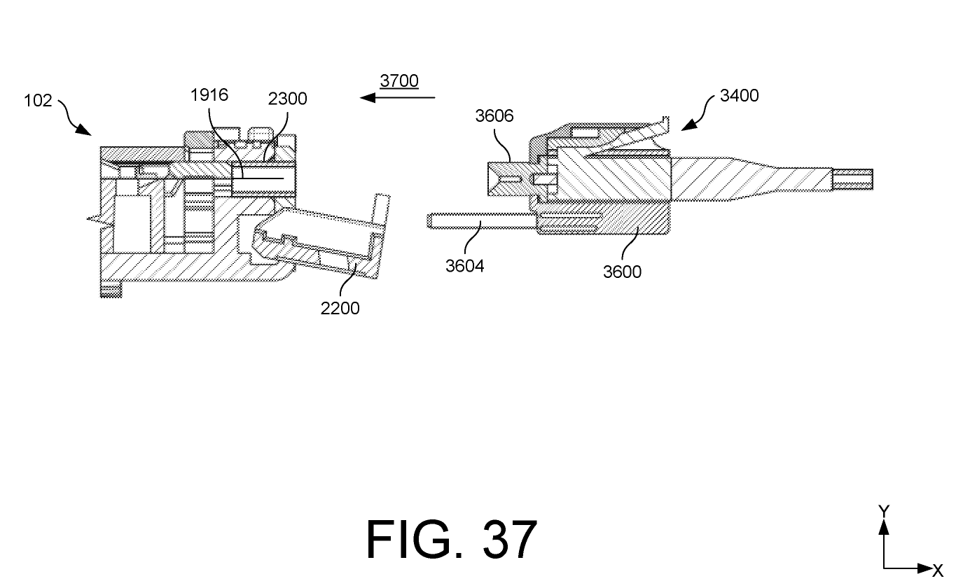

FIG. 37 illustrates an exploded view of the shelf 102 with the coupler 3400 and the connector 3504 positioned for engagement. The coupler 3400 is positioned adjacent to the shelf 102 with the cable 3402 attached. The second prong 3604 is oriented for insertion into the receptacles 2400 on the shelf 102. The door 2200 is shown in an open position, exposing the passages 2300 and permitting access for engagement of the coupler 3400. During engagement, the coupler 3400 is advanced toward the shelf 102 in a direction that disposes the ferrule 3606 within a passage 2300, while the first prong 3602 and the second prong 3604 are disposed within the receptacles 2400 to align the ferrule 3606 with the selected passage 2300.

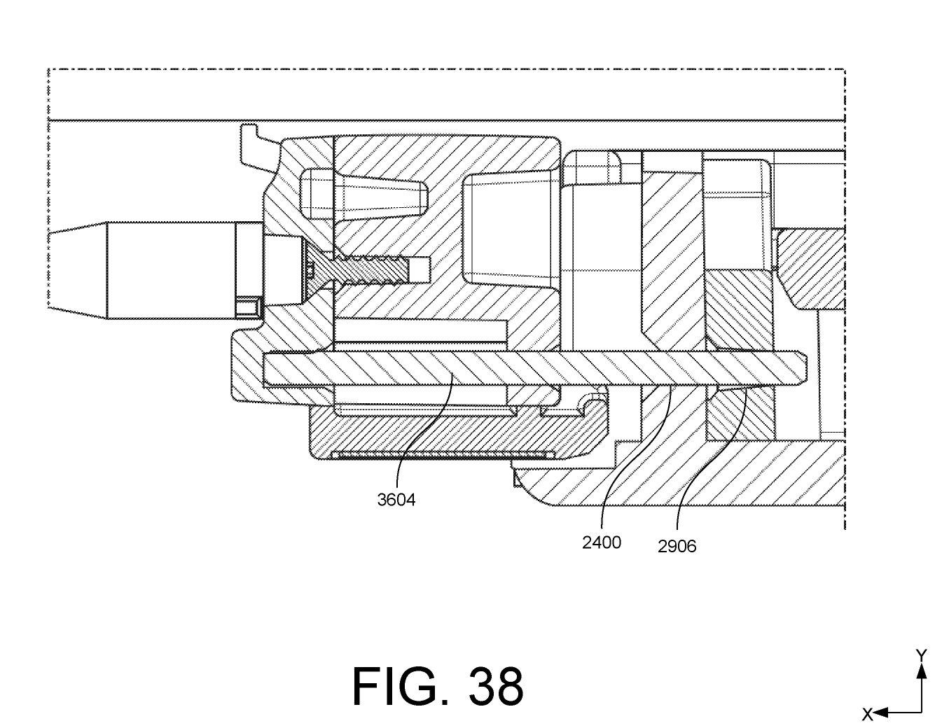

FIG. 38 illustrates a cross-sectional view taken along line G—G of FIG. 34B, showing the second prong 3604 engaged with the receptacles 2400 and the slots 2906. The second prong 3604 extends from the housing 3600 of the coupler 3400 and is disposed within the receptacles 2400 formed in the shelf 102. The receptacles 2400 receive and guide the second prong 3604 to establish proper positioning of the coupler 3400 relative to the passages 2300 and the tracer cables 1916. The receptacles 2400 may be formed as channels, grooves, bores, or recesses that correspond to the profile of the second prong 3604, enabling the second prong 3604 to be inserted into the receptacles 2400 during engagement of the coupler 3400 with the shelf 102.

In addition, in an embodiment, the second prong 3604 engages with the slots 2906 in addition to the receptacles 2400, providing alignment at multiple locations along the length of the second prong 3604. The engagement between the second prong 3604 and the slots 2906 positions the ferrule 3606 relative to the tracer cables 1916 routed through the compliant retainers 1910. The engagement between the second prong 3604 and the receptacles 2400 and/or the slots 2906 may also help retain a coupling between the coupler 3400 and the shelf 102, resisting inadvertent disengagement of the coupler 3400 during tracing operations.

The receptacles 2400 and the slots 2906 cooperate to guide and secure the coupler 3400 in the correct orientation relative to the tracer cables 1916. The alignment provided by the engagement between the second prong 3604 and the receptacles 2400 and the slots 2906 positions the bore 3500 of the ferrule 3606 to receive the tracer cable 1916, facilitating optical coupling between the fiber optic cable 3502 within the cable 3402 and the tracer cable 1916 for circuit identification purposes.

In an embodiment, the first prong 3602 may engage with corresponding receptacles 2400 and slots 2906 on an opposite side of the ferrule 3606 in a similar manner. The engagement of both the first prong 3602 and the second prong 3604 with the receptacles 2400 and the slots 2906 may provide stable alignment of the coupler 3400 relative to the shelf 102, reducing the likelihood of misalignment between the ferrule 3606 and the tracer cable 1916 during tracing operations. Although the first prong 3602, the second prong 3604, the receptacles 2400, and the slots 2906 are described as particular alignment mechanisms, other alignment mechanisms, features, structures, or configurations may be used to align the coupler 3400 with the shelf 102. For example, the coupler 3400 may include rails, tabs, flanges, detents, magnetic elements, keyed features, or other alignment structures that engage with corresponding features on the shelf 102 to establish proper positioning of the ferrule 3606 relative to the tracer cables 1916. The particular alignment mechanism may be selected based on the desired ease of engagement, retention force, repeatability of alignment, and structural constraints of the coupler 3400 and the shelf 102.

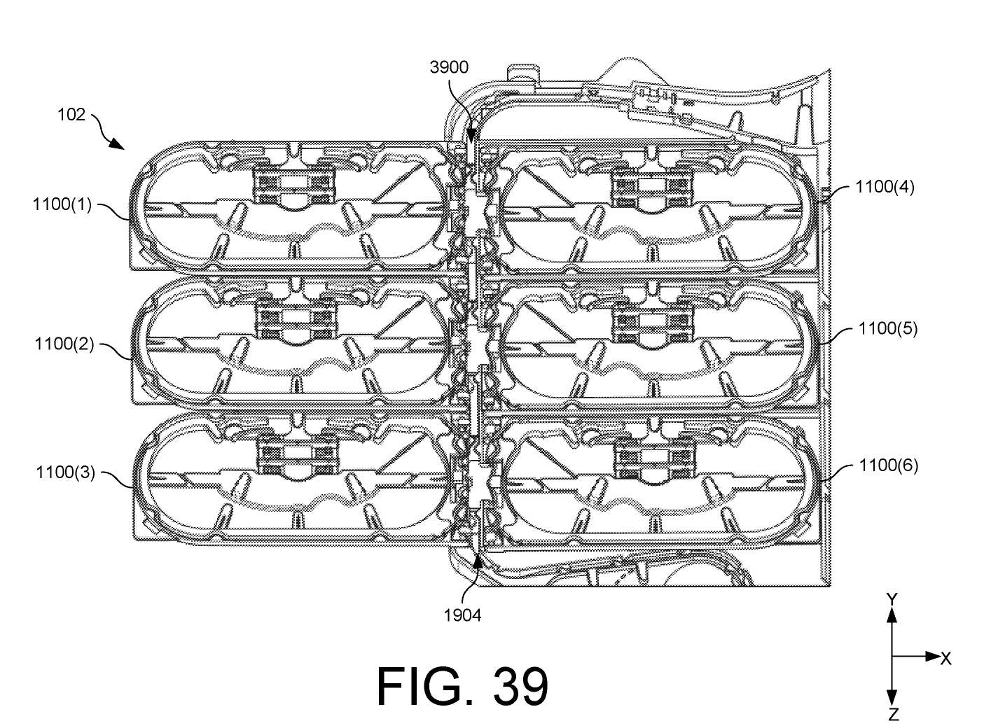

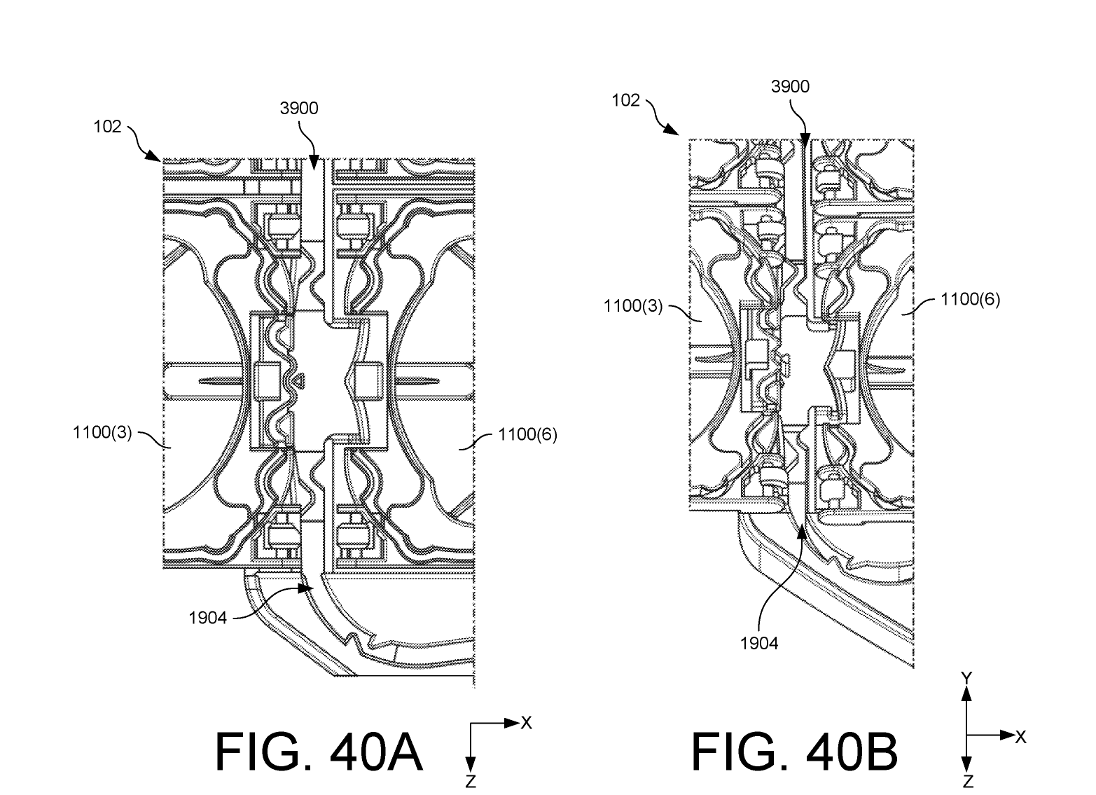

FIG. 39 illustrates a top view of the shelf 102 showing the arrangement of six of the trays 1100 and the spine 3900. The shelf 102 includes the tray 1100(1), the tray 1100(2), and the tray 1100(3) positioned in a first column, and the tray 1100(4), the tray 1100(5), and the tray 1100(6) positioned in a second column. The spine 3900, such as a backbone, central rib, divider, or other central routing structure, extends along a center of the shelf 102 between the first column and the second column of trays 1100. The spine 3900 provides a central channel for routing fiber optic cables from the first channel 1904 to the individual trays 1100. Fiber optic cables, such as the fiber optic cables 1914, entering the shelf 102 through the first channel 1904 may be directed toward the spine 3900, where the fiber optic cables may be distributed to the respective trays 1100. The spine 3900 may function as a distribution pathway that receives fiber optic cables from the first channel 1904 and routes the fiber optic cables to the trays 1100 on either side of the spine 3900.

In an embodiment, the spine 3900 may include routing features, guides, channels, or other cable management structures that direct fiber optic cables from the first channel 1904 toward the individual trays 1100. The fiber optic cables may branch from the spine 3900 and enter the respective trays 1100 for splicing operations. The arrangement of the spine 3900 between the two columns of trays 1100 facilitates organized cable routing by providing a centralized pathway from which fiber optic cables may be distributed to the trays 1100 positioned on either side of the spine 3900.

The symmetrical arrangement of the trays 1100 on either side of the spine 3900 may facilitate organized cable routing and access to individual trays 1100 for splicing operations. The first channel 1904 may receive fiber optic cables from the channel 1200 after the fiber optic cables are secured by the clamps 1202 within the receptacles 1204. The fiber optic cables may then traverse the first channel 1904, enter the spine 3900, and be routed to the designated trays 1100 based on the splicing configuration of the shelf 102.

FIGS. 40A and 40B illustrate views of the shelf 102 showing the tray 1100(3) and the tray 1100(6) positioned on opposite sides of the spine 3900. The first channel 1904 is positioned adjacent to the spine 3900 and directs fiber optic cables toward the trays 1100. The tray 1100(3) and the tray 1100(6) may represent trays positioned at corresponding locations within the first column and the second column of trays 1100, respectively. In an embodiment, the tray 1100(3) may be disposed at a different height above the tray 1100(6), such that the tray 1100(3) may close flushly against the tray 1100(6) when both trays are in the closed position.

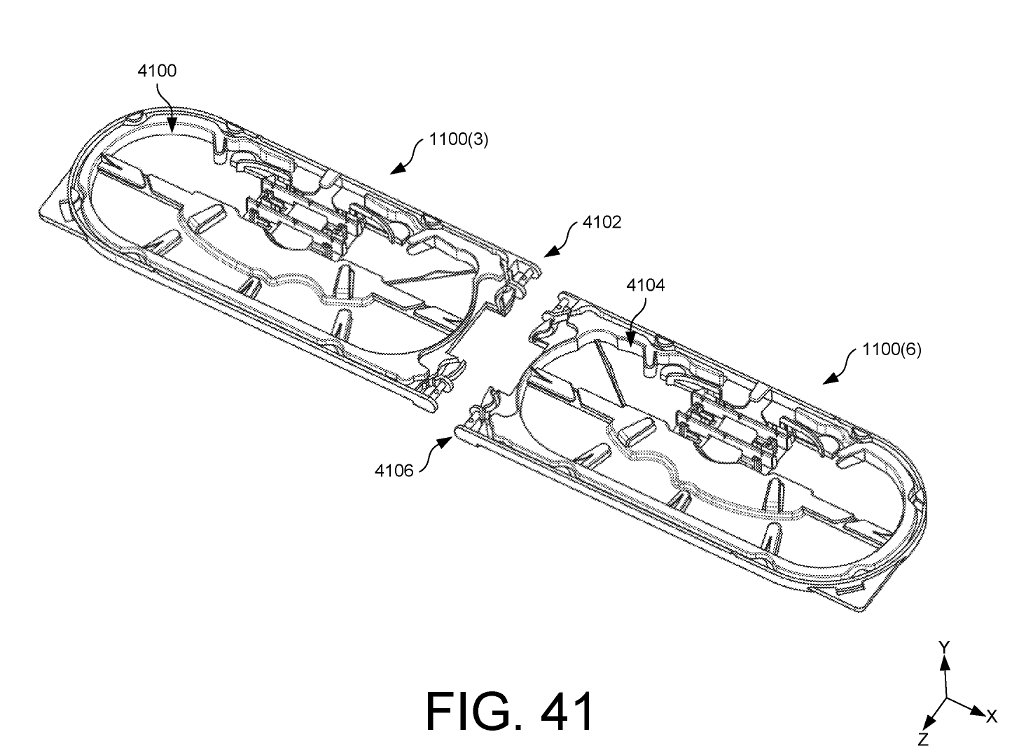

FIG. 41 illustrates an isometric view of the tray 1100(3) and the tray 1100(6) shown in a separated configuration, decoupled from the shelf 102. The tray 1100(3) includes an interior 4100 and a hinge 4102. The tray 1100(6) includes an interior 4104 and a hinge 4106. The interior 4100 of the tray 1100(3) and the interior 4104 of the tray 1100(6) provide workspaces for routing and storing fiber optic cables and for performing splicing operations.

The hinge 4102 is positioned along one edge of the tray 1100(3), and the hinge 4106 is positioned along one edge of the tray 1100(6). The hinge 4102 enables the tray 1100(3) to pivot between an open position and a closed position. Similarly, the hinge 4106 enables the tray 1100(6) to pivot between an open position and a closed position. In the open position, the interior 4100 of the tray 1100(3) and the interior 4104 of the tray 1100(6) are accessible for splicing operations, cable routing, and maintenance. In the closed position, the tray 1100(3) and the tray 1100(6) may be positioned against one another or against adjacent trays within the shelf 102.

In an embodiment, the hinge 4102 and the hinge 4106 may be formed as living hinges, flexible connections, pivot joints, or other articulating structures that permit rotational movement of the trays 1100 relative to the shelf 102. The hinge 4102 and the hinge 4106 may be integrally formed with the respective trays 1100 or may be separate components coupled to the trays 1100.

Fiber optic cables may be routed through or proximate to the hinge 4102 and the hinge 4106 as the fiber optic cables enter the tray 1100(3) and the tray 1100(6), respectively. By routing fiber optic cables along or through the rotational axis defined by the hinge 4102 and the hinge 4106, the fiber optic cables may experience reduced displacement as the trays 1100 transition between the open and closed positions. The routing of fiber optic cables through the hinge region may reduce tugging, pulling, or strain on the fiber optic cables during opening and closing operations, which may help maintain the integrity of the fiber optic connections within the trays 1100.

The hinged configuration of the tray 1100(3) and the tray 1100(6) permits individual access to each tray without disturbing fiber optic cables or splice connections housed within adjacent trays. When a technician opens the tray 1100(3) by pivoting the tray 1100(3) about the hinge 4102, the tray 1100(6) may remain in the closed position, protecting the fiber optic cables and splice connections within the interior 4104 of the tray 1100(6). Similarly, when the tray 1100(6) is opened by pivoting about the hinge 4106, the tray 1100(3) may remain closed to protect the contents of the interior 4100.

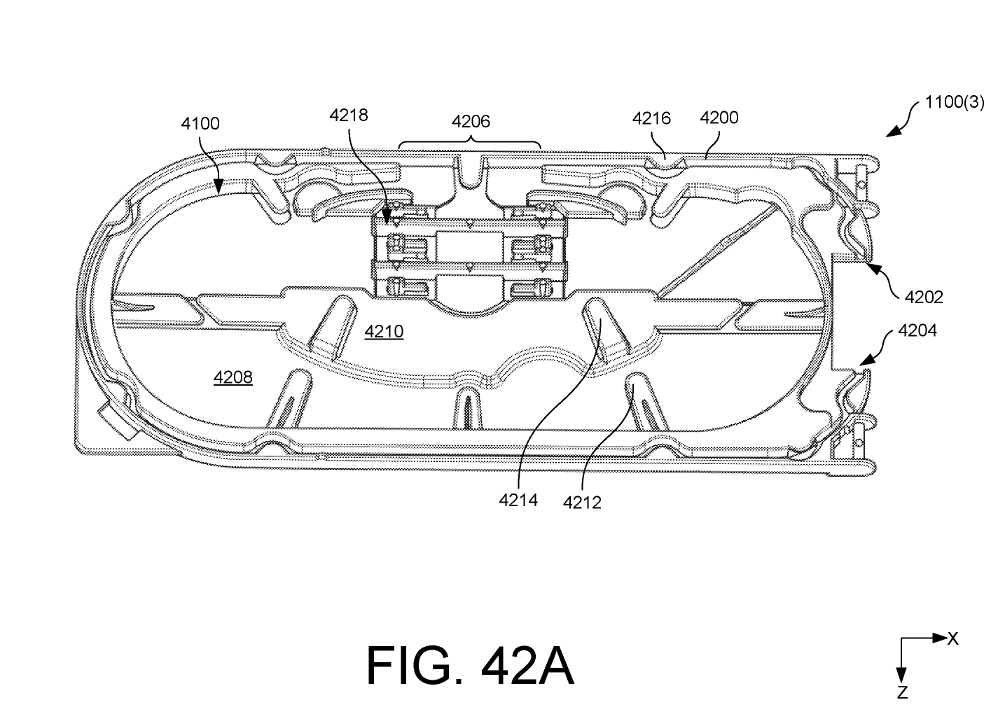

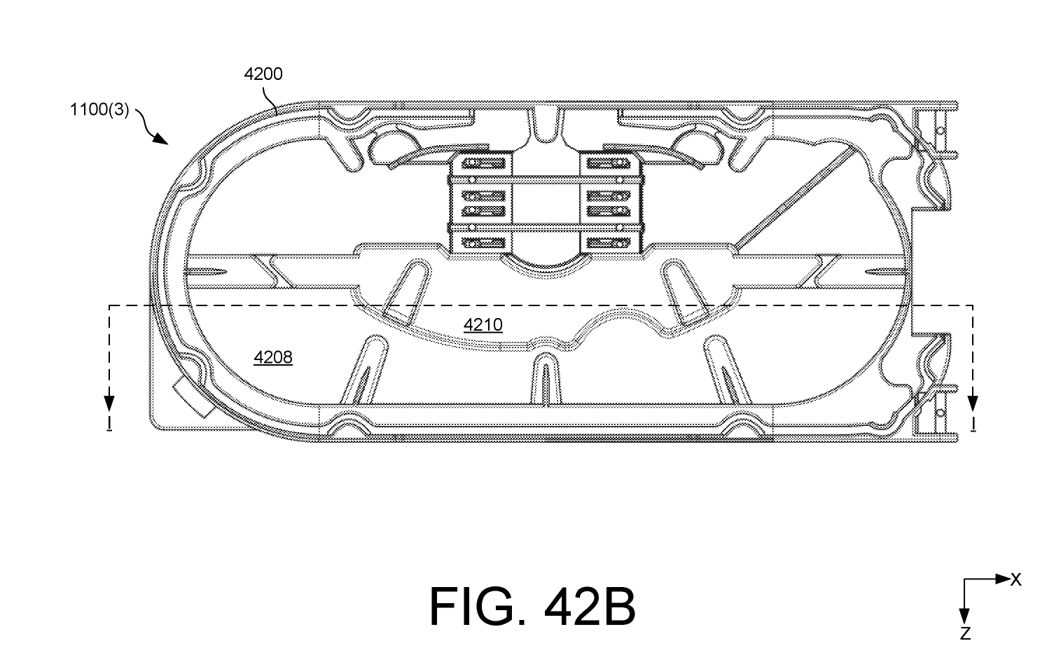

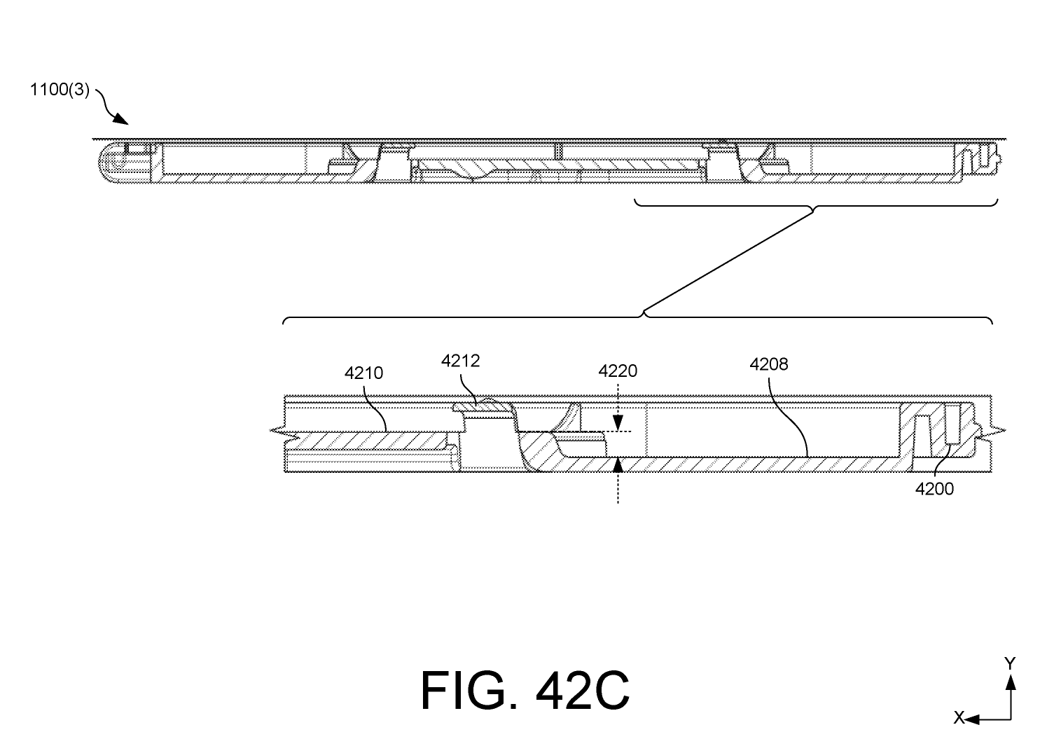

FIGS. 42A-42C illustrate views of the tray 1100(3), showing the interior 4100 and various structural features. FIG. 42C illustrates a cross-sectional view taken along line I—I of FIG. 42B. In an embodiment, the tray 1100(1) and the tray 1100(2) may be similar in structure and configuration to the tray 1100(3).

The tray 1100(3) includes a channel 4200 that surrounds a perimeter of the tray 1100(3). The channel 4200 provides a pathway for routing fiber optic cables into and through the tray 1100(3). The channel 4200 includes an opening 4202 and an opening 4204 positioned along the channel 4200 to facilitate routing of fiber optic cables. An opening 4206 provides a routing path from the channel 4200 to the interior 4100 of the tray 1100(3). In an embodiment, the opening 4206 may serve as a transition point at which unused trunk fibers separate from active fibers for storage within the tray 1100(3).

A base 4208 forms a bottom surface of the tray 1100(3) and provides structural support for the components housed within the interior 4100. The base 4208 defines a foundation area within the tray 1100(3) upon which fiber optic cables that are in use may be routed and stored.

A shelf 4210, such as a platform, ledge, raised surface, or elevated partition, is positioned within the tray 1100(3) and extends across a portion of the interior 4100. The shelf 4210 provides a surface for organizing and securing splice sleeves and fiber connections, as well as for routing and storing fiber optic cables that are not in use. The shelf 4210 is disposed above the base 4208 at a distance 4220, thereby physically separating fiber optic cables that are in use from fiber optic cables that are not in use. The distance 4220 separates the base 4208 and the shelf 4210. The base 4208 and the shelf 4210 define separate routing paths within the tray 1100(3), with fiber optic cables that are in use being routed along the base 4208 and fiber optic cables that are not in use being routed along the shelf 4210. The arrangement of the shelf 4210 relative to the base 4208 facilitates separation between active fibers and dark fibers. This physical separation allows a technician to access and retrieve dark fibers stored on the shelf 4210 without disturbing active, spliced fibers stored on the base 4208. In dense fiber environments where the tray 1100(3) may contain many fragile glass fibers, intermingling active and dark fibers in a single level would risk accidentally pulling or breaking a live, signal-carrying fiber when extracting a dark fiber for future splicing operations. By storing dark fibers on the elevated shelf 4210 and active fibers on the base 4208, the tray 1100(3) enables technicians to clearly distinguish between the two fiber types and selectively access dark fibers without inadvertently disrupting active circuits. The distance 4220 may be configured to accommodate fiber optic cables while maintaining proper bend radius and preventing damage to the fiber optic cables during routing and storage operations.

The tray 1100(3) includes multiple sets of tabs configured to retain and guide fiber optic cables within the tray 1100(3). Tabs 4212 extend from the shelf 4210 and are configured to hold fiber optic cables down within the base 4208, retaining fiber optic cables that are in use along the base 4208. Tabs 4214 are positioned along another portion of the tray 1100(3) and are configured to hold fiber optic cables down within the shelf 4210, retaining fiber optic cables that are not in use along the shelf 4210. Tabs 4216 are positioned near the channel 4200 and may assist in directing fiber optic cables as the fiber optic cables enter or exit the channel 4200. The tabs 4212, the tabs 4214, and the tabs 4216 may prevent fiber optic cables from shifting or becoming disorganized within the tray 1100(3).

A splice region 4218 is located in a central portion of the tray 1100(3). The splice region 4218 provides a designated area for housing splice sleeves and managing spliced fiber connections. In an embodiment, the splice region 4218 may include features configured to receive and retain splice sleeves, such as holders, clips, or recesses that secure the splice sleeves in position within the tray 1100(3).

The arrangement of the channel 4200, the opening 4202, the opening 4204, the opening 4206, the base 4208, the shelf 4210, and the tabs 4212, 4214, and 4216 within the interior 4100 of the tray 1100(3) facilitates organized routing and storage of fiber optic cables while providing access to the splice region 4218 for splicing operations. The configuration of the tray 1100(3) permits fiber optic cables to enter through the channel 4200, be routed along defined paths guided by the tabs 4212, 4214, and 4216, and be spliced within the splice region 4218. The physical separation provided by the shelf 4210 disposed above the base 4208 enables technicians to distinguish between fiber optic cables that are in use and fiber optic cables that are not in use within the tray 1100(3).

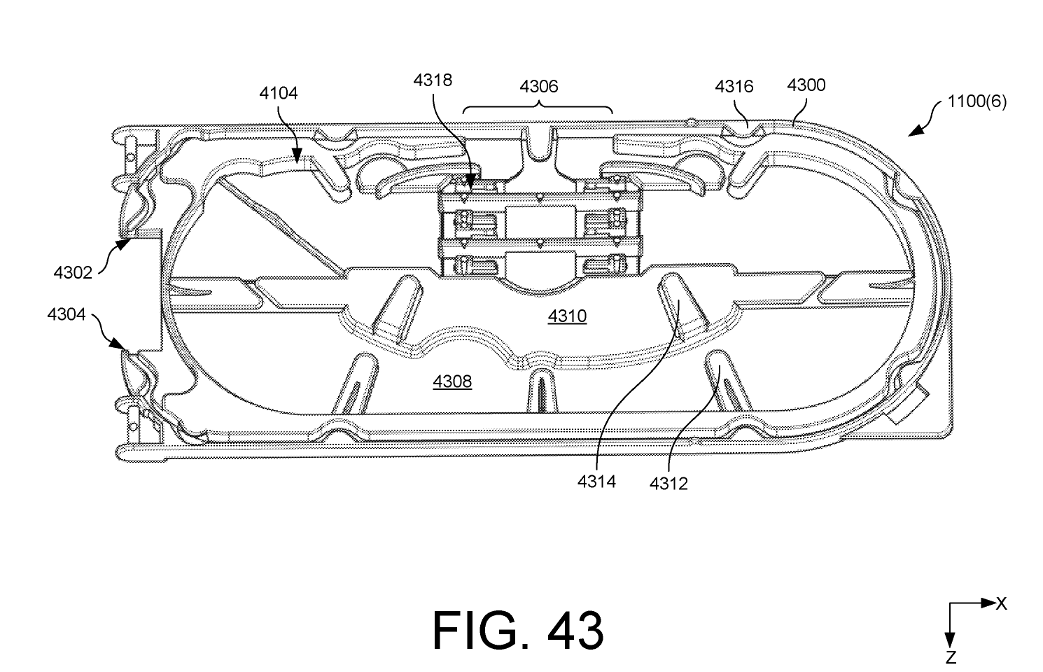

FIG. 43 illustrates the tray 1100(6). In an embodiment, the tray 1100(4) and the tray 1100(5) may be similar in structure and configuration to the tray 1100(6). The tray 1100(6) is similar in structure and configuration to the tray 1100(3). The tray 1100(6) includes a channel 4300 that surrounds a perimeter of the tray 1100(6), with openings 4302, 4304, and 4306 positioned along the channel 4300 to facilitate routing of fiber optic cables. A base 4308 forms a bottom surface of the tray 1100(6), and a shelf 4310 is positioned within the interior 4104 above the base 4308 to physically separate fiber optic cables that are in use from fiber optic cables that are not in use. The tray 1100(6) includes tabs 4312, tabs 4314, and tabs 4316 configured to retain and guide fiber optic cables within the tray 1100(6). A splice region 4318 is located in a central portion of the tray 1100(6), providing a designated area for housing splice sleeves and managing spliced fiber connections.

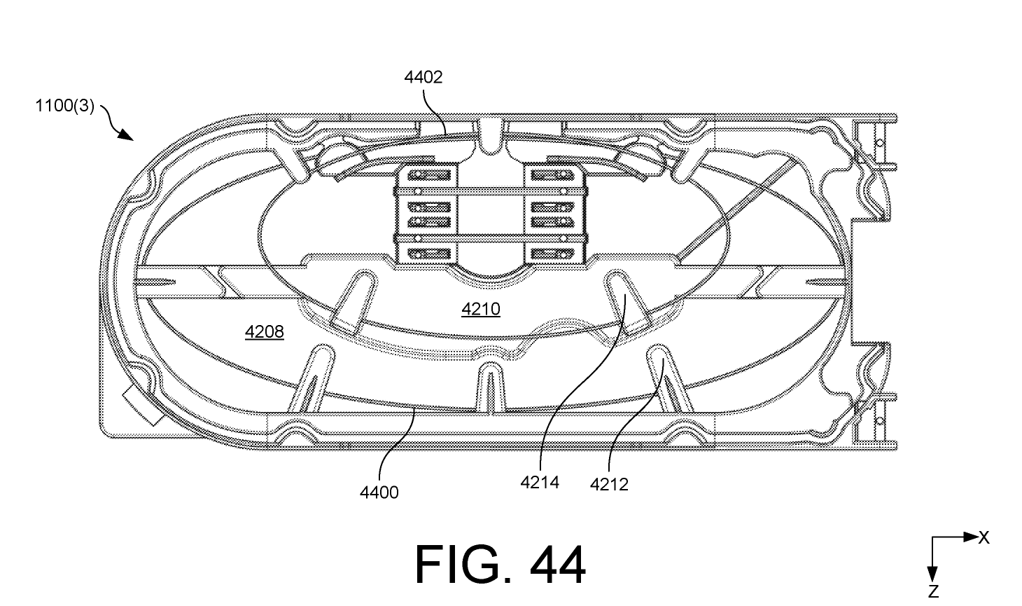

FIG. 44 illustrates a top view of the tray 1100(3) showing the routing of fiber optic cables within the tray 1100(3). A first fiber optic cable 4400 represents active fiber routed below the tabs 4212 on the base 4208. A second fiber optic cable 4402 represents dark fiber routed below the tabs 4214 on the shelf 4210.

The second fiber optic cable 4402 follows a path along an outer perimeter of the tray 1100(3). The second fiber optic cable 4402 is disposed below the tabs 4214 on the shelf 4210, where the second fiber optic cable 4402 is stored as dark fiber that is not in use. The routing of the second fiber optic cable 4402 along the outer track permits the second fiber optic cable 4402 to be stored within the tray 1100(3) while remaining accessible for future activation.

The first fiber optic cable 4400 is routed below the tabs 4212 on the base 4208. The tabs 4212 retain the first fiber optic cable 4400 in position along the base 4208 of the tray 1100(3). The first fiber optic cable 4400 represents active fiber that is in use and routed toward the splice region 4218 for connection with other fiber optic cables.

The arrangement of the second fiber optic cable 4402 below the tabs 4214 on the shelf 4210 and the first fiber optic cable 4400 below the tabs 4212 on the base 4208 provides physical separation between dark fiber and active fiber within the tray 1100(3). The physical separation between the second fiber optic cable 4402 and the first fiber optic cable 4400 may facilitate identification of fiber optic cables that are in use and fiber optic cables that are not in use. In an embodiment, dark fibers stored on the shelf 4210 may be coiled in loops of a smaller diameter than active fibers stored on the base 4208, providing an additional visual indicator that allows technicians to distinguish between the two fiber types at a glance. A technician returning to perform future splicing may retrieve the smaller-diameter loops from the shelf 4210 as a discrete set without disturbing the larger-diameter active fiber coils on the base 4208. The tabs 4212 maintain the first fiber optic cable 4400 in a defined routing path on the base 4208 while the tabs 4214 retain the second fiber optic cable 4402 on the shelf 4210.

In an embodiment, the second fiber optic cable 4402 may be transitioned from dark fiber to active fiber by rerouting the second fiber optic cable 4402 from the shelf 4210 to the base 4208 below the tabs 4212. The configuration of the tray 1100(3) permits technicians to access and reroute fiber optic cables as service requirements change, enabling dark fibers to be activated without disturbing active fiber connections within the tray 1100(3).

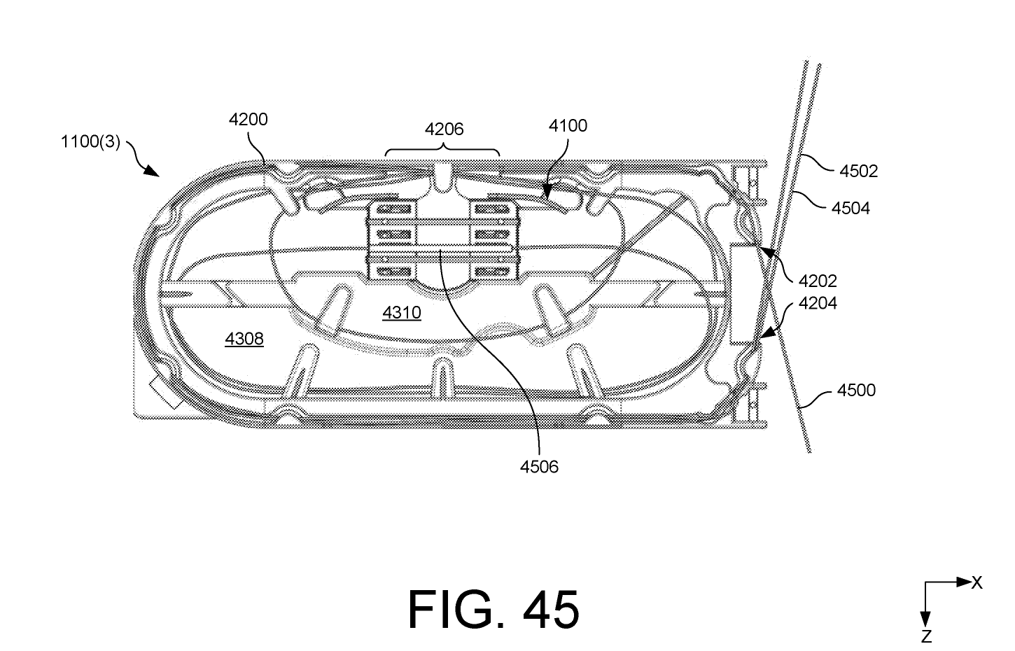

FIG. 45 illustrates a top view of the tray 1100(3) showing the routing of fiber optic cables and splicing within the tray 1100(3). A first fiber optic cable 4500 represents a patch fiber that enters the tray 1100(3), routes partially within the channel 4200, enters through the opening 4206, and routes toward the splice region 4218. A second fiber optic cable 4502 and a third fiber optic cable 4504 represent trunk ribbon fibers that are routed within the channel 4200 and through the opening 4206.

The second fiber optic cable 4502 and the third fiber optic cable 4504 enter the tray 1100(3) through the opening 4204 and route through the channel 4200. At the opening 4206, dark fibers diverge from active fibers. The opening 4206 serves as a transition point at which unused trunk fibers separate from active trunk fibers. The second fiber optic cable 4502 is disposed on the shelf 4310 and enters the opening 4204. Dark fibers, representing unused trunk fibers, continue along the channel 4200 and may be stored within the tray 1100(3) for future activation. Active trunk fibers route through the opening 4206 and into the interior 4100 of the tray 1100(3) toward the splice region 4218.

A splice 4506 is positioned within the splice region 4218 of the tray 1100(3). The splice 4506 connects the first fiber optic cable 4500 to the third fiber optic cable 4504. The splice 4506 may be housed within a splice sleeve that is retained within the splice region 4218. The splice 4506 provides an optical connection between the trunk fiber and the patch fiber, enabling signal transmission between the trunk fiber entering the tray 1100(3) and the patch fiber routed to external connections.

The first fiber optic cable 4500 may enter the tray 1100(3) through the opening 4204, route partially within the channel 4200, enter through the opening 4206, and route toward the splice region 4218 for connection with the trunk fiber at the splice 4506. The routing of the first fiber optic cable 4500 along the base 4308 positions the first fiber optic cable 4500 for splicing with the active trunk fiber at the splice 4506.

In an embodiment, the dark fibers that diverge at the opening 4206 may be stored along the shelf 4310 within the tray 1100(3). The second fiber optic cable 4502 may be retained below the tabs 4314 on the shelf 4310, maintaining separation between the dark fibers and the active fibers routed along the base 4308. The divergence of dark fibers at the opening 4206 permits unused trunk fibers to be stored within the tray 1100(3) while active trunk fibers are routed to the splice 4506 for connection with the patch fiber.

The configuration of the tray 1100(3) permits trunk ribbon fibers to enter through the opening 4204, route within the channel 4200, diverge at the opening 4206 to separate dark fibers from active fibers, and route active fibers to the splice 4506 for connection with patch fibers. The splice 4506 within the splice region 4218 provides a connection point that joins the third fiber optic cable 4504 to the first fiber optic cable 4500, enabling organized fiber management and splicing operations within the tray 1100(3).

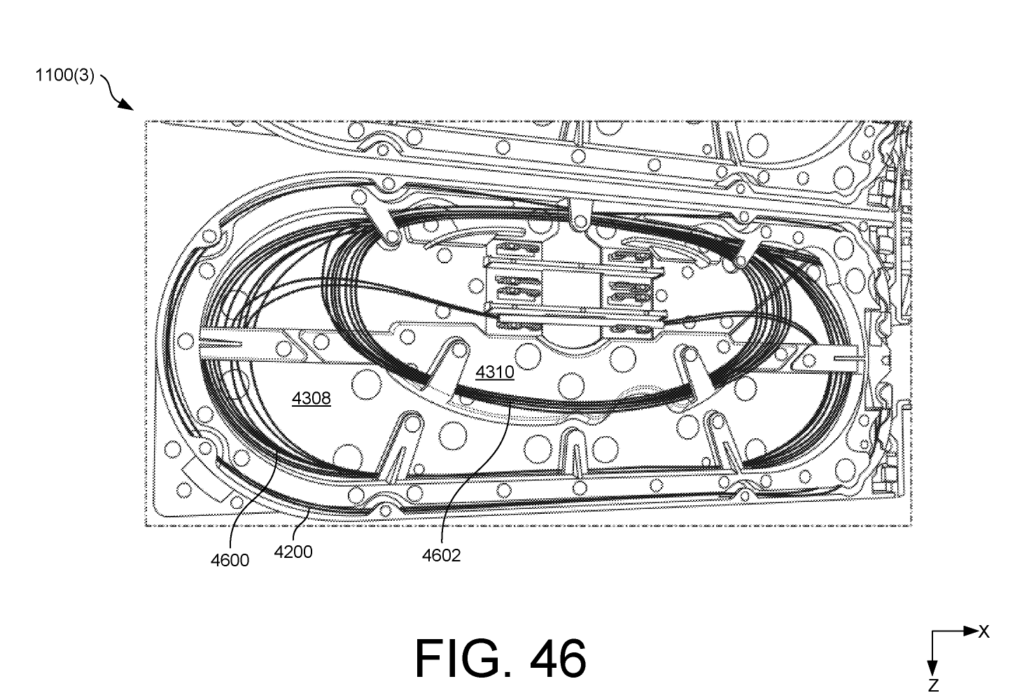

FIG. 46 illustrates a top view of the tray 1100(3) showing the routing of multiple fiber optic cables within the tray 1100(3). The tray 1100(3) includes the channel 4200 that provides a pathway for routing fiber optic cables through the tray 1100(3). The base 4308 is positioned within the tray 1100(3), providing a foundation for fiber management components. The shelf 4310 is disposed within the tray 1100(3) and is configured to support and organize fiber optic cables.

First fiber optic cables 4600 are disposed on the base 4308 and routed through the tray 1100(3), following a curved path around a perimeter of an interior space of the tray 1100(3). The first fiber optic cables 4600 may appear as multicolored ribbons that loop around the channel 4200 and the base 4308. The first fiber optic cables 4600 follow a contour of the tray 1100(3) interior, maintaining proper bend radius as the first fiber optic cables 4600 traverse the available routing space within the tray 1100(3).

Second fiber optic cables 4602 are disposed on the shelf 4310 within the tray 1100(3), routed in a curved configuration similar to the first fiber optic cables 4600. The second fiber optic cables 4602 follow the contour of the tray 1100(3) interior, maintaining proper bend radius as the second fiber optic cables 4602 traverse the available routing space. The arrangement of the first fiber optic cables 4600 on the base 4308 and the second fiber optic cables 4602 on the shelf 4310 demonstrates fiber storage and management capabilities of the tray 1100(3), with the fiber optic cables organized in loops that utilize the channel 4200 for guidance and the shelf 4310 for support during splicing operations.

In an embodiment, the curved routing paths of the first fiber optic cables 4600 and the second fiber optic cables 4602 may be configured to maintain a minimum bend radius for the fiber optic cables. The looped configuration of the first fiber optic cables 4600 and the second fiber optic cables 4602 around the channel 4200 and the base 4308 may provide sufficient slack for future maintenance, resplicing operations, or rerouting of fiber optic cables within the tray 1100(3). The routing of the first fiber optic cables 4600 and the second fiber optic cables 4602 in curved paths around the perimeter of the tray 1100(3) interior may reduce stress on the fiber optic cables and prevent damage that may result from sharp bends or excessive tension.

Although the routing of fiber optic cables is shown within the tray 1100(3), fiber optic cables may be similarly routed into other trays, such as the tray 1100(1), the tray 1100(2), the tray 1100(4), the tray 1100(5), and the tray 1100(6). Each tray may receive fiber optic cables through its respective channel and openings, with the fiber optic cables being routed along the base and shelf portions of the tray in a manner similar to that described with respect to the tray 1100(3). Moreover, more than or less than the number of fiber optic cables shown in the tray 1100(3) may be disposed within the tray 1100(3) or within other trays depending on the capacity requirements and splicing configurations of a particular installation.

While various examples and embodiments are described individually herein, the examples and embodiments may be combined, rearranged, and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A fiber optic distribution system comprising:
a cabinet including an interior;
a shelf disposed within the interior of the cabinet, the shelf including:
a plurality of passages formed in a rail structure,
a plurality of receptacles positioned adjacent to the plurality of passages,
a plurality of tracer cables, each tracer cable routed through a respective passage of the plurality of passages, and
a door movable between an open position and a closed position, the door having a plurality of apertures, each aperture aligned with a corresponding passage of the plurality of passages; and
a coupler configured to engage with the shelf, the coupler including:
a housing,
a ferrule extending from the housing and being disposable at least partially within a passage of the plurality of passages, the ferrule defining a bore configured to receive an end of a tracer cable of the plurality of tracer cables,
a first prong extending from the housing and configured to be disposed within a first receptacle of the plurality of receptacles, and
a second prong extending from the housing and configured to be disposed within a second receptacle of the plurality of receptacles, the first prong and the second prong positioned on opposite sides of the ferrule.

2. The fiber optic distribution system of claim 1, wherein the coupler further includes a fiber optic cable disposed within the bore of the ferrule, the fiber optic cable configured to optically couple with the tracer cable of the plurality of tracer cables.

3. The fiber optic distribution system of claim 2, wherein the ferrule includes an opening at a distal end through which the fiber optic cable interfaces with the tracer cable.

4. The fiber optic distribution system of claim 1, wherein the shelf further includes a plurality of compliant retainers, each compliant retainer configured to secure a respective tracer cable of the plurality of tracer cables.

5. The fiber optic distribution system of claim 4, wherein:
the plurality of compliant retainers is formed as a strip; and
the strip includes slots configured to receive the first prong and the second prong of the coupler.

6. The fiber optic distribution system of claim 1, wherein the door includes a screen configured to diffuse light emerging from the plurality of tracer cables when the door is in the closed position.

7. A fiber optic distribution system comprising:
a shelf including:
a rail structure having a plurality of passages formed therein,
a plurality of receptacles, and
a door hingedly coupled to the shelf and movable between an open position and a closed position, the door including apertures associated with the plurality of passages; and
a coupler configured to removably engage with the shelf when the door is in the open position, the coupler including:
a housing,
a ferrule extending from the housing and defining a bore, the bore configured to receive a tracer cable routed through one of the plurality of passages, and
at least one prong extending from the housing and configured to be disposed within a receptacle of the plurality of receptacles to align the ferrule with the one of the plurality of passages.

8. The fiber optic distribution system of claim 7, wherein the coupler includes a first prong and a second prong extending from the housing, the first prong and the second prong spaced apart from one another on opposite sides of the ferrule.

9. The fiber optic distribution system of claim 7, wherein the shelf further includes a plurality of guides, each guide configured to direct a respective tracer cable toward a respective passage of the plurality of passages.

10. The fiber optic distribution system of claim 7, wherein the at least one prong and the receptacle are configured such that engagement therebetween aligns the bore of the ferrule with the tracer cable routed through the one of the plurality of passages.

11. The fiber optic distribution system of claim 7, wherein the coupler further includes a connector removably secured to the housing, the connector including a fiber optic cable.

12. The fiber optic distribution system of claim 7, wherein the shelf further includes a channel configured to route a tracer cable toward the plurality of passages.

13. The fiber optic distribution system of claim 7, wherein the coupler further includes a fiber optic cable disposed within the bore of the ferrule, the fiber optic cable configured to emit light into the tracer cable when the coupler is engaged with the shelf.

14. A coupler for a fiber optic distribution system comprising:
a housing configured to receive a connector, the connector connected to a cable that includes a fiber optic cable;
a ferrule extending from the housing, the ferrule defining a bore configured to receive an end of a tracer cable, the tracer cable configured to optically couple to the fiber optic cable;
a first alignment mechanism extending from the housing; and
a second alignment mechanism extending from the housing, the first alignment mechanism and the second alignment mechanism configured to be disposed within receptacles formed in a shelf to align the ferrule with a passage through which the tracer cable is routed.

15. The coupler of claim 14, wherein the first alignment mechanism and the second alignment mechanism include prongs extending from the housing.

16. The coupler of claim 14, wherein the bore of the ferrule includes a conical entrance configured to guide and center the tracer cable as the coupler is engaged with the shelf.

17. The coupler of claim 14, wherein the fiber optic cable is configured to transmit visible light into the tracer cable when the coupler is engaged with the shelf, the visible light traveling through the tracer cable to enable circuit identification at a remote location.

18. The coupler of claim 14, wherein the first alignment mechanism and the second alignment mechanism are spaced apart from one another on opposite sides of the ferrule.

19. The coupler of claim 14, wherein the ferrule is disposable within the passage to align the bore with the tracer cable routed through the passage.

20. The coupler of claim 14, wherein:
the shelf includes a door movable between an open position and a closed position; and
the coupler is configured to engage with the shelf when the door is in the open position.
